(19) United States
(12) Patent Application Publication
(10) Pub. No.: US 2008/0129453 A1
(43) Pub. Date: Jun. 5, 2008

(54) Method, system, and apparatus for a radio frequency identification (RFID) waveguide for reading items in a stack

(75) Inventors: Wayne E. Shanks, Baltimore, MD (US); William McKinzie, Fulton, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/606,117

(22) Filed: Nov. 30, 2006

(51) Int. Cl. H04B 7/00

(52) U.S. Cl. 340/10.1; 342/350

(57) ABSTRACT

A method, system, and apparatus for reading RFID tags in a stack of objects is described. For example, a pallet may hold a stack of objects, with one or more of the objects coupled to a RFID tag. A RFID reader may be used to read the tags in the stack. However, tagged objects in the middle of the stack may be difficult to read due to the RF signal loss passing through objects inside the stack. A waveguide may be used to guide radio waves to locations inside the pallet stack. For example, the waveguide can replace a slipsheet that is conventionally placed between horizontal layers of cases in the pallet stack.

### BACKGROUND OF THE INVENTION

1. Field of the Invention

The present invention relates to radio frequency identification (RFID) tag and reader technology.

2. Background Art

An RFID tag may be affixed to an item whose presence is to be detected and/or monitored. The presence of an RFID tag, and therefore the presence of the item to which the tag is affixed, may be checked and monitored by devices known as “readers.”

Difficulties are encountered when attempting to read RFID tags that are blocked by objects from unimpeded, direct access by a reader. For example, difficulties are encountered when reading tags in a stack of items. A pallet may hold a stack of objects, with one or more of the objects coupled to a RFID tag. A RFID reader may be used to read the tags in the stack. However, tagged objects in the middle of the stack may be difficult to read due to the RF signal loss passing through objects in the stack.

Thus, it would be desirable to be able to read RFID tags that are in a stack of objects, or are otherwise difficult to read due to being blocked from direct access by a reader.

### BRIEF SUMMARY OF THE INVENTION

Methods, systems, and apparatuses are described for a radio frequency identification (RFID) waveguide for reading items in a stack.

According to an embodiment, a waveguide is provided between objects in a stack of objects to facilitate communication between an RFID reader and a tag that is attached to an object in the stack. For example, an RF signal may propagate along the waveguide to the tag. The waveguide may be any of a variety of waveguides, such as a transverse electric (TE) mode surface waveguide, a transverse electromagnetic (TEM) mode surface waveguide such as a parallel-plate waveguide, a transverse magnetic (TM) mode surface waveguide, or an electromagnetic hard surface. The waveguide may have an edge portion that extends beyond an outer perimeter of the stack. The waveguide may be arranged in any configuration with reference to the stack (e.g., vertically, horizontally, etc.).

Slots may be provided in the waveguide to facilitate the transfer of the RF signal to and/or from the waveguide. The waveguide may include tapered metallic elements to facilitate transferring energy of the RF signal to the waveguide. The profile height and/or mass of the waveguide may be reduced by implementing a capacitive layer in the waveguide. The waveguide may include a capacitive layer comprising interdigital capacitors or overlay capacitors, to provide some examples.

In another embodiment, a method is provided in which a first radio frequency (RF) signal is transmitted along a waveguide that is provided between objects in a stack of objects. The first RF signal may be provided to the waveguide by a tag reader, for example. Tapered metallic elements along an edge of the waveguide may receive the first RF signal for transmission to the tag. The first RF signal radiates from the waveguide to a tag that is attached to an object in the stack. The tag may process the first RF signal and transmit a second RF signal to the tag reader via the waveguide.

These and other objects, advantages and features will become readily apparent in view of the following detailed description of the invention.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1A shows a plan view of an example RFID tag according to an embodiment of the present invention.

FIG. 1B is a block diagram of an example RFID tag interrogation system according to an embodiment of the present invention.

FIG. 2A illustrates an interrogation system according to an embodiment of the present invention.

FIG. 2B illustrates a stack placed upon a pallet according to an embodiment of the present invention.

FIG. 3A illustrates a rectangular waveguide according to an embodiment of the present invention.

FIG. 3B illustrates a circular waveguide according to an embodiment of the present invention.

FIG. 4A illustrates the rectangular waveguide of FIG. 3A having more than one opening according to an embodiment of the present invention.

FIG. 4B illustrates the circular waveguide of FIG. 3B having more than one opening according to an embodiment of the present invention.

FIG. 5A shows an example transverse electric (TE) mode surface waveguide according to an embodiment of the present invention.

FIG. 5B is a side view of an example TE mode surface waveguide according to another embodiment of the present invention.

FIG. 5C is a side view of an example TE mode surface waveguide according to yet another embodiment of the present invention.

FIGS. 5D and 5E are plan views of the TE mode surface waveguide as shown in FIG. 5C including a transition region according to embodiments of the present invention.

FIG. 5F shows an example transverse magnetic (TM) mode surface waveguide according to an embodiment of the present invention.

FIG. 6A shows an example parallel plate waveguide (PPW) according to an embodiment of the present invention.

FIG. 6B is a side view of example parallel plate waveguide according to another embodiment of the present invention.

FIG. 6C is an example of an asymmetric stepped height transition in a parallel-plate waveguide according to an embodiment of the present invention.

FIG. 6D is a graphical representation of S-parameters associated with the asymmetric stepped height transition of FIG. 6C according to an embodiment of the present invention.

FIG. 6E shows views of a parallel plate waveguide having a V-shaped coupling aperture according to an embodiment of the present invention.

FIG. 6F illustrates a parallel plate waveguide having transition coupling slots and tag coupling slots according to an embodiment of the present invention.

FIG. 6G illustrates several types of resonant coupling slots according to embodiments of the present invention.

FIG. 7A shows a first example test configuration for the TE mode surface waveguide of FIGS. 5A-5E, according to an embodiment of the present invention.

FIG. 7B shows a modified stacking pattern for the first example test configuration of FIG. 7A according to an embodiment of the present invention.

FIG. 8 shows a second example test configuration for the TE mode surface waveguide of FIGS. 5A-5E, according to an embodiment of the present invention.

FIG. 9 shows an example test configuration for the parallel plate waveguide of FIGS. 6A-6G, according to an embodiment of the present invention.

FIG. 10 shows an example pallet-stacking pattern according to an embodiment of the present invention.

FIG. 11A provides a graphical comparison between measured data and modeled data for the real part of the dielectric constant of Pantene Pro-V® shampoo according to embodiments of the present invention.

FIG. 11B provides a graphical comparison between measured data and modeled data for the imaginary part of the dielectric constant of Pantene Pro-V® shampoo according to embodiments of the present invention.

FIG. 12 illustrates the placement of 750 ml Pantene Pro-V® shampoo bottles in cases that were used for testing the configurations of FIGS. 7-10 according to an embodiment of the present invention.

FIG. 13 shows an example hard electromagnetic surface waveguide according to an embodiment of the present invention.

FIGS. 14A and 14C each show a single-layer frequency-selective structure (FSS) having interdigital capacitors according to respective embodiments of the present invention.

FIG. 14B shows a dual-layer FSS having overlay capacitors according to an embodiment of the present invention.

FIG. 15A is a side view of another example TE mode surface waveguide according to an embodiment of the present invention.

FIG. 15B is an equivalent transmission line for the example TE mode surface waveguide shown in FIG. 15A according to an embodiment of the present invention.

FIG. 16 shows an example TE mode surface waveguide according to yet another embodiment of the present invention.

FIG. 17 is a graphical representation of a normalized propagation constant and a field decay constant with respect to frequency according to an embodiment of the present invention.

FIG. 18 illustrates a distinction between actual and equivalent plan views of shampoo bottles according to an embodiment of the present invention.

FIG. 19 shows an example gridded model according to an embodiment of the present invention.

FIG. 20 shows top and bottom views of a TE mode surface waveguide simulated in FIG. 19 according to an embodiment of the present invention.

FIG. 21 is a graphical representation of power transmission for the gridded model in FIG. 19 according to an embodiment of the present invention.

FIG. 22 is a graphical representation of power transmission for the gridded model in FIG. 19 according to an embodiment of the present invention.

FIG. 23 illustrates transmission performance of the gridded model of FIG. 19 for different sized slots according to an embodiment of the present invention.

FIG. 24 illustrates a second gridded model according to an embodiment of the present invention.

FIG. 25 shows the simulated performance of the second gridded model shown in FIG. 24 according to an embodiment of the present invention.

FIG. 26 shows a metallization pattern of prototype TE mode waveguides according to an embodiment of the present invention.

FIGS. 27 and 28 show respective side and bottom views of the prototype TE mode waveguides according to embodiments of the present invention.

FIGS. 29 and 30 show the capacitive side of a second prototype TE mode waveguide according to an embodiment of the present invention.

FIG. 31 shows the ground plane side of the second prototype TE mode waveguide shown in FIGS. 29 and 30 according to an embodiment of the present invention.

FIGS. 32 and 33 are graphical representations of the reflection coefficient amplitude and phase, respectively, of a prototype TE mode waveguide according to an embodiment of the present invention.

FIG. 34 is an equivalent circuit model of a prototype TE mode waveguide according to an embodiment of the present invention.

FIG. 35 is a graphical representation of the simulated reflection coefficient for the equivalent circuit model shown in FIG. 34 according to an embodiment of the present invention.

FIG. 36 shows pallet stacks that include respective parallel plate waveguides (PPWs) according to embodiments of the present invention.

FIG. 37 shows an equivalent circuit that approximates the stepped height transitions shown in FIG. 36 according to an embodiment of the present invention.

FIG. 38 illustrates the Microstripes™ gridded 2D workspace according to an embodiment of the present invention.

FIG. 39 shows a comparison between the transmission performance S₂₁ of the equivalent circuit in FIG. 37 and the full-wave Microstripes™ model described with reference to FIG. 38.

FIG. 40 illustrates asymmetric PPW transitions according to embodiments of the present invention.

FIG. 41 illustrates symmetric PPW transitions according to embodiments of the present invention.

FIG. 42 shows an equivalent circuit of asymmetric embodiment (c) as shown in FIG. 40, according to an embodiment of the present invention.

FIG. 43 shows a Microstripes™ simulation of the final transition design according to an embodiment of the present invention.

FIG. 44 is a graphical representation of the S-parameters associated with the equivalent model of the four-section transition of asymmetric embodiment (d) shown in FIG. 41.

FIG. 45 shows a PPW that includes a linear array of V-shaped coupling slots etched or cut in the lower plate of the PPW according to an embodiment of the present invention.

FIG. 46 shows a perspective view of one slot of the array of V-shaped slots shown in FIG. 45 according to an embodiment of the present invention.

FIG. 47 shows a plan view of the slot in FIG. 46 according to an embodiment of the present invention.

FIG. 48 is a graphical representation of the normalized scattering parameters for the slot array transition illustrated in FIGS. 46 and 47, according to an embodiment of the present invention.

FIG. 49 shows two perspective views a PPW having coupling slots according to an embodiment of the present invention.

FIG. 50 shows simulated geometry and s-parameter results for a crossed slot in which the slotline open ends allow the overall slot size to be reduced, according to an embodiment of the present invention.

FIG. 51 shows a coupling slot that is center-loaded with a shunt capacitor according to an embodiment of the present invention.

FIG. 52 shows a coupling slot that is center-loaded with an interdigital capacitor according to an embodiment of the present invention.

FIG. 53 shows an S-shaped coupling slot according to an embodiment of the present invention.

FIG. 54 shows dimensions of an S-shaped coupling slot that is based on a simulation using a Microstripes™ software program, according to an embodiment of the present invention.

FIG. 55 shows dimensions of an S-shaped coupling slot based on a simulation using a CST Microwave Studio™ software program, according to an embodiment of the present invention.

FIG. 56 shows an equivalent circuit model for a cascade of four slots in the x direction according to an embodiment of the present invention.

FIG. 57 shows a PPW having a 4×4 coupling slot array according to an embodiment of the present invention.

FIG. 58 is a graphical representation of the network response for the equivalent circuit model shown in FIG. 56 according to an embodiment of the present invention.

FIG. 59 shows the power radiated by each cascaded slot of the equivalent circuit model shown in FIG. 56 relative to the input power at port 1 of the equivalent circuit, according to an embodiment of the present invention.

FIG. 60 illustrates mapping of the transmission lines and slot loads of an equivalent circuit model into each physical feature of the PPW according to an embodiment of the present invention.

FIG. 61 shows the predicted end-to-end transmission performance S₂₁ and the port return loss S₁₁ of the equivalent circuit model shown in FIG. 60 according to an embodiment of the present invention.

FIG. 62 shows power transfer functions for respective first and second slots of the equivalent circuit model shown in FIG. 60 according to embodiments of the present invention.

FIG. 63 shows a prototype PPW according to an embodiment of the present invention.

FIG. 64 is a more detailed view of resonant coupling slots of the prototype PPW shown in FIG. 63 according to an embodiment of the present invention.

FIG. 65 is a plan view of the test setup showing the relationship between the test horn and the slots to be probed, according to an embodiment of the present invention.

FIG. 66 shows a loop probe used to test the prototype PPW shown in FIG. 63.

FIG. 67 shows loop probe S₂₁ coupling measurements for slots A, B, and C of the prototype PPW shown in FIGS. 63 and 65, according to an embodiment of the present invention.

FIG. 68 shows loop probe S₂₁ coupling measurements for slots D, E, and F of the prototype PPW shown in FIGS. 63 and 65 according to an embodiment of the present invention.

FIG. 69 shows loop probe S₂₁ coupling measurements for slots A, B, and C of a second prototype PPW according to an embodiment of the present invention.

FIG. 70 shows loop probe S₂₁ coupling measurements for slots D, E, and F of the second prototype PPW according to an embodiment of the present invention.

FIG. 71A is a side view of another example TM mode surface waveguide according to an embodiment of the present invention.

FIG. 71B is an equivalent transmission line for the TM mode surface waveguide shown in FIG. 71A according to an embodiment of the present invention.

FIG. 72 illustrates the performance of the example TM mode surface waveguide shown in FIG. 71A at different frequencies according to an embodiment of the present invention.

FIG. 73 shows a gap between the surface of the PPW and the lossy dielectric (shampoo) according to an embodiment of the present invention.

FIG. 74 shows a relationship between the decay constant α and frequency according to an embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### 1.0 Introduction

The present invention relates to radio frequency identification (RFID) technology. More specifically, embodiments of the invention include methods, systems, and apparatuses for reading RFID tags in a stack of objects.

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications. For example, in the following description, for illustrative purposes, embodiments may be described in terms of a particular waveguide type (e.g., transverse electric (TE) mode, transverse magnetic (TM) mode). However, it would be apparent to persons skilled in the relevant art(s) that alternative types of waveguides may be used in embodiments of the present invention, including but not limited to transverse electromagnetic (TEM) mode surface waveguides (e.g., waveguides that have no electric or magnetic field in the direction of propagation).

This specification discloses one or more embodiments that incorporate the features of this invention. The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to effect such feature, structure, or characteristic in connection with other embodiments whether or not explicitly described.

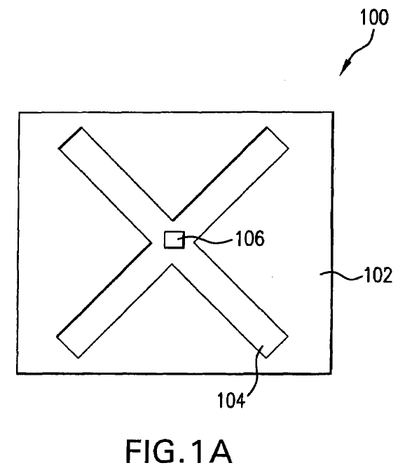

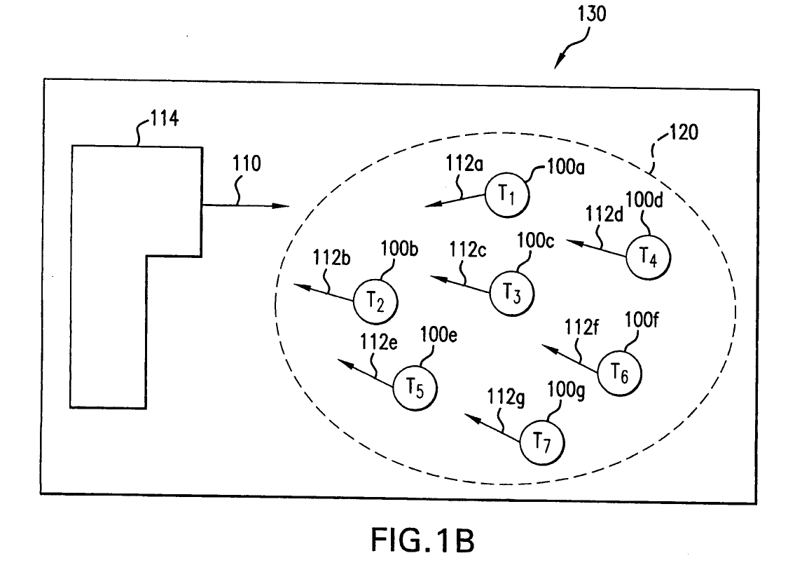

The present invention is applicable to any type of RFID tag. FIG. 1A shows a plan view of an example RFID tag 100 according to an embodiment of the present invention. Tag 100 includes a substrate 102, an antenna 104, and an integrated circuit (IC) 106. Antenna 104 is formed on a surface of substrate 102. IC 106 includes one or more integrated circuit chips/dies and/or other electronic circuitry. IC 106 is attached to substrate 102, and is coupled to antenna 104. IC 106 may be attached to substrate 102 in a recessed and/or non-recessed location. IC 106 controls operation of tag 100 and transmits signals to, and receives signals from, RFID readers using antenna 104. The present invention is applicable to tag 100, and to other types of tags, including surface acoustic wave (SAW) tags.

FIG. 1B is a block diagram of an example RFID tag interrogation system 130 according to an embodiment of the present invention. Tag interrogation system 130 includes a RFID reader 114 and an example population 120 of RFID tags 100. As shown in FIG. 1B, the population 120 of tags 100 includes a first tag 100a, a second tag 100b, a third tag 100c, a fourth tag 100d, a fifth tag 100e, a sixth tag 100f, and a seventh tag 100g. These seven tags 100 are shown in the population 120 for exemplary purposes. According to embodiments of the present invention, a population 120 of tags 100 may include any number of one or more tags 100. In some embodiments, very large numbers of tags 100 may be included in a population 120 of tags 100, including hundreds, thousands, or even more tags 100.

As shown in FIG. 1B, one or more interrogation signals 110 are transmitted from RFID reader 114 to the population 120 of tags 100. One or more response signals 112 are transmitted from RFID tags 100 to RFID reader 114. For example, as shown in FIG. 1B, first tag 100a transmits a first response signal 112a, second tag 100b transmits a second response signal 112b, third tag 100c transmits a third response signal 112c, fourth tag 100d transmits a fourth response signal 112d, fifth tag 100e transmits a fifth response signal 112e, sixth tag 100f transmits a sixth response signal 112f, and seventh tag 100g transmits a seventh response signal 112g.

According to the present invention, signals 110 and 112 are exchanged between RFID reader 114 and tags 100 according to one or more communication protocols. RFID reader 114 can communicate with tags 100 according to any communications protocol/algorithm, as required by the particular application. For example, RFID reader 114 can communicate with tags 100 according to a binary algorithm, a tree traversal algorithm, or a slotted aloha algorithm. RFID reader 114 can communicate with tags 100 according to a standard protocol, such as Class 0, Class 1, EPC Gen2, and any other known or future developed RFID communications protocol/algorithm.

Signals 110 and 112 are wireless signals, such as radio frequency (RF) transmissions. Upon receiving a signal 110, a tag 100 may produce a responding signal 112 by alternately reflecting and absorbing portions of signal 110 according to a time-based pattern. The time-based pattern is determined according to information that is designated for transmission to RFID reader 114. This technique of alternately absorbing and reflecting signal 110 is referred to herein as backscatter modulation. Persons skilled in the art will recognize that tags 100 may employ any of a variety of approaches to perform backscatter modulation. For example, tags 100 may vary the impedance characteristics of onboard receive circuitry, such as one or more antennas and/or other connected electronic components.

Each tag 100 has an identification number. In certain embodiments, each of tags 100 has a unique identification number. However, in other embodiments, multiple tags 100 may share the same identification number, or a portion thereof. During the aforementioned communications with tags 100, RFID reader 114 receives identification numbers from tags 100 in response signals 112. Depending on the protocol employed for such communications, the retrieval of identification numbers from tags 100 may involve the exchange of signals over multiple iterations. In other words, the receipt of a single identification number may require RFID reader 114 to transmit multiple signals 110. In a corresponding manner, tags 100 will respond with respective signals 112 upon the receipt of each signal 110, if a response is appropriate.

Alternatively or in addition to identification numbers, RFID reader 114 may send other information to tags 100. For example, RFID reader 114 may store a unit of information in one or more of tags 100 to be retrieved at a later time. Depending upon the design of tags 100, this could be volatile or non-volatile information storage and retrieval.

RFID reader 114 may also obtain information generated by sensors that are included in tags 100. When provided to RFID reader 114, this sensor information may include information regarding the operational environments of tags 100, for example.

A variety of sensors may be integrated with tags 100. Exemplary sensors include: gas sensors that detect the presence of chemicals associated with drugs or precursor chemicals of explosives such as methane, temperature sensors that generate information indicating ambient temperature, accelerometers that generate information indicating tag movement and vibration, optical sensors that detect the presence (or absence) of light, pressure sensors that detect various types of tag-encountered mechanical pressures, tamper sensors that detect efforts to destroy tags and/or remove tags from affixed items, electromagnetic field sensors, radiation sensors, and biochemical sensors. However, this list is not exclusive. In fact, tags 100 may include other types of sensors, as would be apparent to persons skilled in the relevant arts.

Each of tags 100 is implemented so that it may be affixed to a variety of items. For example a tag 100 may be affixed to airline baggage, retail inventory, warehouse inventory, automobiles, and other objects. In some circumstances, the objects to which tags 100 are affixed may be stacked. In conventional RFID interrogation systems, stacking the objects hinders communication between RFID reader 114 and tags 100 that are affixed to the stacked objects. For example, tags 100 toward the center of the stack may not receive a signal 110 transmitted by RFID reader 114 because objects surrounding those tags 100 block or absorb the signal 110. In another example, the surrounding objects may block or absorb signals 112 transmitted from those tags 100, hindering detection of signals 112 by RFID reader 114. The present invention attempts to resolve these problems by facilitating communication between RFID reader 114 and tags 100 that are stacked or blocked.

### 2.0 Example Waveguide Embodiments

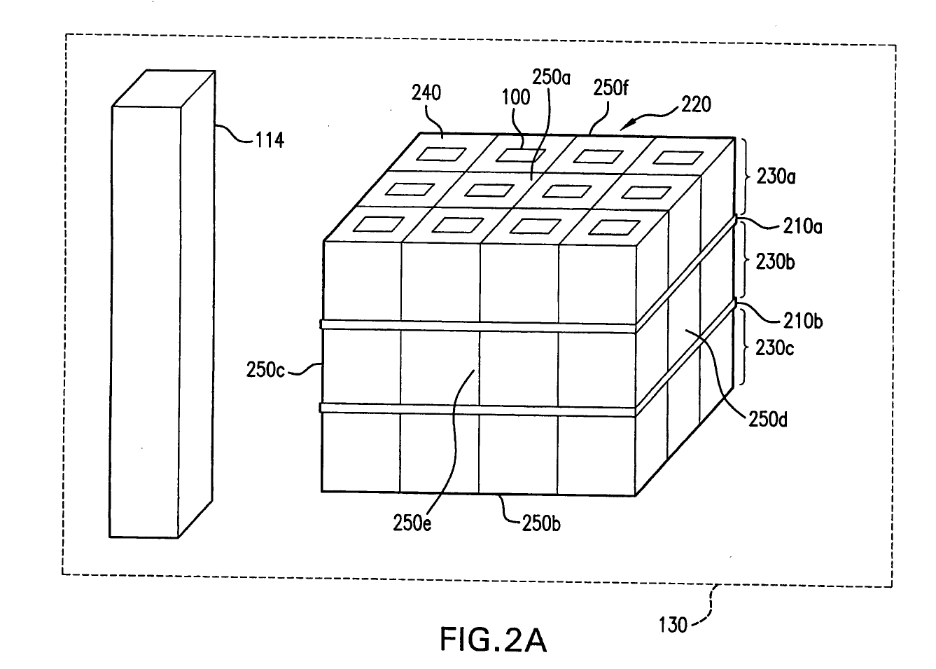

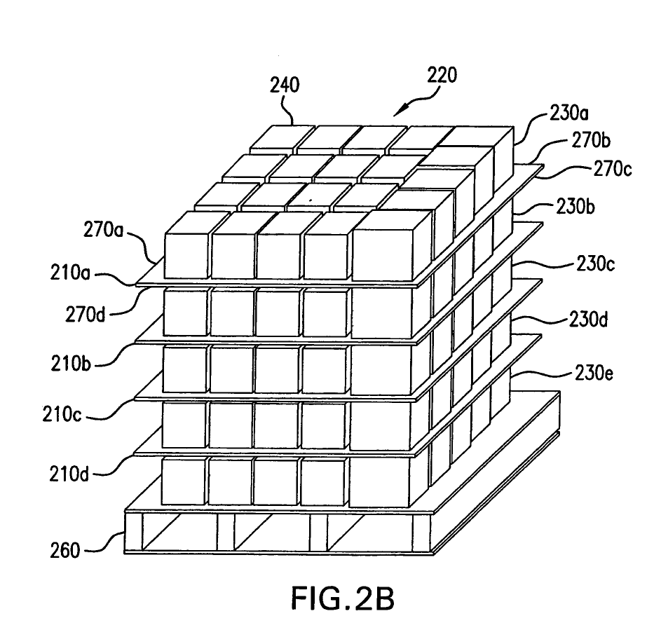

FIG. 2A illustrates an interrogation system 130 according to an embodiment of the present invention. In FIG. 2A, interrogation system 130 includes waveguides 210a and 210b that are used to facilitate communication between RFID reader 114 and tags 100 that are coupled to objects 240 in a stack 220. In the embodiment of FIG. 2A, stack 220 includes three layers 230a-c of objects 240. A waveguide 210 is provided between adjacent layers 230 to carry signals between RFID reader 114 and tags 100 that are coupled to objects 240. Waveguide 210a is provided between layers 230a and 230b. Waveguide 210b is provided between layers 230b and 230c. Interrogation system 130 can include any number of waveguides 210 and/or layers 230 of objects 240. Moreover, layers 230 can include any number of objects 240, and layers 230 need not necessarily include the same number of objects 240.

In FIG. 2A, stack 220 has six surfaces 250a-f, though the scope of the invention is not limited in this respect. For example, stack 220 may be a cylinder, a pyramid, a cone, or any other shape. In another example, stack 220 may be a pile of objects 240 having a random or semi-random distribution. Stack 220 can have any number of layers 230, including one. For example, in a one layer embodiment, a waveguide 210 may be present on a shelf, and objects 240 may be positioned on layer 230 on the shelf. Such a configuration may aid in reading objects positioned behind other objects on a shelf.

Referring to FIG. 2A, objects 240 in the middle of stack 220 may be difficult to read due to the radio frequency (RF) signal loss passing through objects 240 in stack 220. Waveguides 210a and 210b can guide radio waves to locations within stack 220, so that tags 100 affixed to objects 240 in the interior of stack 220 may detect the radio waves.

Radio waves decay exponentially with distance as the radio waves travel into a stack of absorptive products, such as shampoo, for example. Many commercial products impose such a high RF loss that buried tags (i.e., tags that are not exposed to a surface 250 of stack 220) cannot be read. Waveguides 210a-b bridge the performance gap between tags 100 and RFID reader 114, allowing tags 100 within stack 220 to communicate with RFID reader 114.

Any of a variety of waveguides 210 may be used to facilitate communication between tags 100 and RFID reader 114. Waveguide 210 may be flexible or rigid and may be composed of any suitable material or combination of materials. According to an embodiment, waveguide 210 is a rigid planar RF waveguide configured to guide 900 MHz radio waves to locations within a pallet stack. Waveguide 210 may be used with conventional reader systems, such as a conventional MATRICS portal reader system. Persons skilled in the art will recognize that embodiments of the present invention are adaptable to frequencies other than those described herein.

FIG. 2B illustrates a stack 220 placed upon a pallet 260 according to an embodiment of the present invention. In FIG. 2B, waveguides 210a-d replace slipsheets, which are traditionally placed between horizontal layers of cases in a pallet stack.

In FIG. 2B, each layer 230 of objects 240 (e.g., cases) is separated from an adjacent layer 230 by a waveguide 210. However, multiple layers 230 of objects 240 can be placed between waveguides 210. As shown in FIG. 2B, objects 240 of a layer 230 need not necessarily be the same size.

Referring to FIG. 2B, each of waveguides 210a-d includes edge portions 270a-d, which extend beyond the perimeter of layers 230a-e. Edge portions 270a-d facilitate communication between RFID reader 114 and tags that are affixed to objects 240 in layers 230a-e. Any one or more of waveguides 210a-d can include an edge portion 270a, 270b, 270c, and/or 270d. Waveguides 210a-d need not necessarily include edge portions 270a-d.

In the embodiment of FIG. 2B, waveguides 210a-d are depicted as rigid surfaces, though the scope of the invention is not limited in this respect. Waveguides 210a-d need not necessarily be rigid and may be flexible. For example, stack 220 may include a supporting layer beneath each waveguide 210a-d. The supporting layers may provide structural support for respective waveguides 210a-d.

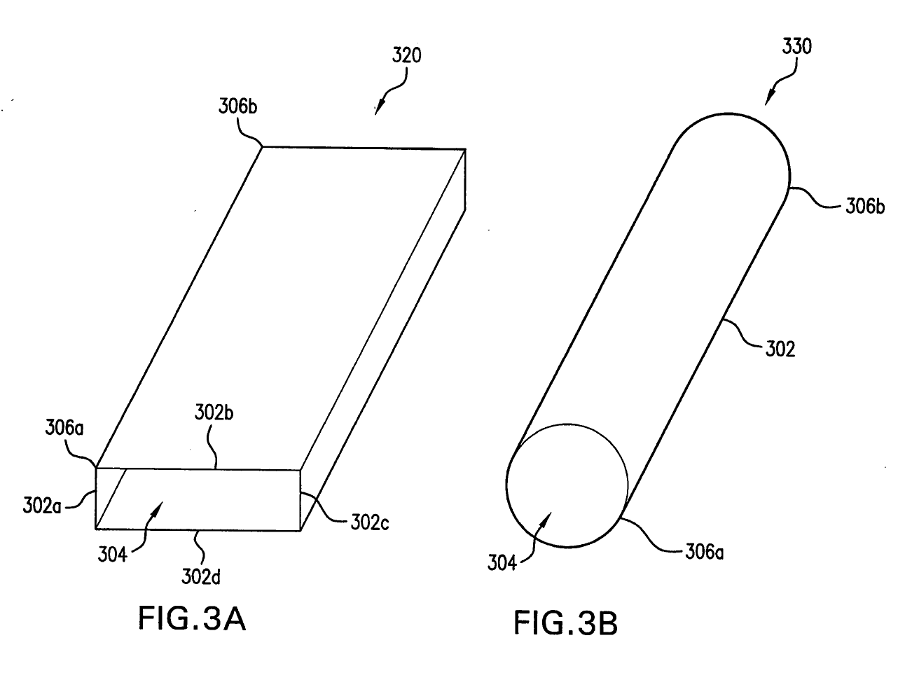

A waveguide may be described as a hollow “tube” having wall(s) that surround a dielectric, such as air. The wall(s) of the waveguide provides distributed inductance, and the space between the wall(s) provides distributed capacitance. FIGS. 3A and 3B illustrate some example waveguides according to embodiments of the present invention.

FIG. 3A illustrates a rectangular waveguide 320 according to an embodiment of the present invention. In FIG. 3A, waveguide 320 has four walls 302a-d that surround a hollow portion 304. Hollow portion 304 extends from a first end 306a of waveguide 320 to a second end 306b of waveguide 320. A signal can travel along waveguide 320 from first end 302a to second end 302b or vice versa.

FIG. 3B illustrates a circular waveguide 330 according to an embodiment of the present invention. In FIG. 3B, waveguide 330 has a single wall 302 that surrounds a hollow portion 304. Hollow portion 304 extends from a first end 306a of waveguide 330 to a second end 306b of waveguide 330.

A waveguide need not necessarily be rectangular or circular as described above with reference to FIGS. 3A and 3B, respectively. For example, a waveguide can be elliptical or any other shape. A waveguide can have any suitable number of sides.

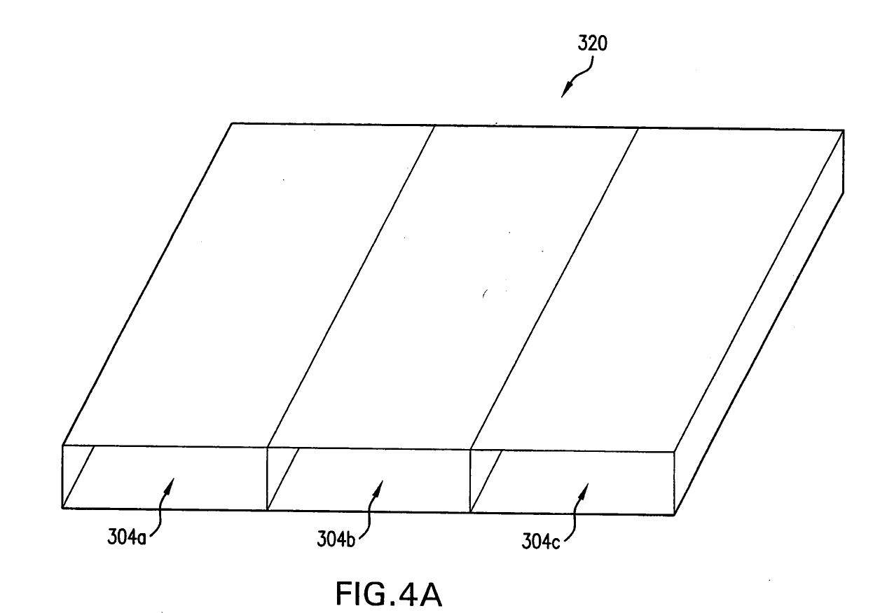

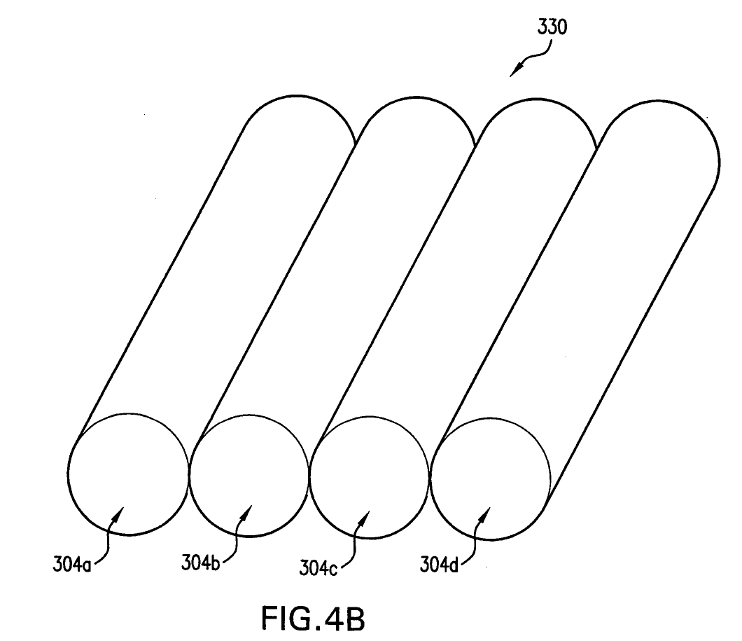

FIGS. 4A and 4B illustrate that a waveguide can have more than one hollow portion 304. For example, FIG. 4A shows waveguide 320 of FIG. 3A having an array of three openings 304a-c according to an embodiment of the present invention. Waveguide 320 can include any number of openings 304, and openings 304 need not necessarily be arranged in an array. In FIG. 4A, adjacent openings 304 share a common wall. However, the scope of the present invention is not limited in this respect. Walls surrounding adjacent openings 304 may or may not be in contact with each other.

FIG. 4B shows waveguide 330 of FIG. 3B having four openings 304a-d according to an embodiment of the present invention. Waveguide 330 can include any number of openings 304, and openings 304 may be arranged in any of a variety of configurations. Note that hollow portions 304, as described with reference to FIGS. 3A-4B, may be metallic-walled hollow portions.

2.1 TE Mode Surface Waveguide Embodiment

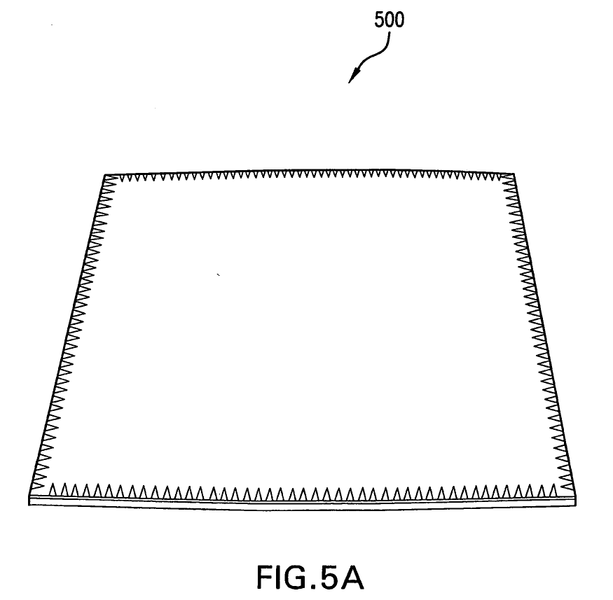

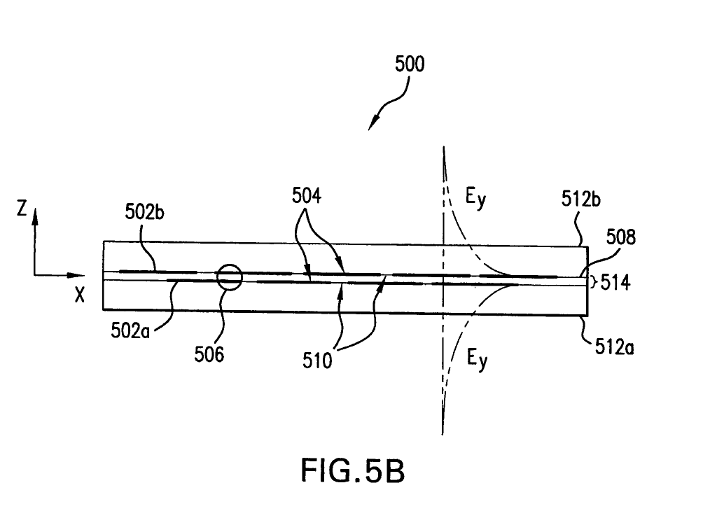

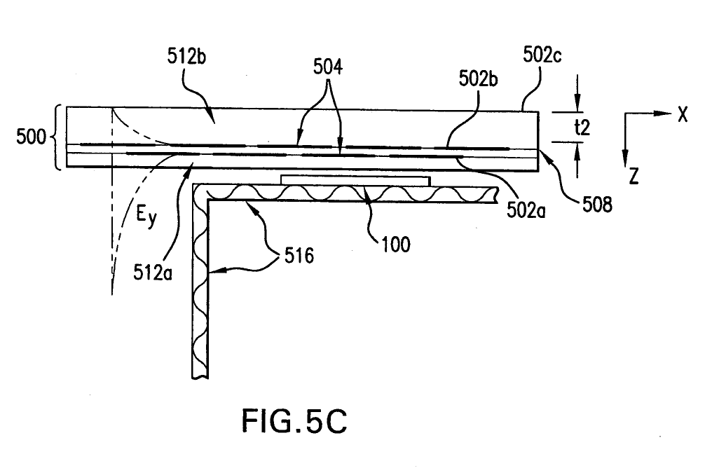

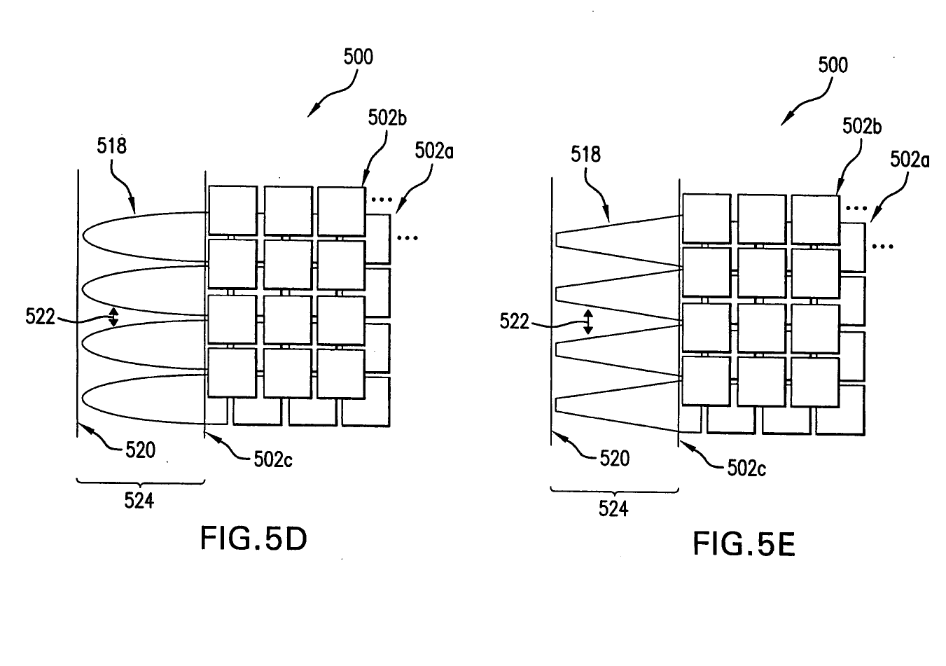

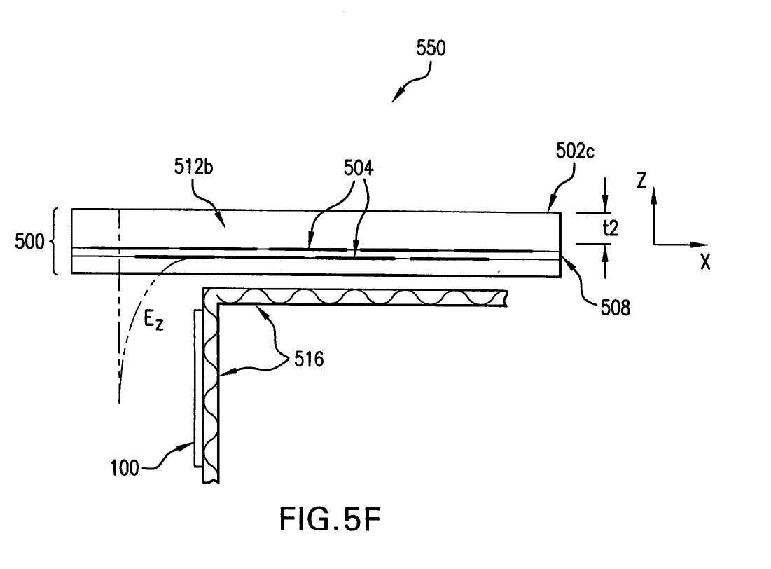

FIG. 5A shows an example transverse electric (TE) mode surface waveguide 500 according to an embodiment of the present invention. A signal can be transmitted by RFID reader 114 or a tag 100 along TE mode surface waveguide 500 to facilitate or enable communication between RFID reader 114 and tag 100. A signal propagating along TE mode surface waveguide 500 has an associated magnetic field and an associated electric field. The electric field is perpendicular (transverse) to the direction of propagation of the signal, and the magnetic field has components both normal to the surface and in the direction of propagation of the signal.

FIG. 5B is a side view of example TE mode surface waveguide 500 according to another embodiment of the present invention. In FIG. 5B, TE mode surface waveguide 500 includes a capacitive layer 514 having metallic layers 502a-b and a dielectric layer 508 provided between metallic layers 502a-b. Each metallic layer 502 includes Cohn squares 504 that are separated by gaps 510. For example, Cohn squares 504 may be printed on opposing sides of a thin dielectric film, such as Mylar. According to an embodiment, capacitive layer 514 may be implemented as an array of co-planar inter-digital capacitors.

Referring to FIG. 5B, power propagates in the x direction. Cohn squares 504 in metallic layers 502a-b overlap in the z-direction to provide overlapping regions 506. Overlapping regions 506 provide an effective sheet capacitance that can guide a TE mode “skin wave”. The highest energy density is found in a thin layer or skin associated with metallic layers 502a-b. Transverse, or y-directed, electric fields decay exponentially both above and below capacitive layer 514, as illustrated in FIG. 5B. Protective dielectric layers 512a-b, such as cardboard, can be bonded to each side of capacitive layer 514 to protect metallic layers 502a-b from damage and/or to help separate the high field strength regions of the slots from the lossy dielectric of a product being transported in close proximity to TE mode surface waveguide 500.

TE mode surface waveguide 500 is one of the easiest potential waveguide solutions to fabricate. TE mode surface waveguide 500 may have a relatively high attenuation per unit length, as compared to other potential waveguide solutions, due to the exponentially decreasing tail of the electric field in the region above TE mode surface waveguide 500. If TE mode surface waveguide 500 is provided between cases of shampoo bottles, for example, the tail of the electric field may sweep across the bottom of the shampoo bottles, and be either reflected or significantly absorbed.

FIG. 5C is a side view of example TE mode surface waveguide 500 according to yet another embodiment of the present invention. In the embodiment of FIG. 5C, TE mode surface waveguide 500 includes metallization layer 502c coupled to protective dielectric layer 512b. For example, metallization layer 502c may be a metal foil. According to an embodiment, metallization layer 502c serves as a ground plane to ensure that fields of the guided TE mode do not become absorbed by a lossy dielectric located above metallization layer 502c in relatively close proximity to TE mode surface waveguide 500. TE mode surface waveguide 500 including the ground plane may be referred to as a grounded-capacitive frequency-selective structure (FSS).

FIG. 5C shows a tag 100 affixed to a cardboard case 516, which may store bottles of shampoo, for example. As shown in FIG. 5C, the surface wave is characterized by an exponentially decreasing electric field extending downward into the top of cardboard case 516. The closest liquid shampoo in cardboard case 516 to TE mode surface waveguide 500 may be multiple inches (e.g., 2.5″) from TE mode surface waveguide 500. Other cardboard cases of shampoo may be placed on top of TE mode surface waveguide 500. The closest shampoo in the other cardboard cases to TE mode surface waveguide 500 may be much closer (e.g., 1 mm) to TE mode surface waveguide 500. A good place for tag 100 is the top surface of cardboard case 516, as shown in FIG. 5C, where the electric field strength is the greatest. However, tag detuning may be an issue for this location. Tag detuning occurs when the frequency response of antenna 104 of tag 100 is lower in frequency than it is during normal operation in free space. This change in frequency response is due to capacitive loading caused by the relatively close proximity to the FSS.

One of the engineering challenges in any surface waveguide solution is the design of a transition region at the perimeter of the waveguide. This modal transition captures a portion of the plane wave power incident upon the pallet stack and converts this power into the intended surface wave mode.

FIGS. 5D and 5E are plan views of TE mode surface waveguide 500 as shown in FIG. 5C including a transition region 524 according to embodiments of the present invention. In FIGS. 5D and 5E, metallic layer 502a includes tapered fingers 518 arranged along a perimeter 520 of TE mode surface waveguide 500. Transition region 524 extends from a perimeter of metallic layer 502c to a perimeter of TE mode surface waveguide 500. Transition region 524 includes tapered slots 522 between tapered fingers 518. For a TE mode, tapered slots 522 may facilitate the capture of power from a horizontally polarized incident electric field, for example.

TE mode surface waveguide 500 may have a field decay constant in the transverse (z) direction of between 2 dB and 3 dB per inch, for example.

2.2 Parallel Plate Waveguide Embodiment

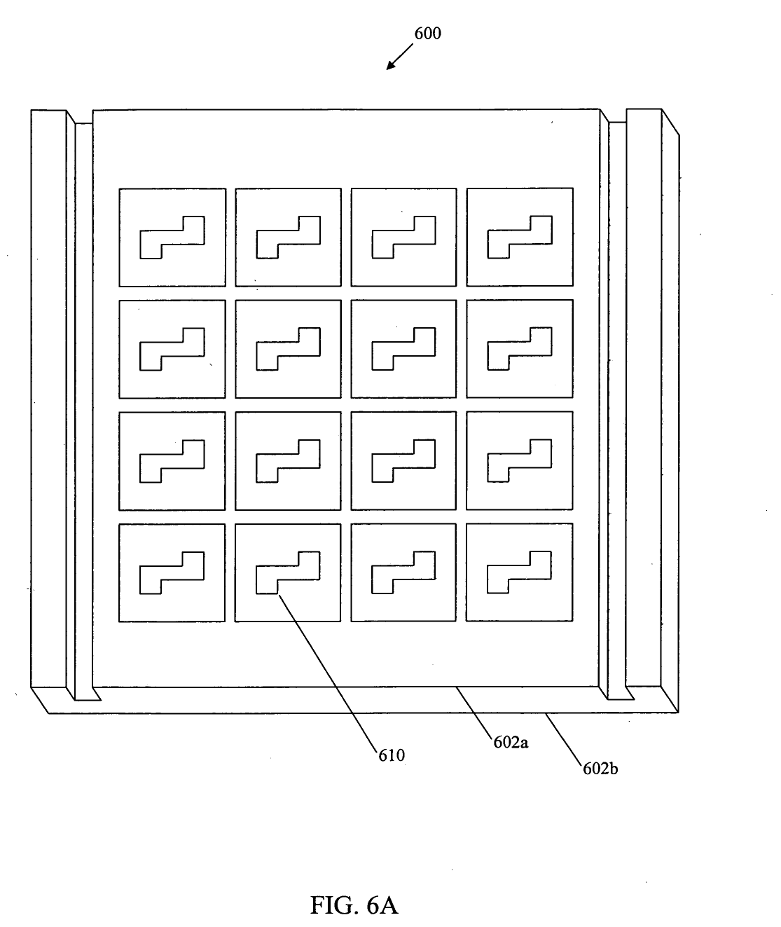

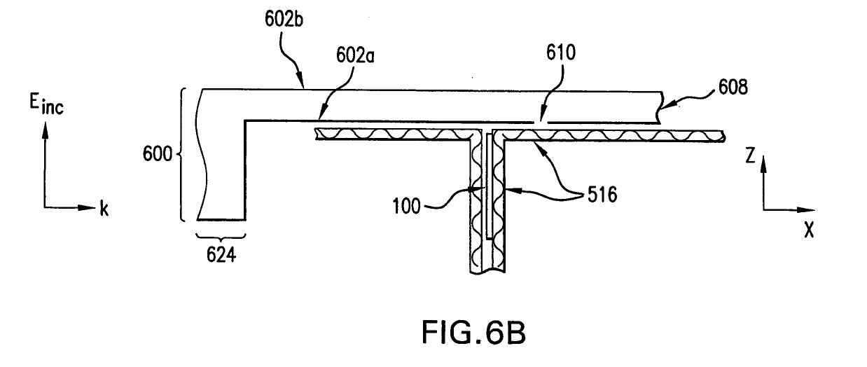

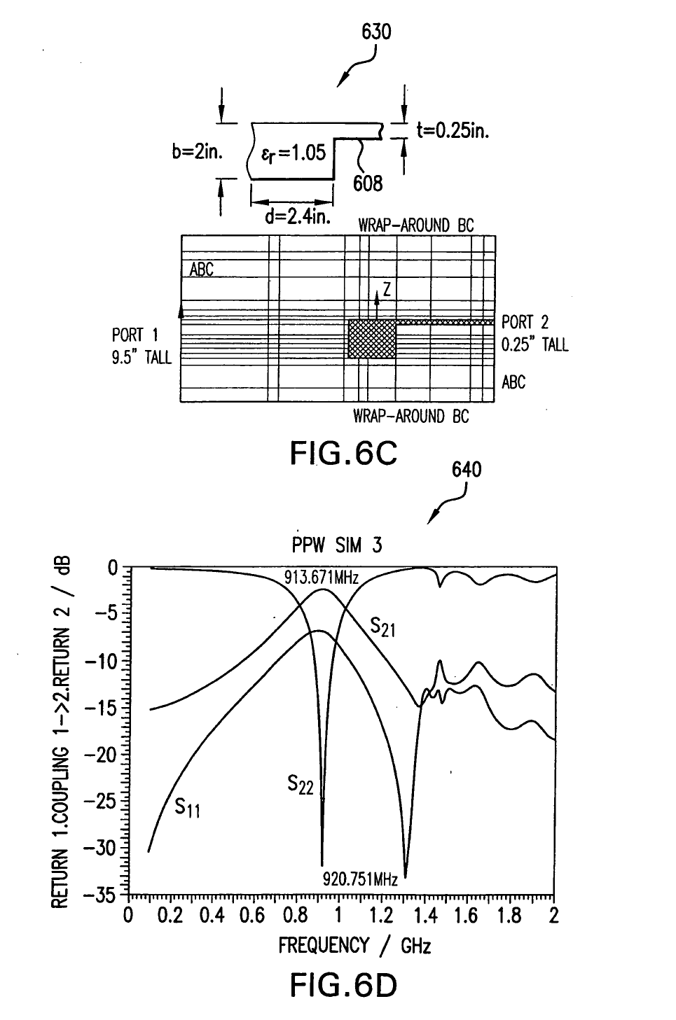

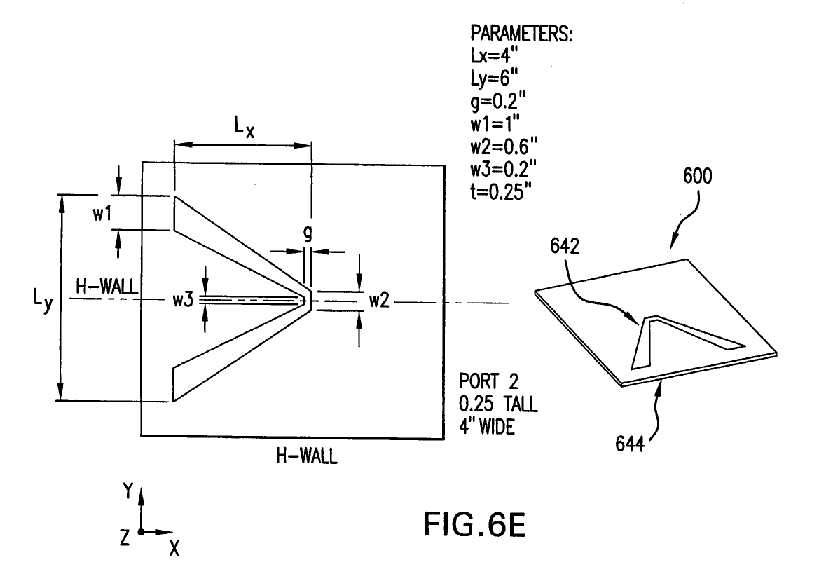

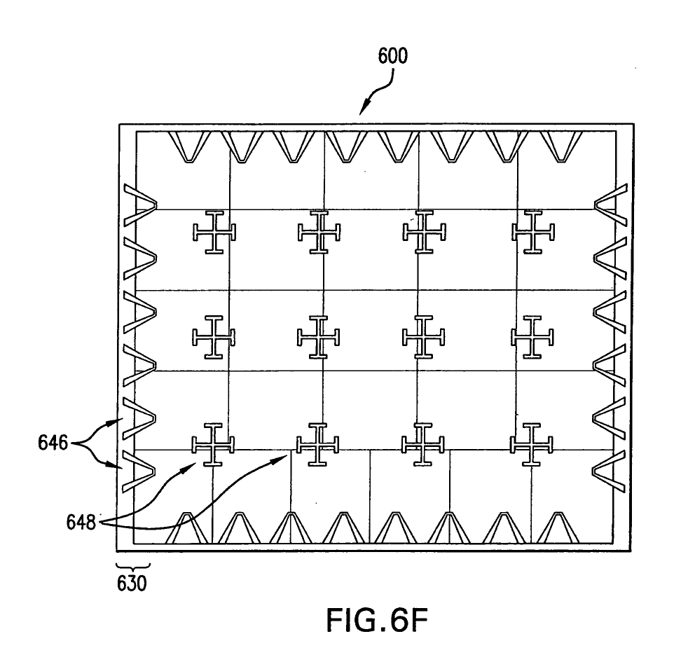

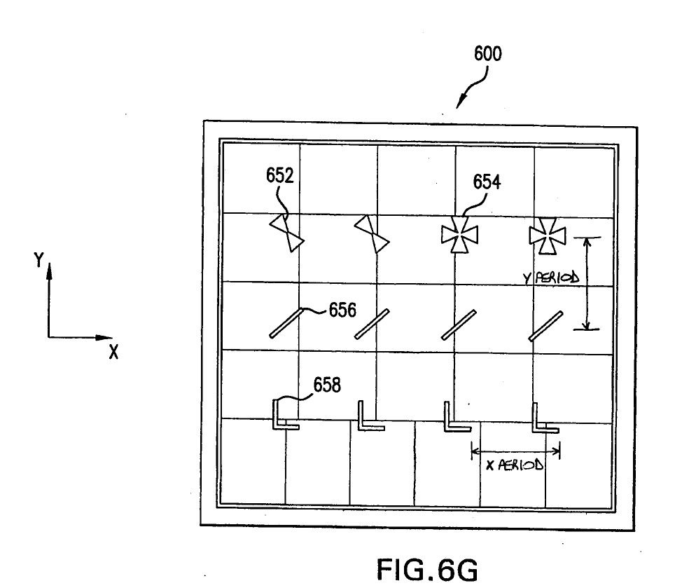

FIG. 6A shows an example parallel plate waveguide (PPW) 600 according to an embodiment of the present invention. Parallel plate waveguide 600 includes two metallic layers 602a-b, a transition region on one or more edges, and resonant coupling slots 610. Metallic layers 602a-b may be coupled in any of a variety of ways. The frequency response of parallel plate waveguide 600 may be manipulated by changing the design of the transition region and/or changing the size and/or shape of resonant coupling slots 610.

FIG. 6B is a side view of example parallel plate waveguide 600 according to another embodiment of the present invention. Parallel plate waveguide 600 includes ground planes 602a-b and dielectric 608, which is provided between ground planes 602a-b. Ground planes 602a-b are substantially parallel in the embodiment of FIG. 6B. Ground plane 602a has a slot 610 through which RF power radiates. For example, RF power may radiate through slot 610 into a pallet stack.

An incident vertically polarized electric field (E_{inc}) may excite parallel plate waveguide 600 by impressing a voltage between ground planes 602a-b. The relatively tall transition region 624 at the edge of parallel plate waveguide 600 is an impedance matching device. According to an embodiment, parallel plate waveguide 600 (1) is configured to have a transition region 624 at the perimeter of parallel plate waveguide 600 which allows efficient capture of RF energy at 900 MHz, (2) is configured to have resonant coupling slots (e.g., slot 610) with the proper coupling level to permit roughly uniform excitation of RF signal strength within the pallet stack, and (3) is configured to have the resonant coupling slots such that they are each tuned on-frequency.

In an embodiment, a reactive, or tuned, transition is present at the perimeter of parallel plate waveguide 600 because without it, the coupling level into parallel plate waveguide 600 having a height of 0.25″ is approximately −15 dB, which is equal to the optical cross section of 0.25″, divided by the vertical period (i.e., case height plus the thickness of parallel plate waveguide 600) of 9.5″.

FIG. 6C is an example asymmetric stepped height transition 630 according to an embodiment of the present invention. In FIG. 6C, the thickness of dielectric 608 steps from 2 inches to 0.25 inches

FIG. 6D is a graphical representation 640 of S-parameters associated with asymmetric stepped height transition 630 according to an embodiment of the present invention. As shown in FIG. 6D, the coupling (or RF cross-section) of asymmetric stepped height transition 630 peaks above −3 dB. Asymmetric stepped height transition 630 is effective at capturing more than 50% of the incident power over the 902-928 MHz RFID band. Asymmetric stepped height transition 630 may be too long at 2.4″ to be used in some practical parallel plate waveguide 600 designs, but it shows the remarkable improvement in S₂₁ that is available with a properly designed transition.

The length of transition 630 may be shortened in any of a variety of ways. According to an embodiment, an aperture capacitor that is fabricated as interdigital fingers is used to shorten the transition length. In another embodiment, a linear array of V-shaped coupling apertures cut or etched into a side of parallel plate waveguide 600 is used as a tuned transition.

FIG. 6E shows a parallel plate waveguide 600 having a V-shaped coupling aperture 642 according to an embodiment of the present invention. In the embodiment of FIG. 6E, V-shaped coupling aperture 642 is etched into the upper plate of parallel plate waveguide 600. The edge of parallel plate waveguide 600 has a shorting wall 644 of height t. Because V-shaped coupling aperture 642 is symmetric about it center, and the plane wave is incident from the −x direction, it is sufficient to simulate half of V-shaped coupling aperture 642 using a magnetic wall boundary condition along the plane of symmetry to predict the full-wave performance. The configuration shown in FIG. 6E is not optimized, but the coupling level, S₂₁, peaks at approximately −6 dB. In other words, approximately 25% of the incident power is captured. At least eight variables are used to uniquely define a transition of V-shaped coupling aperture 642.

FIG. 6F illustrates a parallel plate waveguide 600 having a plurality of transition coupling slots 646 and tag coupling slots 648 according to an embodiment of the present invention. Transition coupling slots 646 couple power into parallel plate waveguide 600 at transition region 630, which extends along the perimeter of parallel plate waveguide 600 in FIG. 6F. Tag coupling slots 648 allow the power to radiate from parallel plate waveguide 600 to tags 100 (not shown). In FIG. 6F, transition coupling slots 646 and tag coupling slots 648 are shown as V-shaped coupling apertures and crosses, respectively, for illustrative purposes. However, the example shapes provided in FIG. 6F are not intended to limit the scope of the present invention. Transition coupling slots 646 and tag coupling slots 648 may be any of a variety of shapes.

FIG. 6G illustrates several types of resonant coupling slots according to embodiments of the present invention. In FIG. 6G, parallel plate waveguide 600 includes slots shaped as bowties 652, crossed bowties 654, slanted slots 656, and L-slots 658, to provide some examples. The list of slot shapes provided herein is not intended to be an exhaustive list. The resonant coupling slots may be any shape. Persons skilled in the art will recognize that parallel plate waveguide 600 can include any of a variety of combinations of transition coupling slots and tag coupling slots, for example.

In FIG. 6G, the center-to-center distance between slots in the x direction is referred to as the “x period”, and the center-to-center distance between slots in the y direction is referred to as the “y direction”. The x period and the y period may be different for different applications. For example, the x period and the y period may be provided as variables to be determined through testing and/or computer optimization, as would be understood by persons skilled in the relevant art(s).

TE and TM mode surface waveguides 500 and 550, respectively, as described above with reference to FIGS. 5A-5F, have fewer design variables, as compared to parallel plate waveguide 600. On the other hand, parallel plate waveguide 600 requires fewer layers of metal than TE and TM mode surface waveguides 500 and 550. Parallel plate waveguide 600 may be less expensive to fabricate in large volume production than TE and TM mode surface waveguides 500 and 550.

2.3 TM Mode Surface Waveguide Embodiment

FIG. 5F shows an example transverse magnetic (TM) mode surface waveguide 550 according to an embodiment of the present invention. In FIG. 5F; TM mode surface waveguide 550 is similar to TE mode surface waveguide 500 shown in FIG. 5C. However, the fields associated with a signal that propagates as a TM mode surface wave are aligned differently than those associated with a signal that propagates as a TE mode surface wave. A signal propagating as a TM mode surface wave has an associated electric field having a normal component (z directed) and a longitudinal component (x directed) and an associated magnetic field component (y directed) that is perpendicular (transverse) to the direction of propagation of the wave (x directed) and tangential to the surface of the waveguide. In FIG. 5F, tag 100 is affixed to the side of cardboard case 516 (perpendicular to waveguide 550), rather than the top of cardboard case 516 (parallel to waveguide 500) as shown in the TE mode surface waveguide embodiment of FIG. 5C. Positioning tag 100 on the side of cardboard case 516 allows tag 100 to couple into the z-directed electric field of the TM mode.

The same grounded-capacitive FSS that may guide a TE mode may also guide a TM mode. However, the field decay rate in the transverse direction for the TM mode is extremely weak. This means that the TM mode will be poorly attached to TM mode surface waveguide 550. For example, more energy may be guided in an air region exterior to TM mode surface waveguide 550 than within TM mode surface waveguide 550. In FIG. 5F, much of the guided power may quickly be consumed by shampoo stored in case 516, because the decay rate for the electric field is on the order of approximately 0.05 dB per inch at 900 MHz.

To force the TM mode to be more tightly bound to the surface of TM mode surface waveguide 550 (or to raise the TM mode surface reactance) one can introduce vertical conductors or vias between metallization layer 502c and Cohn squares 504. Introducing vertical conductors or vias may significantly increase manufacturing cost, for example, for both a prototype and potential large volume production.

2.4 Hard Electromagnetic Surface Embodiment

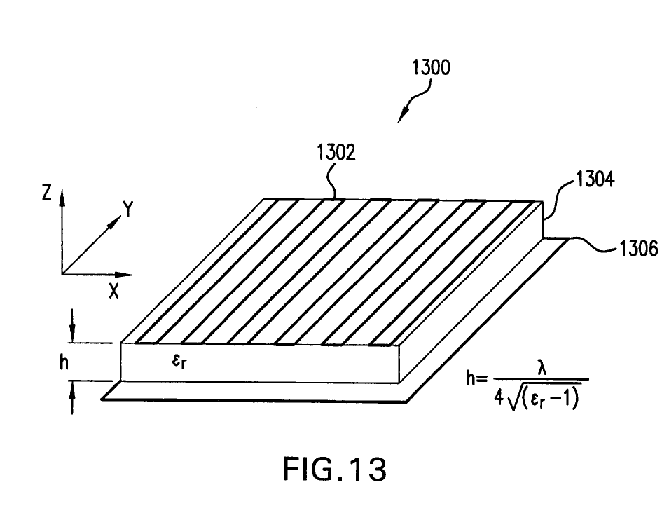

FIG. 13 shows an example hard electromagnetic surface waveguide 1300 according to an embodiment of the present invention. Hard electromagnetic surface waveguide 1300 includes longitudinal strips 1302, a ground plane 1306, and a dielectric layer 1304 between longitudinal strips 1302 and ground plane 1306.

Hard surfaces are able to guide a TEM mode along the surface with a Poynting vector aligned with the longitudinal direction of longitudinal strips 1302. The TEM wave sees a low impedance along longitudinal strips 1302 and a high impedance for directions transverse to longitudinal strips 1302. Longitudinal strips 1302 provide an anisotropic reactive surface.

Referring to FIG. 13, recent research suggests that the TEM mode decays with distance away from the surface at frequencies above the mid-band frequency of operation. Experimental evidence suggests that vertically polarized waves are strongly attached to anisotropic reactive surfaces, such as that provided by longitudinal strips 1302, much more so than for a simple ground plane.

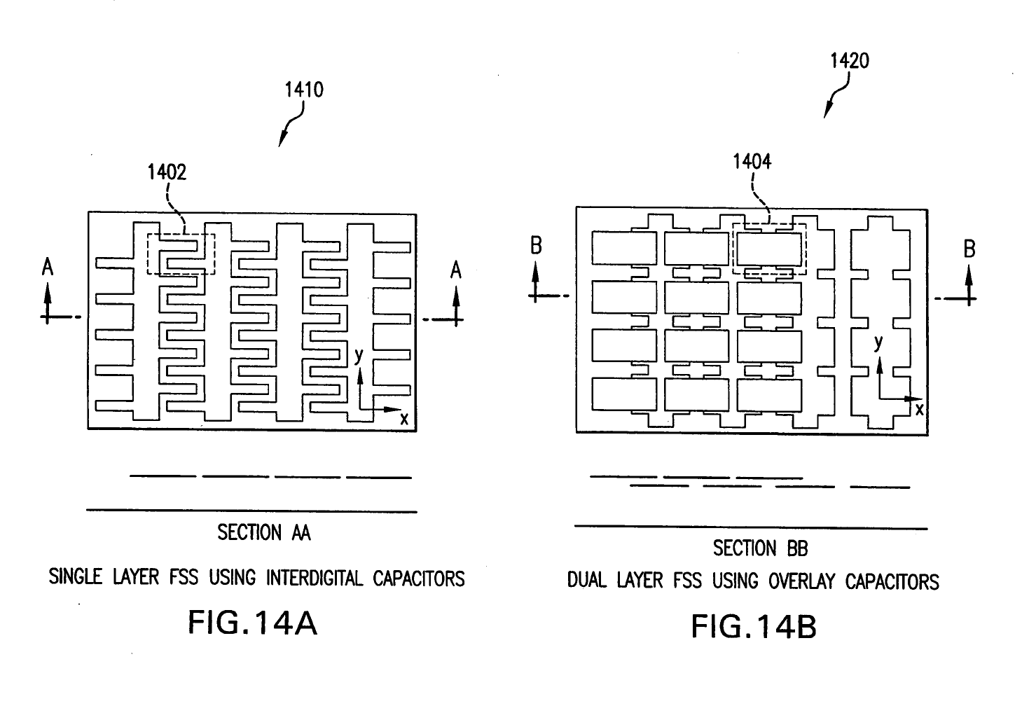

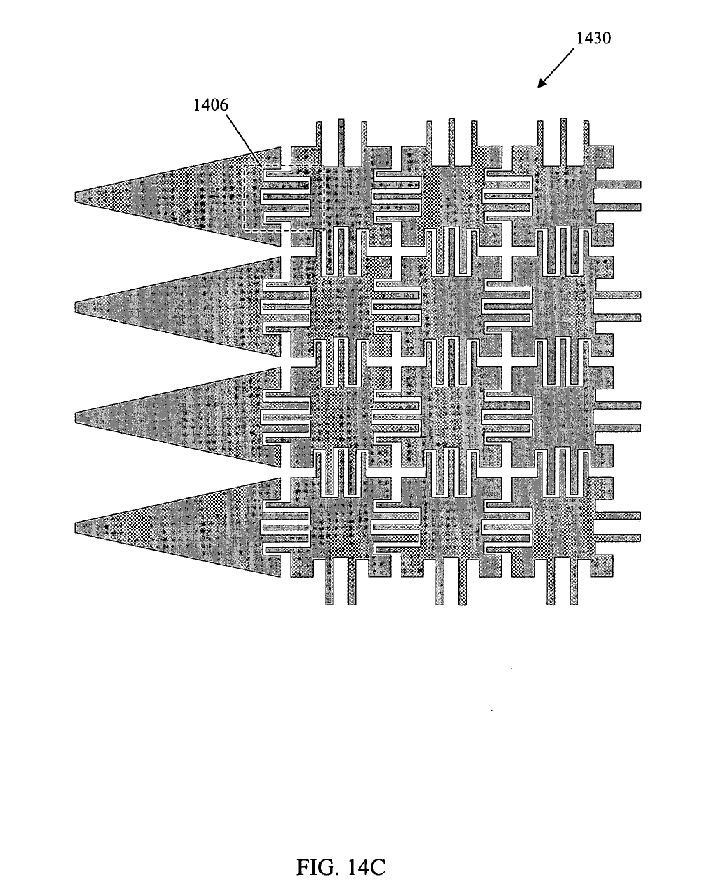

Dielectric layer 1304 of hard electromagnetic surface waveguide 1300 may be too thick and/or heavy for some 900 MHz applications. However, hard surfaces may be manufactured with lower profile and/or less mass by loading longitudinal strips 1302 with capacitance in the transverse direction. Increasing the capacitance of longitudinal strips 1302 may be achieved in any of a variety of ways. FIG. 14A shows a single-layer FSS 1410 (e.g., hard electromagnetic surface waveguide 1300) having interdigital capacitors 1402 according to an embodiment of the present invention. FIG. 14C shows a single-layer FSS 1430 having interdigital capacitors 1406 according to another embodiment of the present invention. FIG. 14B shows a dual-layer FSS 1420 having overlay capacitors 1404 according to yet another embodiment of the present invention. In FIG. 14B, overlay capacitors 1404 may be formed using overlapping metallic patches, such as Cohn squares.

### 3.0 Testing Some Example Waveguide Embodiments

The example waveguides described above in sections 2.1, 2.2, and 2.3 are provided for illustrative purposes only and are not intended to limit the scope of the invention. Following is a list of example waveguide design steps that were implemented to determine the waveguides used.

Task 1: Identification of Potential Solutions—Potential solutions that were considered include electromagnetic surface waveguides capable of guiding either TE or TM modes, as well as parallel-plate waveguide modes.

Task 2: Risk Matrix—A cost and technical risk assessment was created for the potential waveguide solutions.

Task 3: Electromagnetic Simulations—The proposed solutions were simulated with the computational electromagnetic code Microstripes™ to identify propagation decay rates in a lossy environment, which was intended to simulate the cases of shampoo. The simulations included a Debye model for the shampoo.

Task 4: Prototype Fabrication—Customer components were fabricated, and five units of a waveguide prototype were thereafter assembled.

Task 5: RF Testing—The result of reading into a pallet stack of shampoo when using the prototype waveguide units was quantified.

Task 6: Final Report.

The following are example design parameters in example embodiments, provided for illustrative purposes:

### 1. The footprint of the waveguide is 40″×48″.

### 2. The thickness of the waveguide is ¼″ maximum except at the edges.

### 3. The waveguide operates from at least 860 MHz to 960 MHz.

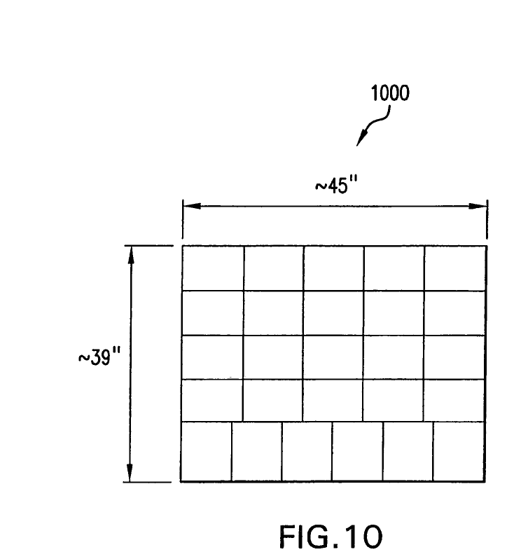

### 4. The waveguide is compatible with the example pallet-stacking pattern 1000 of FIG. 10.

In an example environment, the objects are cardboard cases of Pantene® shampoo that are 9.25″ tall and occupy a footprint of 7.5″×9.0″. Each case contains six 750 ml bottles of shampoo. Each layer includes twenty-six cases, and each pallet includes five layers. Thus, each pallet stack contains 130 cases of shampoo, or 780 bottles.

According to an embodiment, a boundary condition is that the RFID tags can be placed at any location on the exterior of the cardboard cases: top or sides.

The example test configurations described below may be applied to any waveguide. Thus, references will be made generally to waveguide 210, as described above with respect to FIGS. 2A and 2B.

3.1 Testing the TE Mode Surface Waveguide Embodiment

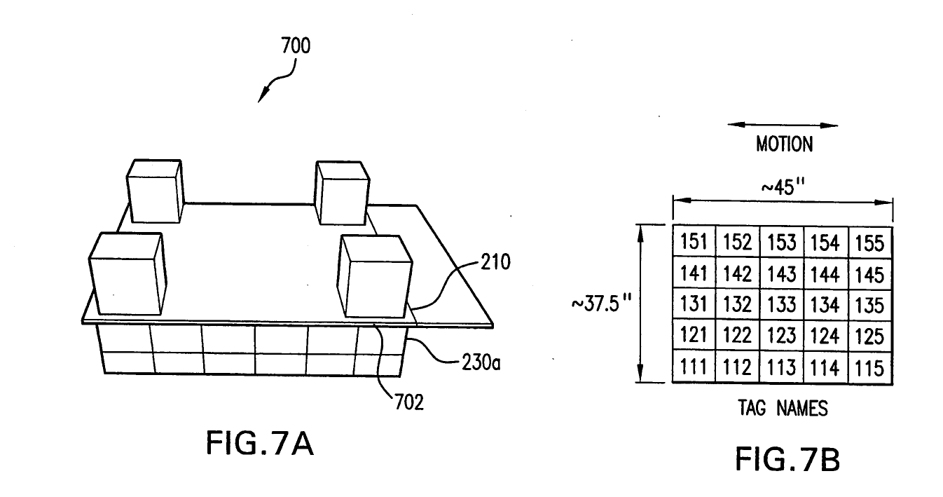

FIG. 7A shows a first example test configuration 700 for TE mode surface waveguide 500 shown in FIG. 5 according to an embodiment of the present invention. In the embodiment of FIG. 7A, layer 230a is 39″ wide and includes 26 cases. FIG. 7B shows a modified stacking pattern for configuration 700 according to an embodiment of the present invention. The modified stacking pattern of FIG. 7B allows more of waveguide 210 to be exposed to portal antennas, for example. In FIG. 7B, layer 230a includes twenty-five cases of Pantene® shampoo. As shown in FIG. 7B, layer 230a has a width of approximately 37.5″ and a length of approximately 45″.

In configuration 700, a white, ⅜″ thick foamboard 702 is placed between waveguide 210 and tags that are affixed to the cases in layer 230a to improve RF performance. Configuration 700 enables 24-25 of the 25 cases (i.e., 96-100%) in layer 230a to be reliably read.

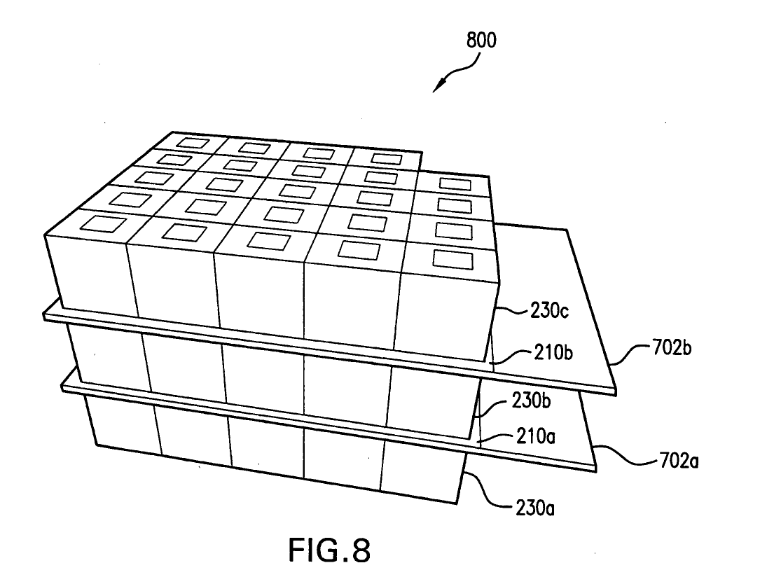

FIG. 8 shows a second example test configuration 800 for TE mode surface waveguide 500 shown in FIG. 5 according to an embodiment of the present invention. In the embodiment of FIG. 8, three layers 230a-c of Pantene® shampoo cases are tested. Each of layers 230a and 230b includes twenty-five cases, and layer 230c includes twenty-four cases. Waveguide 210a and foamboard 702a are between layers 230a and 230b. Waveguide 210b and foamboard 702b are between layers 230b and 230c. The proximity of Pantene® shampoo bottles in cases of layer 230b to the edge of waveguide 210a causes a degradation in RF performance, as compared to configuration 700. In an example test embodiment, configuration 800 enabled fifteen of the cases in layer 230a to be read, ten cases in layer 230b to be read, and all twenty-four cases in layer 230c to be read.

Following are six comments regarding the testing of TE mode surface waveguide 500 using configurations 700 and 800 as illustrated in FIGS. 7 and 8, respectively.

1. The TE mode surface waveguides 500 fabricated for these tests have significant metal losses. The excess series resistance for the capacitive frequency selective structure or surface (FSS), measured at RF frequencies, is approximately 2 ohms per square. This is due to the finite resistivity of the conductive ink used in the silk-screening process. Different manufacturing methods may be used which may offer an order of magnitude improvement in resistivity, for example.

2. For a single-layer stack of Pantene® shampoo, the prototype TE mode surface waveguides 500 offered a 96% read rate. This is a very good result, especially in light of the losses in the FSS. When a second layer (i.e., layer 230b) of cases is added to the stack, the read rate fell to 15 out of 25 for layer 230a due to power absorbed by shampoo near the transition region.

3. Progressively thicker foam spacers between the FSS and the tags offer better read rates. For example, 4″ crossed dipole tags may be detuned when placed in close proximity to a TE mode surface waveguide 500. Tags designed for higher dielectric environments or different dielectric environments may be appropriate for this application.

4. One type of RFID tag was used in these initial experiments: a 4″ crossed dipole tag designed as an unloaded tag to be resonant near 915 MHz. Any of a variety of tags may be used. For example, simple dipoles, which offer more mounting options on the sides of cases, may be used.

5. The tapered slot transition region may be exposed as much as possible to provide maximum power transfer into the TE mode waveguide.

6. The forward link margin can be improved.

According to an embodiment, TE mode surface waveguides 500 are fabricated on (or affixed to) shelves or the sides or top of cardboard cases to guide RF energy from an RFID reader into a stack that includes the cases. In this embodiment, a discontinuity exists between TE mode surface waveguides 500 of adjacent cases. The discontinuity may limit power transfer from case to case, as compared to a larger, rigid waveguide that fits between horizontal layers of a stack. In embodiments, such as FIG. 2B, which has larger, rigid waveguides 210, discontinuities are reduced to only two: the transition at the edge of the pallet, and the actual coupling of waveguide fields into a tag 100.

3.2 Testing the Parallel Plate Waveguide Embodiment

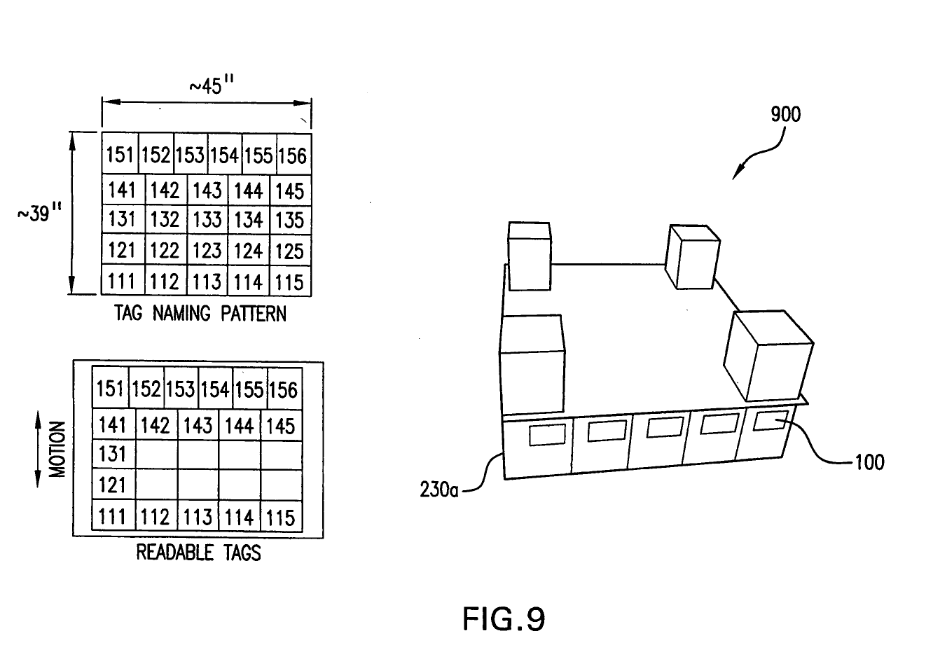

FIG. 9 shows an example test configuration 900 for parallel plate waveguide 600 shown in FIG. 6 according to an embodiment of the present invention. In the embodiment of FIG. 9, each case in layer 230a has a 4″ crossed dipole tag 100 affixed to its side. During an example test, configuration 900 enabled eighteen of the twenty-six tags 100 in layer 230a, including one entire row of interior tags 100, to be reliably read.

### 4.0 Dielectric Material Measurements

Given the large number of potential design variables for a waveguide, numerical simulation tools may be used to accelerate the design process. One design variable that is used in the simulation of a waveguide approach is the nature of the lossy dielectric. For example, measurements may be made of the lossy dielectric and provided to a simulation tool to facilitate designing the waveguide.

The dielectric used in the tests described herein is Pantene Pro-V® shampoo. Damaskos, Inc. of Concordville, Pa. was commissioned to conduct dielectric measurements of the Pantene Pro-V® shampoo. The measurements were performed over a broad frequency range, extending approximately one decade above and one decade below the RFID band, because the measurements were to be used in broadband time domain simulations.

A three-pole Debye model, as provided in Equation 1, can be applied to the measured data. In the following Debye model, frequency is given in GHz.

$$ɛ ( f ) = 12.5 - j \frac{3.59}{2 π f {10}^{9} {ɛ}_{o}} + \frac{6.5}{1 + j ( \frac{f}{0.4} )} + \frac{8.8}{1 + j ( \frac{f}{1.6} )} + \frac{35}{1 + j ( \frac{f}{15.5} )} \qquad Equation 1$$

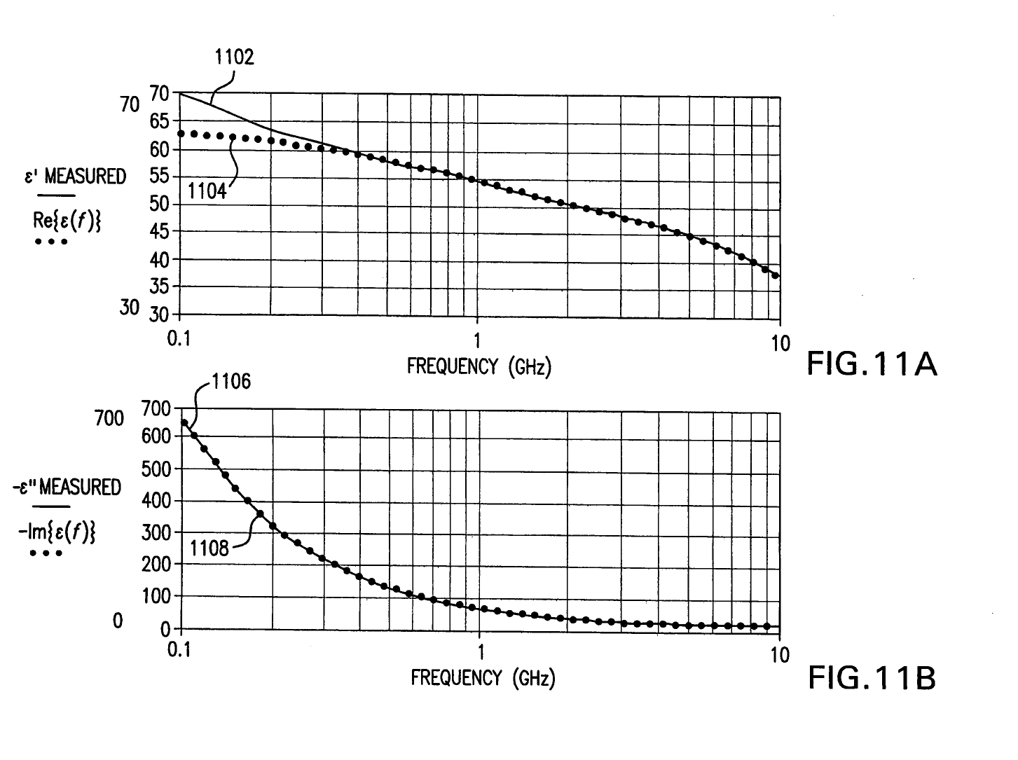

FIGS. 11A and 11B provide graphical comparisons between the measured data and modeled data for the real and imaginary parts, respectively, of the dielectric constant of Pantene Pro-V® shampoo according to embodiments of the present invention. In FIG. 11A, the measured real data is represented by solid line 1102, and the modeled real data is represented by dotted line 1104. In FIG. 11B, the measured imaginary data is represented by solid line 1106, and the modeled imaginary data is represented by dotted line 1108.

Following are three example observations that may be drawn from the Debye model. First, the Debye poles are found at frequencies of 0.4 GHz, 1.6 GHz, and 15.5 GHz. For more economical numerical simulations, the highest frequency pole at 15.5 GHz may be ignored, because its contribution is more than a decade above the RFID band. According to the Debye model, the real part of the relative permittivity of the Pantene Pro-V® shampoo at an infinite frequency is 12.5, as indicated by the first term in Equation 1. A step change in permittivity of 35 can be added to the residual permittivity at infinity to reduce the number of poles associated with the Debye model. The step change speeds up the time required for simulation by approximately 30% because the evaluation time of a Debye material within Microstripes™, for example, is proportional to the number of poles.

Second, the direct current (DC) conductivity is found from the second term of Equation 1 to be 3.59 S/m, which is very similar to seawater at 4.0 S/m. If this DC conductivity is ignored, the model will likely have errors in accuracy. As illustrated in FIG. 11B, the second term of Equation 1 causes ∈″ (i.e., the imaginary part of the dielectric constant of Pantene Pro-V® shampoo) to increase substantially as frequency goes to zero.

Third, the absolute value of both the real relative permittivity (∈″), as shown in FIG. 11A, and the imaginary relative permittivity (∈″), as shown in FIG. 11B, is quite high compared to corresponding values for air. For example, the relative permittivity of the Pantene Pro-V® shampoo is on the order of 55-j85 at a frequency of 900 MHz. A significant reflection occurs at 900 MHz for a plane wave incident upon a pallet stack of Pantene Pro-V® shampoo, as described in greater detail below.

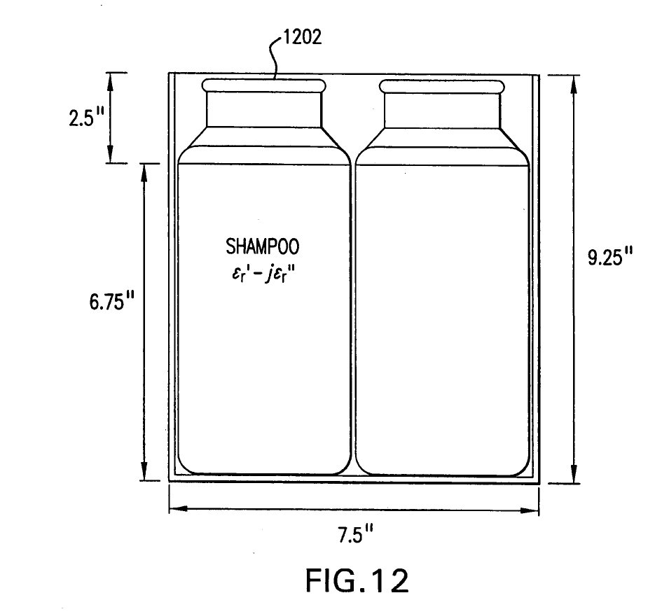

FIG. 12 illustrates the placement of 750 ml Pantene Pro-V® shampoo bottles 1202 in cases that were used for testing configurations 700-1000 described above with reference to FIGS. 7-10 according to an embodiment of the present invention. In FIG. 12, the top 2.5 inches inside the case is devoid of a lossy dielectric material. The bottles are approximately elliptic in cross-section with major and minor axes of 3.3″ and 2.85″, respectively.

### 5.0 Further Discussion of Some Example Waveguide Embodiments

5.1 TE Mode Surface Waveguide Embodiment

5.1.1 Design of a Prototype TE Mode Waveguide

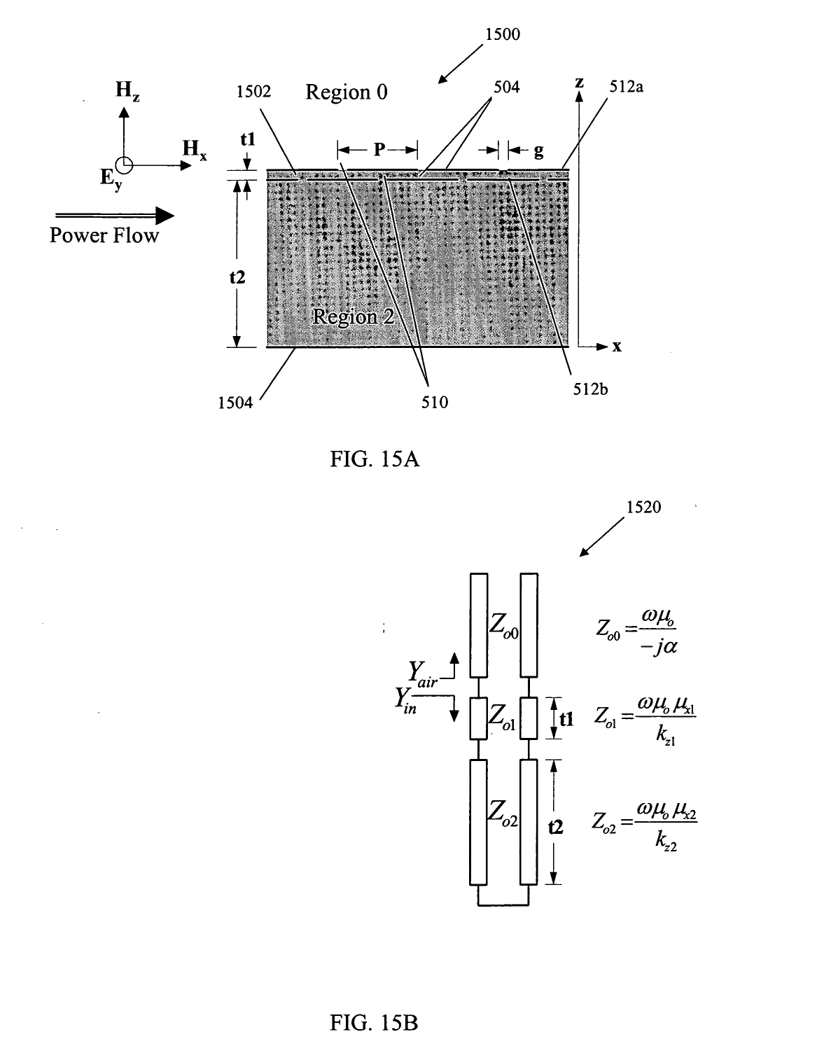

FIG. 15A is a side view of another example TE mode surface waveguide 1500 according to an embodiment of the present invention. In the embodiment of FIG. 15A, TE mode surface waveguide 1500 includes a capacitive frequency selective surface (FSS) 1502 offset a distance t₂ from a plane 1504. Plane 1504 may be a ground plane or a metal foil, to provide some examples. Surface wave propagation along TE mode surface waveguide 1500 can be analyzed using the transverse resonance method in which a transmission line models standing waves in the direction normal to surface 512a or 512b. This type of wave has an electric field, E_{y}, transverse to the direction of propagation, and a longitudinal magnetic field, Hₓ. Assuming that the surface wave power propagates in the +x direction, an equivalent transmission line 1520 for wave propagation k_{z} in the z direction may be derived, as shown in FIG. 15B. Enforcing the continuity of tangential electric and magnetic fields at a convenient boundary such as surface 512a or 512b yields the transverse resonance equation Yᵢₙ+Yₐᵢᵣ=0, where Yₐᵢᵣ=−jα/(ωμ₀) and

$${Y}_{i n} = \frac{{k}_{z 1}}{{ωμ}_{o} {μ}_{x 1}} \frac{- j \frac{{k}_{z 2}}{{ωμ}_{o} {μ}_{x 2}} cot ( {k}_{z 2} {t}_{2} ) cos ( {k}_{z 1} {t}_{1} ) + j \frac{{k}_{z 1}}{{ωμ}_{o} {μ}_{x 1}} sin ( {k}_{z 1} {t}_{1} )}{\frac{{k}_{z 1}}{{ωμ}_{o} {μ}_{x 1}} ( {k}_{z 1} {t}_{1} ) + \frac{{k}_{z 2}}{{ωμ}_{o} {μ}_{x 2}} cot ( {k}_{z 2} {t}_{2} ) sin ( {k}_{z 1} {t}_{1} )}$$

As illustrated in the embodiment of FIG. 5B, the surface wave fields decay exponentially beyond surfaces 512a and 512b. This phenomenon applies to TE mode surface waveguide 1500 as shown in FIG. 15A, as well. Thus, an imaginary propagation constant k_{z0}=−jα, which is consistent with zero power flow in the z direction, may be employed in the simulation of TE mode surface waveguide 1500. The positive real parameter α is the exponential decay factor.

The transverse resonance equation may be solved for the decay constant α to yield

$$\begin{matrix}α = \frac{{ωμ}_{o}}{j} {Y}_{i n} \\ = \frac{{k}_{z 1}}{{μ}_{x 1}} \\ \frac{- \frac{{k}_{z 2}}{{ωμ}_{o} {μ}_{x 2}} cot ( {k}_{z 2} {t}_{2} ) cos ( {k}_{z 1} {t}_{1} ) + \frac{{k}_{z 1}}{{ωμ}_{o} {μ}_{x 1}} sin ( {k}_{z 1} {t}_{1} )}{\frac{{k}_{z 1}}{{ωμ}_{o} {μ}_{x 1}} cos ( {k}_{z 1} {t}_{1} ) + \frac{{k}_{z 2}}{{ωμ}_{o} {μ}_{x 2}} cot ( {k}_{z 2} {t}_{2} ) sin ( {k}_{z 1} {t}_{1} )}\end{matrix}$$

having units of Nepers per meter. Substitution of α back into the dispersion equation for the air region kₓ²+k_{z0}²=k₀² yields the dispersion relation for the x-directed TE wave propagation:

kₓ^{TE}={square root over (k₀²+α(k_{z1}(kₓ),k_{z2}(kₓ))²)}

In the embodiments described herein, kₓ is the same value inside and outside of the surface waveguide because the wave travels at the same velocity in both regions. Solutions to the dispersion equation reveal the frequency ω at which the value of kₓ is possible.

As illustrated in FIG. 15A, FSS 1502 is formed using overlapping conductive patches 504, making it an anisotropic media because both μ and ∈ have different transverse and normal parameters. Accordingly, μ and ∈ may be represented by tensors. For TE waves traveling in an anisotropic media, the z-directed propagation constants are given as

$${k}_{z 1 , 2} = {k}_{0} \sqrt{{μ}_{x 1 , 2} {ɛ}_{y 1 , 2} - {( \frac{{k}_{x}}{{k}_{0}} )}^{2} \frac{{μ}_{x 1 , 2}}{{μ}_{z 1 , 2}}}$$

The constituent parameters of each layer, μ_{x1,2} and ∈_{y1,2}, are linked to the physical construction of the waveguide. The transverse permittivity is one of two key engineering factors to determine the onset of TE mode propagation. The transverse permittivity may be represented as ∈_{y1}=C/(∈₀t), where the effective sheet capacitance C is the parallel-plate capacitance found in one quadrant of overlapping square patches 504. Assuming equal sizes of overlapping square patches 504 on both layers of FSS 1502, the effective sheet capacitance is approximated as

$$C = \frac{{ɛ}_{o} {{ɛ}_{r 1} ( \frac{P - g}{2} )}^{2}}{{t}_{1}}$$

Referring to FIG. 15A, P is defined as the period of FSS 1502 in the longitudinal and transverse (x and y) directions, and g is the gap dimension. Variables t₁ and ∈ᵣ₁ are the thickness and relative dielectric constant, respectively, of FSS 1502. The relative dielectric constant ∈_{y1} is a relatively large value, typically on the order of hundreds to thousands; whereas, the tensor permeabilities are less than or equal to one. The longitudinal and normal relative permeabilities may be represented as μₓ₁=1 and μ_{z1}≅2.5/(∈_{y1}/∈ᵣ₁) respectively. The normal relative permeability μ_{z1} is typically on the order of 10⁻³ because ∈_{y1} is so large. For example, overlapping patches 504 may create an environment that impedes the flow of magnetic flux through FSS 1502 by constricting the magnetic flux to flow into the narrow gaps 510 between patches 504.

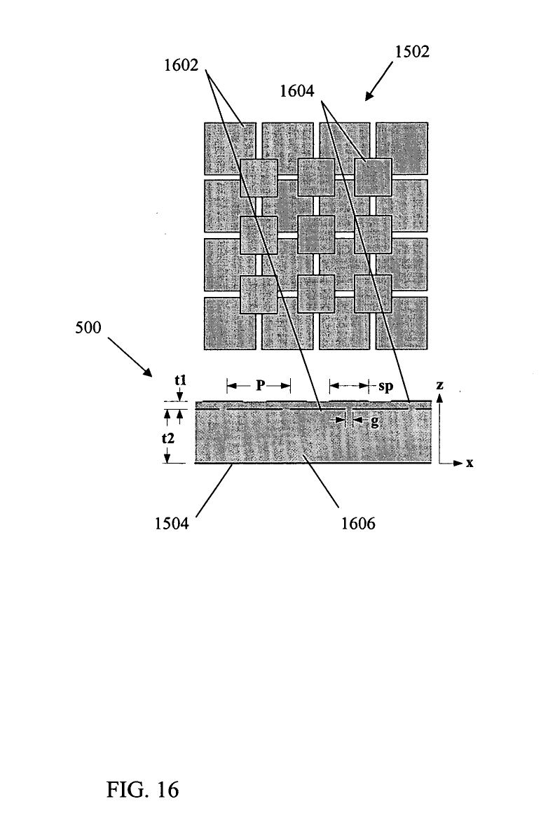

The TE mode transverse resonance calculations described above may be performed using any of a variety of software programs, firmware, hardware, or any combination thereof. For example, the calculations may be performed using a Mathcad™ file. For the TE mode embodiments described herein multiple iterations were performed to determine how large patches 504 should be to achieve a cutoff sufficiently below a predetermined frequency (900 MHz in this example) such that the fields decay approximately 6 dB over the distance between the surface of TE mode surface waveguide 1500 and the absorptive Pantene shampoo. In the final design, a rather arbitrary period P of one inch was chosen, with larger patches 1602 on one side and smaller patches 1604 on the other, as shown in the embodiment of FIG. 16.

Referring to FIG. 16, the thickness of FSS 1502 is represented as t1=5 mils, the thickness of spacer layer 1606 is represented as t2=250 mils, the permittivity of FSS 1502 is represented as ∈ᵣ₁=3.2, the permittivity of spacer layer 1606 is represented as ∈ᵣ₂=1, the period of FSS 1502 is represented as P=1000 mils, the gap between patches 1602 is represented as g=100 mils, and the length of patches 1604 is represented as sp=450 mils. Assuming that propagation is in the x direction, the TE mode fields are E_{y}, Hₓ, and H_{z}.

Given the dissimilar patch sizes on opposing layers of FSS 1502, the effective sheet capacitance is controlled by the size of smaller patches 1604 alone, because patches 1604 determine the overlap area in each quadrant of a unit cell. The effective sheet capacitance of FSS 1502 may be approximated as

$$C = \frac{{ɛ}_{o} {{ɛ}_{r 1} ( \frac{sp - g}{2} )}^{2}}{{t}_{1}} ,$$

having units of Farads/square.

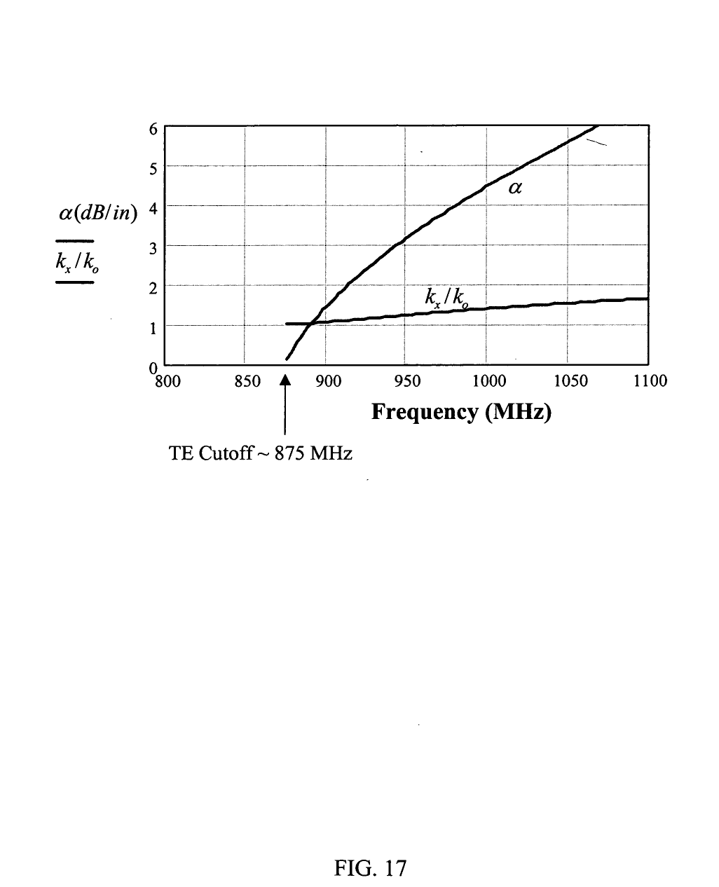

FIG. 17 is a graphical representation of a normalized propagation constant kₓ/k₀ and a field decay constant α with respect to frequency according to an embodiment of the present invention. In FIG. 17, the constants kₓ/k₀ and a are predicted values calculated using the transverse resonance method and the parameters described above with reference to FIG. 16. Referring to FIG. 17, the field decay constant α is associated with fields exterior to the surface of FSS 1502 and has units of dB per inch. The field decay constant α may be computed by multiplying the value of α in Nepers per meter by 8.686 to convert to dB/m, and then dividing by 39.37 to achieve the units of dB/inch. The frequency where the decay constant goes to zero is the TE mode cutoff frequency below which the mode does not propagate. The predicted TE mode cutoff is near 875 MHz for the parameters described with reference to FIG. 16, corresponding with the dimensions of TE mode surface waveguide 1500 shown in FIG. 15A.

The selection of the cutoff frequency is a tradeoff driven by competing factors. In this embodiment, the cutoff frequency is selected to be below the 902-930 MHz RFID band. However, if the cutoff is too high then the decay constant α may be too low, meaning that the TE modal fields are not well confined to the surface of FSS 1502. For instance, the TE modal fields may penetrate deep into the lossy product, which is Pantene shampoo in this example. In this situation, propagation loss may be too great as excess RF power is absorbed in the shampoo.

If the cutoff frequency is too low, the TE wave is tightly bound to the surface as indicated by a high decay constant. In this situation, the wave may be more difficult to launch at the transition region because there is a smaller reaction integral between the plane wave electric field incident upon the pallet, for example, and the exponentially decaying electric field of the TE mode. The prototype design described below is not necessary an optimized design, but demonstrates the RFID waveguide concept.

The purpose of the transverse resonance analysis is to investigate trends and get close to the desired parameter values for the final design. However, because the separation between plane 1504 and FSS 1502 is only ¼ of the period size in this example, it is expected that FSS 1502 might not behave exactly as it would in free space. For instance, higher order Floquet modes are still significant in magnitude within one period of FSS 1502, and placing any obstacle in the near field of FSS 1502 may perturb the net capacitance of FSS 1502. A full-wave simulation may be performed to verify the cutoff frequency is below 900 MHz in this example.

Even with general purpose full-wave simulation tools, engineering approximations are often necessary to render a problem tractable. In this example, the elliptic shape of the shampoo bottles, the non-uniform complex dielectric constant, and the electrically-small period of TE mode surface waveguide 1500 complicate efforts to design a prototype TE mode waveguide. The following simplifications were made to reduce the number of TLM cells in the simulations:

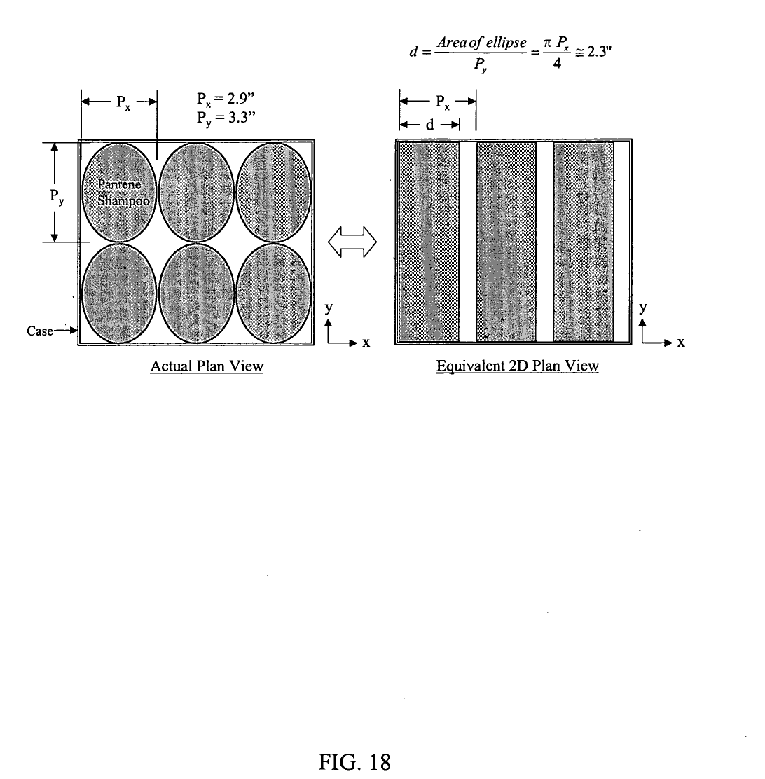

(a) First, it was decided to model transmission through a path involving one case of shampoo rather than multiple cases.
(b) Second, electric wall boundary conditions were used at the planes of symmetry in the physical waveguide (FSS 1502) to form sidewalls for the computational waveguide. This is appropriate given the periodic nature of the TE mode waveguide in the transverse direction.
(c) Third, the 3D elliptic shape of the shampoo bottles was reduced to a 2D problem by homogenizing the transverse features, as illustrated in FIG. 18.
(d) Fourth, the Debye poles whose resonant frequency is higher than the simulation frequency range were omitted from the Debye model. However, the step change in dielectric constant associated with the pole was included in the value at infinity.

The commercial computational electromagnetic code known as Microstripes™ version 6.1 was used to simulate power transmission through one case of Pantene shampoo for a horizontally polarized incident electric field. It will be recognized by persons of ordinary skill in the relevant art(s) that any suitable software program or other means may be used to simulate the power transmission.

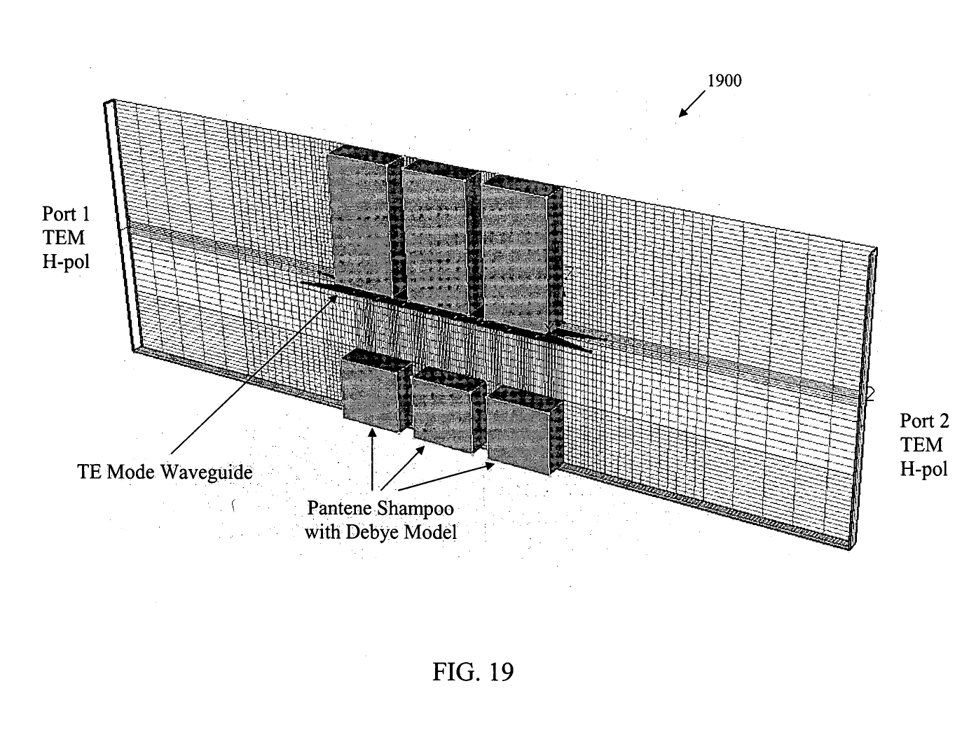

FIG. 19 shows an example gridded model 1900 according to an embodiment of the present invention. The workspace shown is 0.5″ wide, 9.5″ tall, and 28″ in length between TEM ports, though any sized workspace may be used. Boundary conditions are absorbing boundaries at each port, E-walls on the sides, and wrap-around boundary conditions on the top and bottom. In the embodiment of FIG. 19, each Pantene bottle is modeled as a rectangular brick shape, 6.75″ tall, 2.3″ in the x direction or longitudinal direction, and with a 2.9″ period in the longitudinal direction. Gridded model 1900 simulates a wall of Pantene cases that is infinite in both transverse directions. Also, the shampoo is modeled with the Debye dielectric model given as

$$ɛ ( f ) = 12.5 - j \frac{3.59}{2 π f {10}^{9} {ɛ}_{o}} + \frac{6.5}{1 + j ( \frac{f}{0.4} )} + \frac{8.8}{1 + j ( \frac{f}{1.6} )} + \frac{35}{1 + j ( \frac{f}{15.5} )}$$

where f is the frequency in GHz. According to an embodiment, the Debye dielectric model is a fit to measured dielectric data associated with the shampoo.

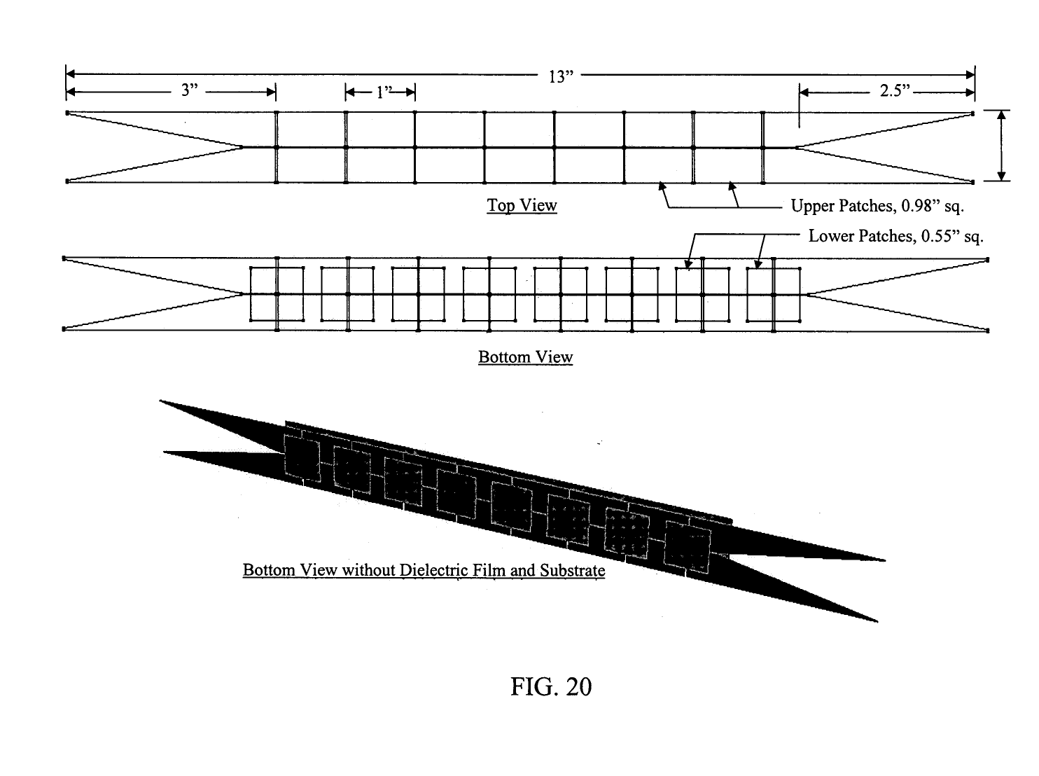

FIG. 20 shows top and bottom views of a TE mode surface waveguide simulated in FIG. 19, according to an embodiment of the present invention. The TE mode surface waveguide in FIG. 20 will be described with continued reference to TE mode surface waveguide 500 shown in FIG. 16 for illustrative purposes. In FIG. 20, patches 1604 are referred to as upper patches and have a length of 0.98″. Patches 1602 are referred to as lower patches and have a length of 0.55″. Spacer layer 1606 includes a dielectric film, having a thickness of 10 mils, ∈ᵣ=3.2, and loss tangent of 0.01 at 1 GHz. The transition regions have a tapered length Lt=2.5″. All gaps are 0.020″. Patches 1602 and 1604 have a period of 1″ in both x and y directions. All metals are modeled with zero thickness and with the surface resistance of copper, Cu. In the embodiment of FIG. 20, ground plane 1504 has a length of 8.1″ and lies 0.25″ above the upper patches.

Referring to FIG. 20, the effective sheet capacitance of FSS 1502 is uniform for both x and y directions. Although the gaps for the slots are smaller in this simulation than the fabricated gaps in the prototype TE mode surface waveguide 500, the results are instructive.

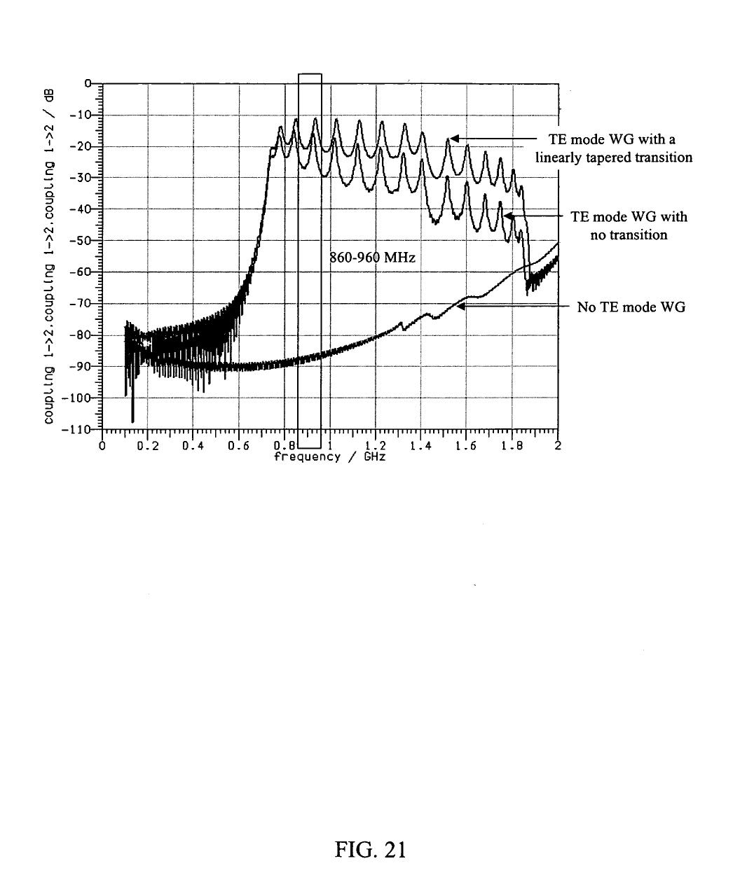

FIG. 21 is a graphical representation of power transmission for gridded model 1900 in FIG. 19, according to an embodiment of the present invention. FIG. 21 illustrates coupling between horizontally polarized TEM mode ports on either end of the Microstripes™ workspace, or on either side of the wall of shampoo. The simulated improvement in transmission at 900 MHz afforded by a TE mode waveguide (e.g., TE mode surface waveguide 1500) is at least 65 dB. The additional improvement afforded by a pair of 2.5″ long tapered transition regions on each end of the TE mode waveguide is simulated to be another 4 dB to 8 dB.

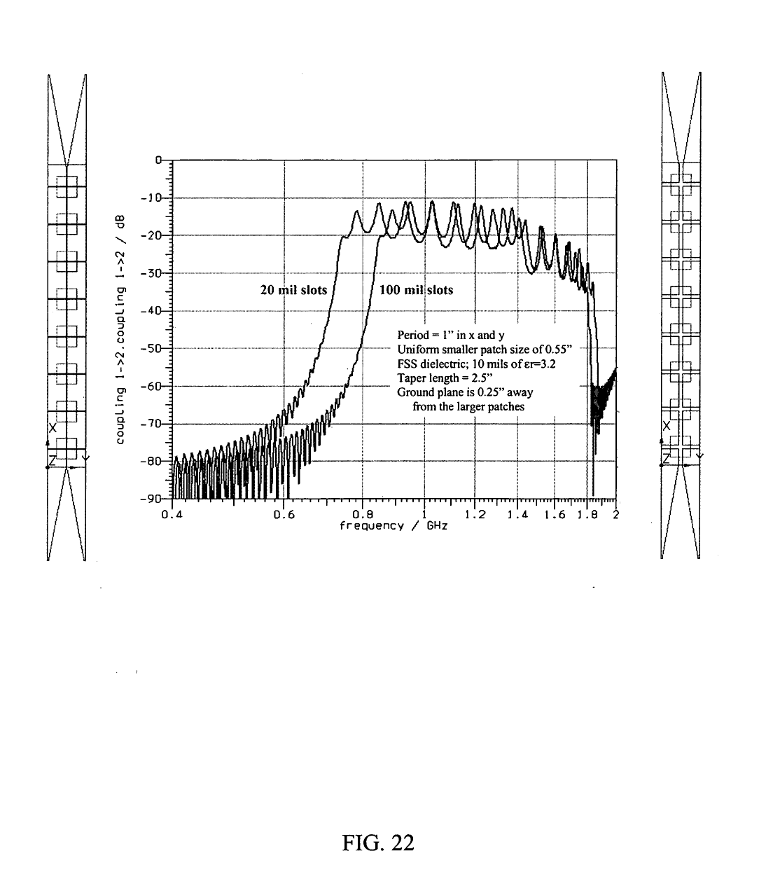

The width of the slots in a capacitive FSS (e.g., FSS 1502) substantially effects the cost of a TE mode waveguide. The width of the slots in gridded model 1900, as shown in FIG. 19, is 20 mils. An additional simulation was performed for 100 mil wide slots. FIG. 22 illustrates a comparison of transmission performance between gridded model 1900 having 20 mil slots and a model having 100 mil slots. The valuable conclusion is that passband ripple, which is caused by impedance mismatch between the transition region and the field of patches, is significantly less when wider slots are employed.

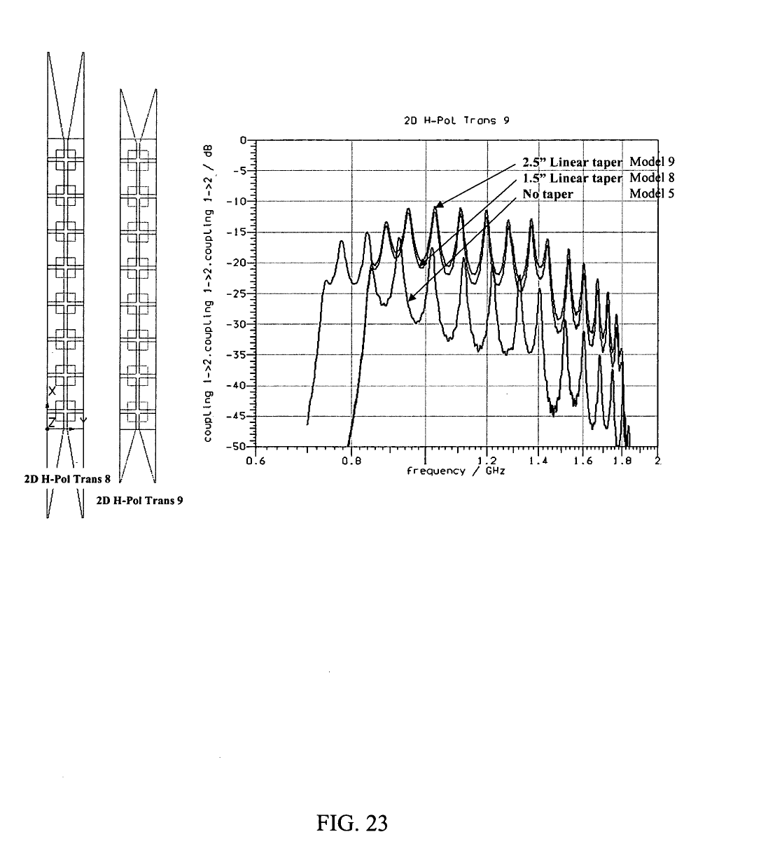

Another variable that impacts the size of a TE mode waveguide is the length of the taper in the transition region. Analysis was performed using models that had no taper, a 1.5″ long taper, and a 2.5″ long taper. FIG. 23 illustrates the impact of the transition taper length on power transmission according to an embodiment of the present invention. In each case, the length of the FSS is 8 periods, or 8″, regardless of the transition region details. The simulations that have tapered transitions used a wider slot of 100 mils (less capacitance), causing the TE mode cutoff frequency to differ.

Referring to FIG. 23, the no-transition simulation has 20 mil slots. All simulations used 1″ periods, 0.55″ small patches, 10 mil films having a relative permittivity of ∈ᵣ=3.2 for the FSS dielectric, and a 0.25″ spacer layer from ground plane to FSS. The net result is that there is at most a 1 dB difference in the RFID band between the two taper lengths in the end-to-end transmission simulation. Because the difference in S₂₁ performance was so small, the shorter 1.5″ long transition was chosen for the final TE mode surface waveguide design. As a constraint, the pallet stack of shampoo is designed such that only 1.5″ is available for the 48″ long TE mode surface waveguide to protrude from the pallet stack on opposite sides (along the narrower, 40″, sides of the pallet).

The Microstripes™ simulations described above were performed using a 10 mil thick PET film for the capacitive FSS. However, the silk-screen vendor offered a 5 mil film, and not a 10 mil film. Thus, a final simulation was run to model this change and to determine whether the TE mode cutoff was lower than the RFID band. The simulation time was exacerbated from approximately 7 hours to 15 hours due to the relatively small cell size required for the 5 mil film. The small square patch size was reduced from 550 mils to 420 mils to maintain the same parallel-plate capacitance for the reduced film thickness.

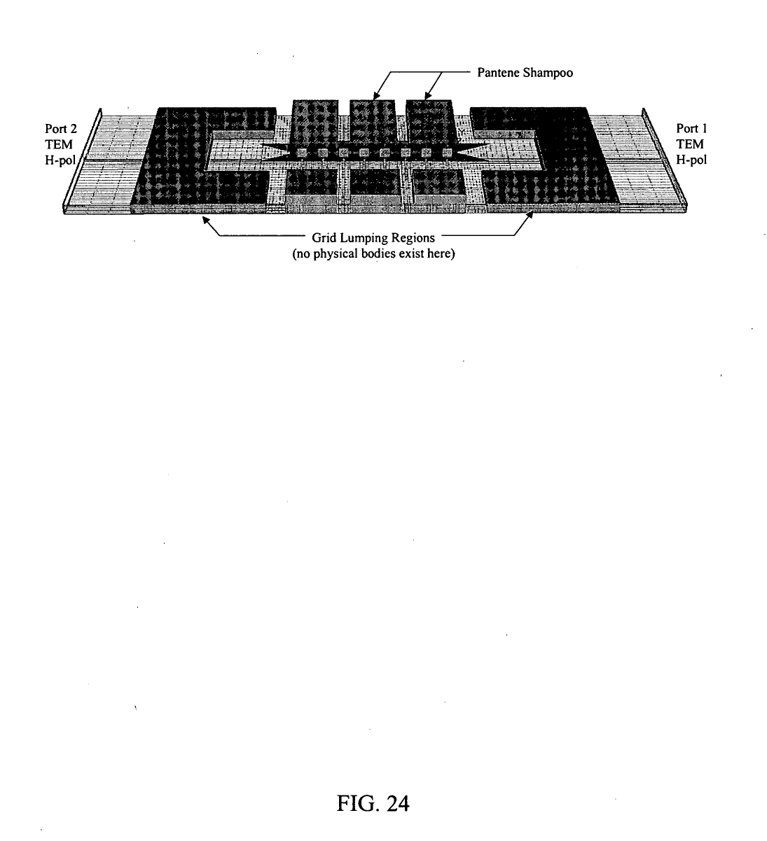

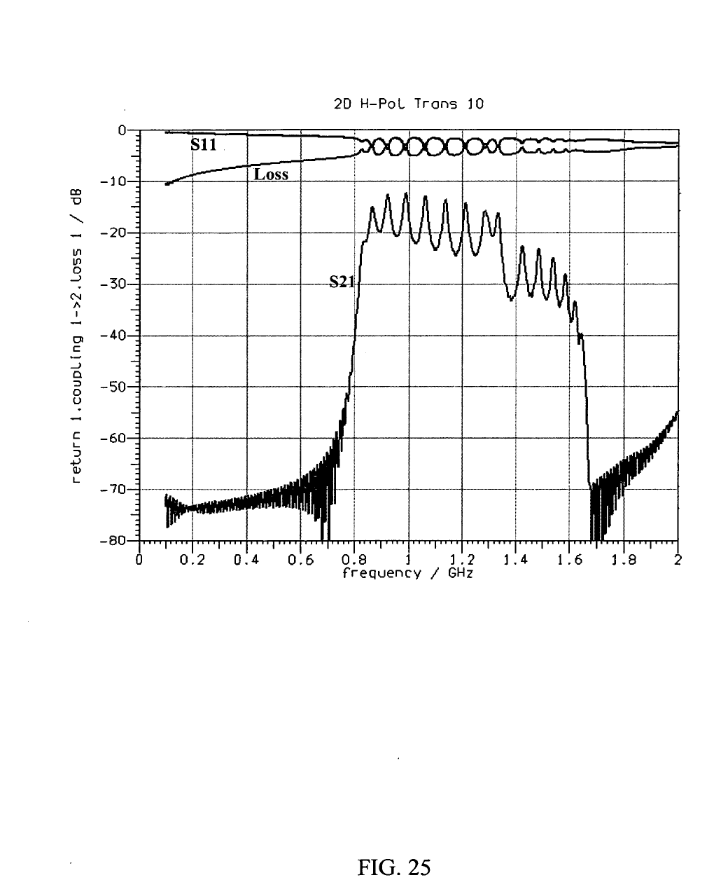

FIG. 24 illustrates a second gridded model 2400 that incorporates a 5 mil film for the FSS according to an embodiment of the present invention. FIG. 25 shows the simulated performance of gridded model 2400. Referring to FIG. 25, the TE mode cutoff of gridded model 2400 is approximately 830 MHz. As shown in FIG. 25, at most frequencies, more than half the incident power is reflected back from the pallet stack, as evidenced by the magnitude of S11 exceeding −3 dB. This is understandable given the relatively high dielectric constant of the Pantene shampoo. However, losses are relatively high, as well, rippling between −5 dB and −3 dB. Aside from the shampoo, the model includes a loss tangent of 0.01 for the FSS film, and the metal in the waveguide is modeled with the resistivity of copper. In the simulations described herein, the peak-to-peak ripple of transmission power associated with the simulations using a 5 mil FSS was substantially the same as the ripple associated with the earlier simulations using a 10 mil FSS.

The simulated time averaged power density at 900 MHz flowing from left to right through the simulated workspace of FIG. 24 reveals the following:
(a) The highest power density is found in the space immediately next to and on both sides of FSS 1502. This finding is consistent with the concept of a skin wave for the TE mode.
(b) The power density along FSS 1502 is approximately 60 dB to 65 dB greater than the power density of the incident wave. This finding indicates that tags 100 should be placed as close as possible to surface a 512 of FSS 1502.
(c) The power density no more than 1″ inside the Pantene shampoo is more than 100 dB lower than the peak power density found along FSS 1502.
(d) Near the output port, the power density is approximately −80 dB; whereas the power density is approximately −60 dB at the input port. This difference is consistent with the plot of S₂₁ in FIG. 25, showing S₂₁=−20 dB at 900 MHz.

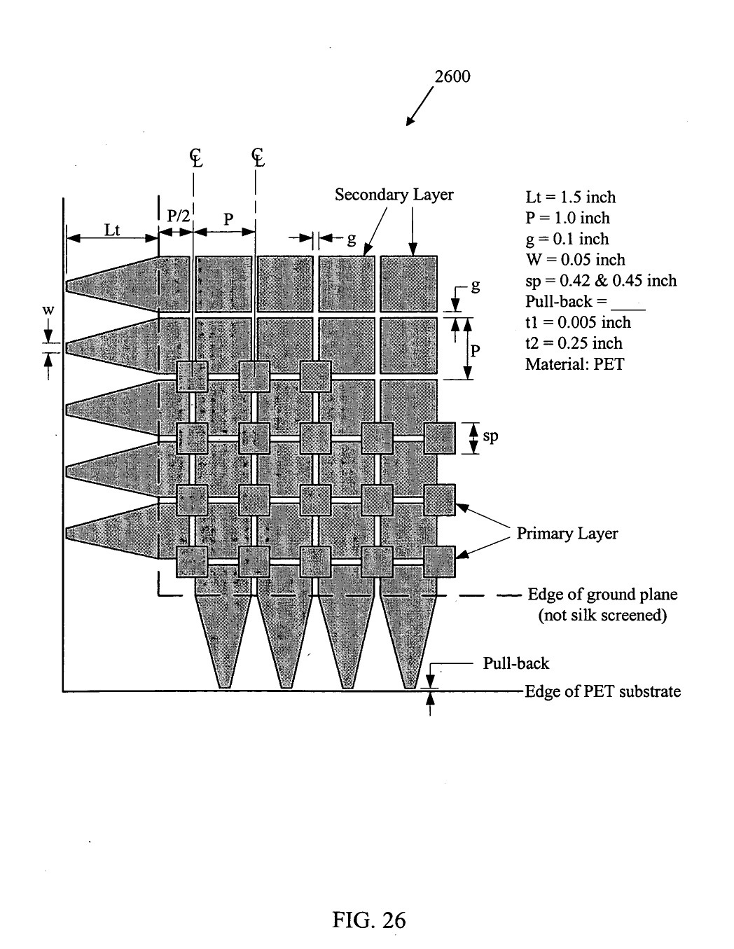

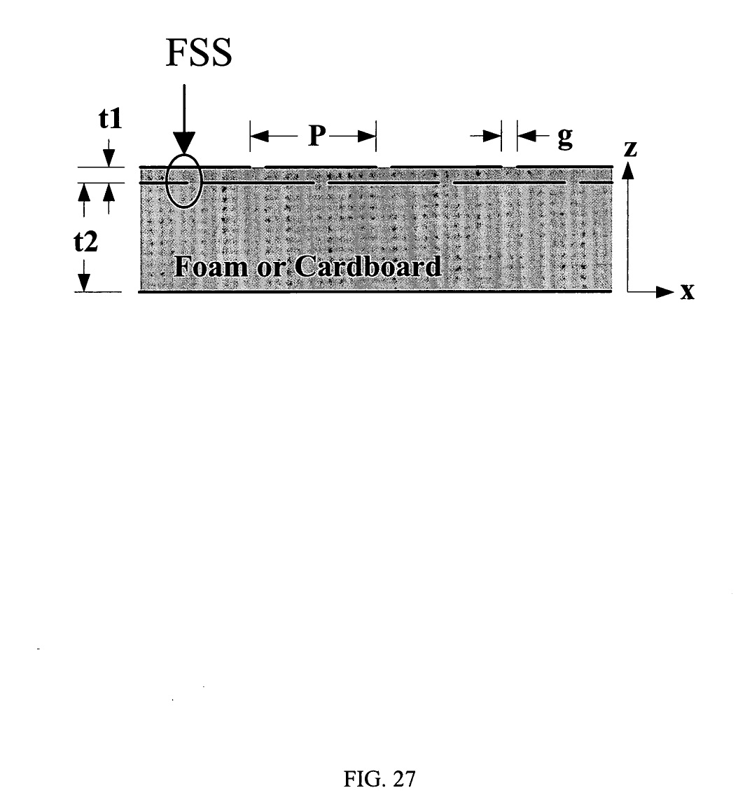

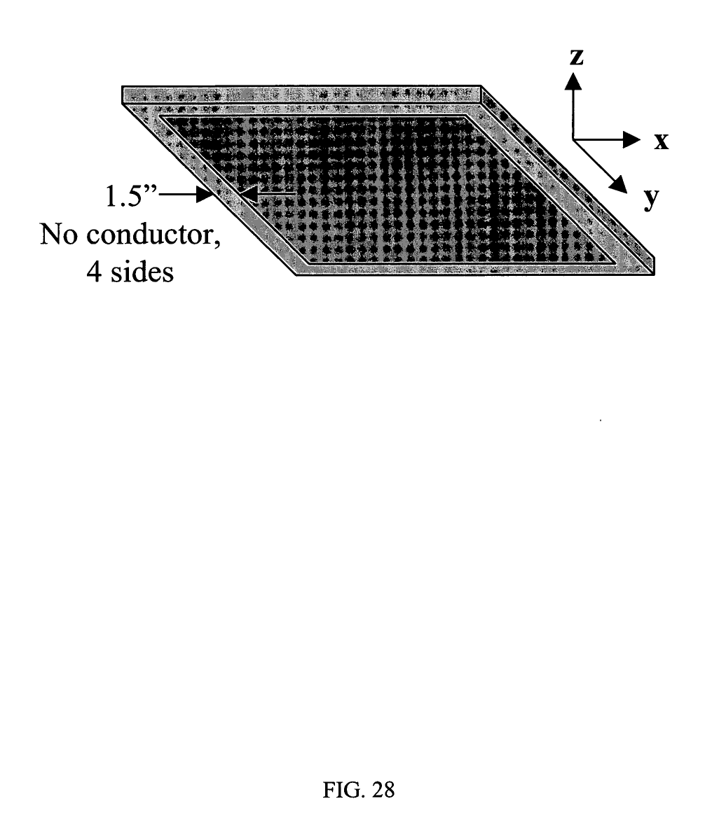

FIG. 26 shows metallized pattern 2600 of prototype TE mode waveguides according to embodiments of the present invention. The prototype TE mode waveguides were silk screened by Graphic Solutions International LLC as four quadrants, each having a size of 20″×24″. FIGS. 27 and 28 show respective side and bottom views of the prototype TE mode waveguides according to embodiments of the present invention. The conductive ink used for the prototype TE mode waveguides was part number CB028. Referring to FIG. 26, a first prototype TE mode waveguide design was fabricated having small patches measuring 0.42″, and a second prototype TE mode waveguide design was fabricated having small patches measuring 0.45″.

The prototype TE mode waveguides were designed using the following steps:
1. Choose an FSS period that is between 5% and 10% of a free space wavelength, λ₀, at the midband operating frequency of the intended RFID band.
2. Choose a total thickness that is compatible with available manufactured materials, and nominally 2% of λ₀.
3. Choose a slot width for the layer of larger patches that is nominally 10% of the period.
4. Using the transverse resonance method, adjust the small patch size so as to place the TE mode cutoff frequency at approximately 85% of the lowest operating frequency. This is one of the few critical variables in the design, and needs to be adjusted to achieve optimum performance of the prototype TE mode waveguide.
5. Design a transition region using linearly tapered slots for the larger patch layer where the longitudinal dimension of the taper is nominally 150% of the period.

5.1.2 Fabrication of a Prototype TE Mode Waveguide

Five of the second prototype TE mode waveguides were assembled, each using the 0.45″ small patches. Time did not permit assembly of the first prototype TE mode waveguides, having 0.42″ small patches. The second prototype TE mode waveguides having the larger patches were assembled because they have a lower TE mode cutoff frequency, as compared to the first prototype TE mode waveguides.

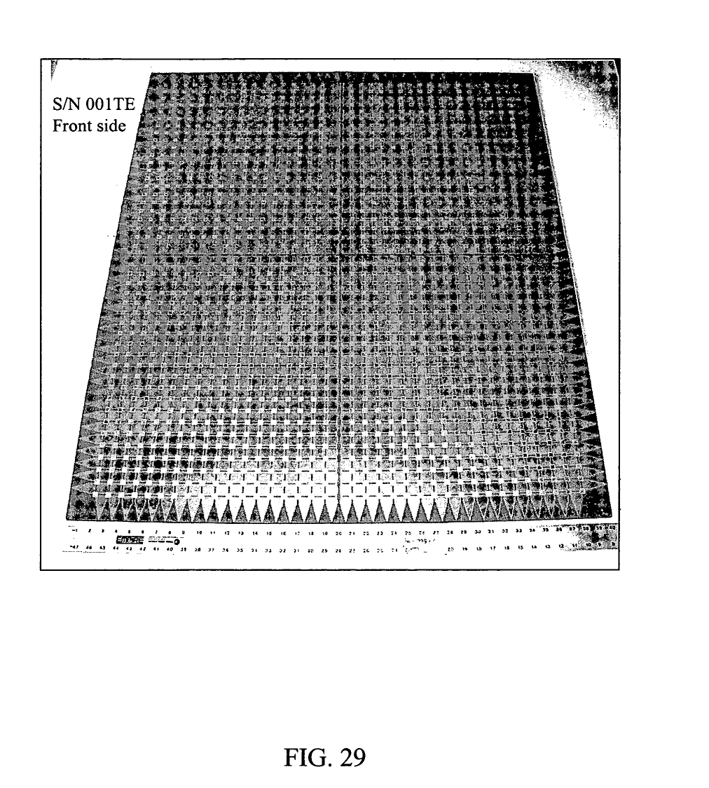

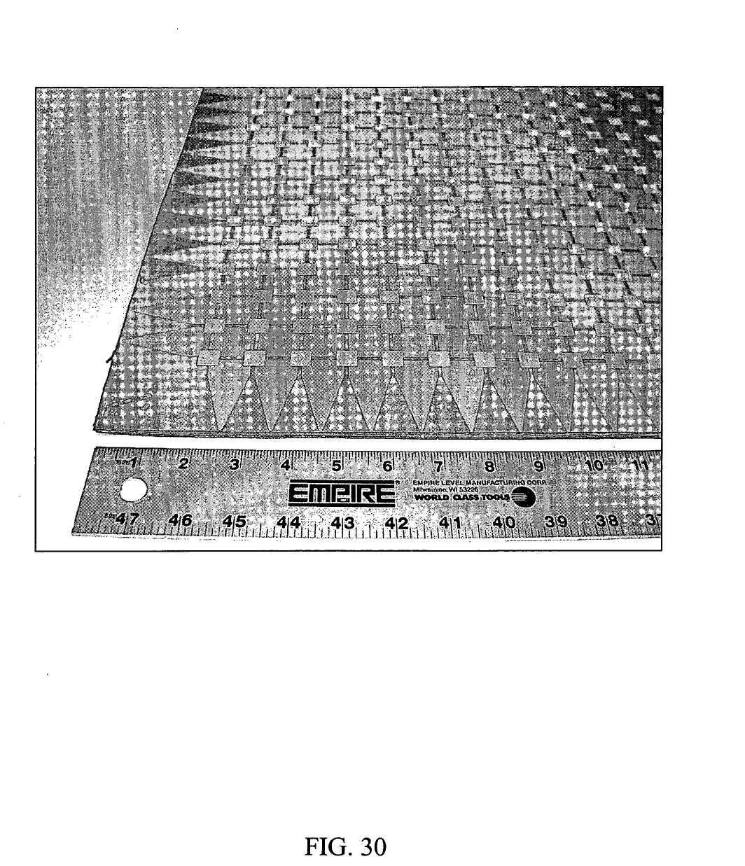

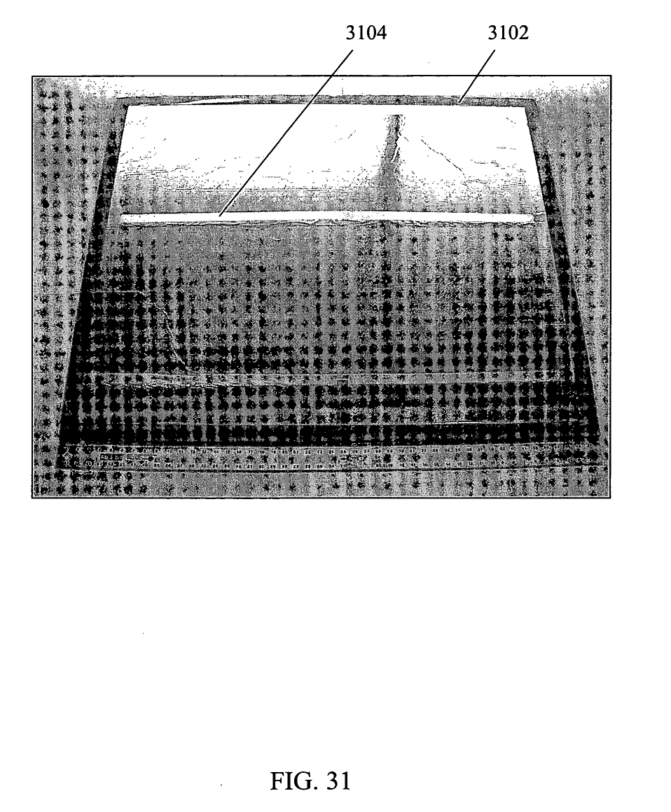

The second prototype TE mode waveguides were assembled using aluminum foil for a ground plane, a 0.25″ thick cardboard core, and a double-sided, conductive ink, silk-screened, 5 mil thick PET film. FIGS. 29 and 30 show the bottom side of a second prototype TE mode waveguide 2900 according to an embodiment of the present invention. The bottom side of second prototype TE mode waveguide is configured to face tags 100. FIG. 31 shows a ground plane, or topside, of second prototype TE mode waveguide 2900.

Second TE mode waveguide 2900 is assembled in quadrants from 20″×24″ silk-screened parts. The capacitive FSS and aluminum foil ground plane 3102 are attached to 0.25″ thick cardboard using Krylon repositionable adhesive. However, 3M Spray 77 was used for the remaining four second prototype TE mode waveguides, and it worked better. The ground plane is cut back a distance of 1.5″ away from the ends of the tapered fingers. Copper tape 3104 joins the small FSS patches at the butt joints in the silk-screened films. A 3″ wide clear packing tape was added on top of the seams to help protect the copper tape. Clear packing tape was also added to the edges of the FSS and ground plane 3102 for added durability.

5.1.2 Test Results of a Prototype TE Mode Waveguide

The prototype TE mode waveguides were tested in an indoor laboratory environment that has a raised floor of steel panels, approximately 9 feet below an acoustic paneled ceiling. The acoustic paneled ceiling is approximately 3 or 4 feet below a corrugated steel structural ceiling. The indoor laboratory environment is not an anechoic environment.

The first test was a TE mode coupling test across a prototype TE mode waveguide. A pair of 0.7 GHz to 18 GHz broadband horns on tripods were configured to be horizontally polarized and coplanar with the horizontal prototype TE mode waveguide. A multilayer broadband absorber, AN-79, was placed against the ground plane side of the prototype TE mode waveguide, and also near the FSS side, but separated by about 1.5″ with an empty cardboard box to make a transmission tunnel. An S₂₁ measurement was made using an HP4396B network analyzer. However, the dynamic range available was only about 20 dB due to the high multipath environment. No obvious transmission was made through the waveguide, and at least 40 dB of dynamic range was needed to make a clean measurement. A measure of the TE mode cutoff was not possible. An anechoic test chamber would be a better environment for this type of test. The HP4396B analyzer (the only analyzer available) lacked time domain gating, and floor or ceiling reflections could not be gated out.

Since the measurement of TE mode transmission across the prototype TE mode waveguide was not immediately possible, a bistatic reflection coefficient measurement of the surface of the prototype TE mode waveguide was made. The bistatic reflection coefficient measurement was performed to estimate the losses in the FSS based on the reflection coefficient amplitude and phase response. It is known that the prototype TE mode waveguide behaves as a high-impedance surface at some frequency below the TE mode cutoff.

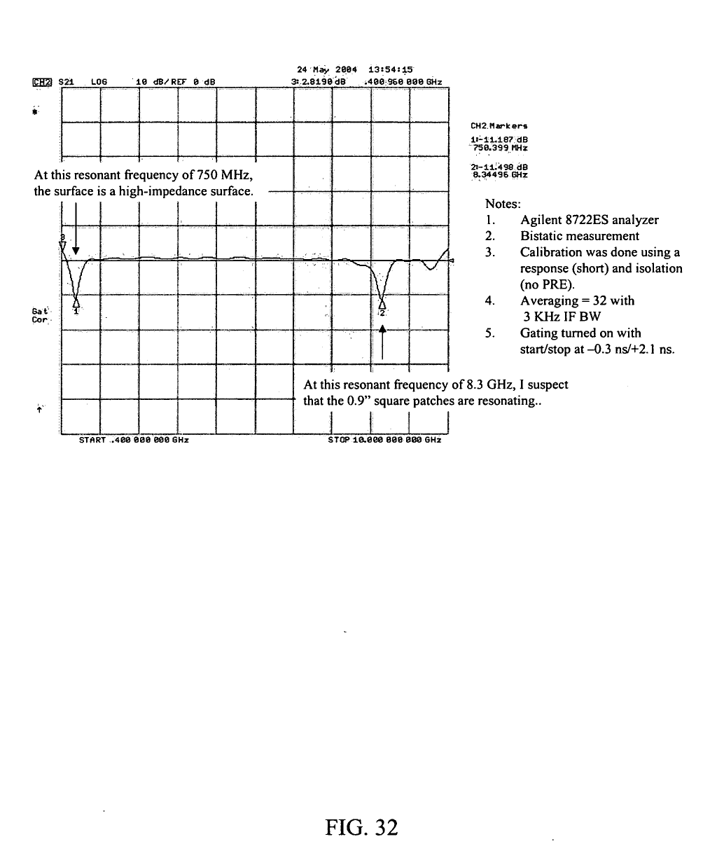

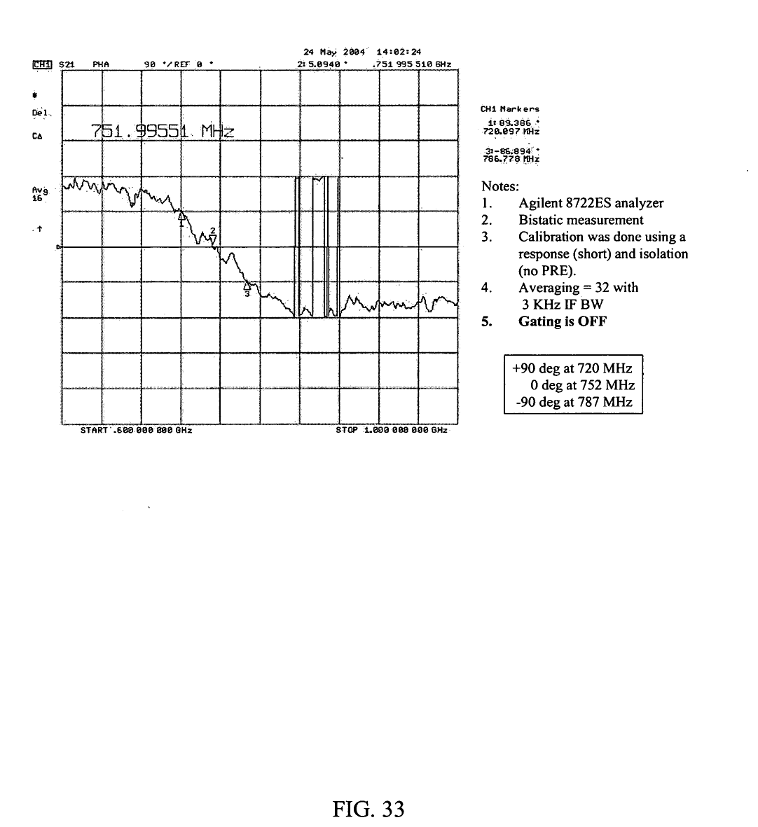

FIGS. 32 and 33 are graphical representations of the reflection coefficient amplitude and phase, respectively, for the prototype TE mode waveguide, according to an embodiment of the present invention. Referring to FIGS. 32 and 33, the surface of the prototype TE mode waveguide resonates (zero degree reflection phase) near 752 MHz. The S₁₁ null of the prototype TE mode waveguide is relatively low at −11.2 dB, indicating substantial loss in the prototype TE mode waveguide.

Based on prior experience with reactive surfaces, the TE mode cutoff for this type of structure should be found between the 0° and −90° reflection phase points, depending on the normal component of permeability for the capacitive FSS. This information brackets the cutoff between 752 MHz and 787 MHz, which is approximately 100 MHz lower than the cutoff frequency of 875 MHz that is predicted by the transverse resonance analysis. However the transverse resonance analysis begins to lose accuracy when the FSS period exceeds the spacer layer thickness, and that ratio is 4:1 in the prototype TE mode waveguide design.

The Microstripes™ transmission simulation illustrated in FIG. 25 shows the TE mode cutoff frequency for the FSS design using 0.42″ patches to be near 830 MHz. The measured prototype TE mode waveguide uses 0.45″ patches, which forces the TE mode cutoff frequency to be slightly lower than 830 MHz. Accordingly, the reflection coefficient measurements associated with the prototype TE mode waveguide are not inconsistent with the full-wave Microstripes™ simulation of FIG. 25.

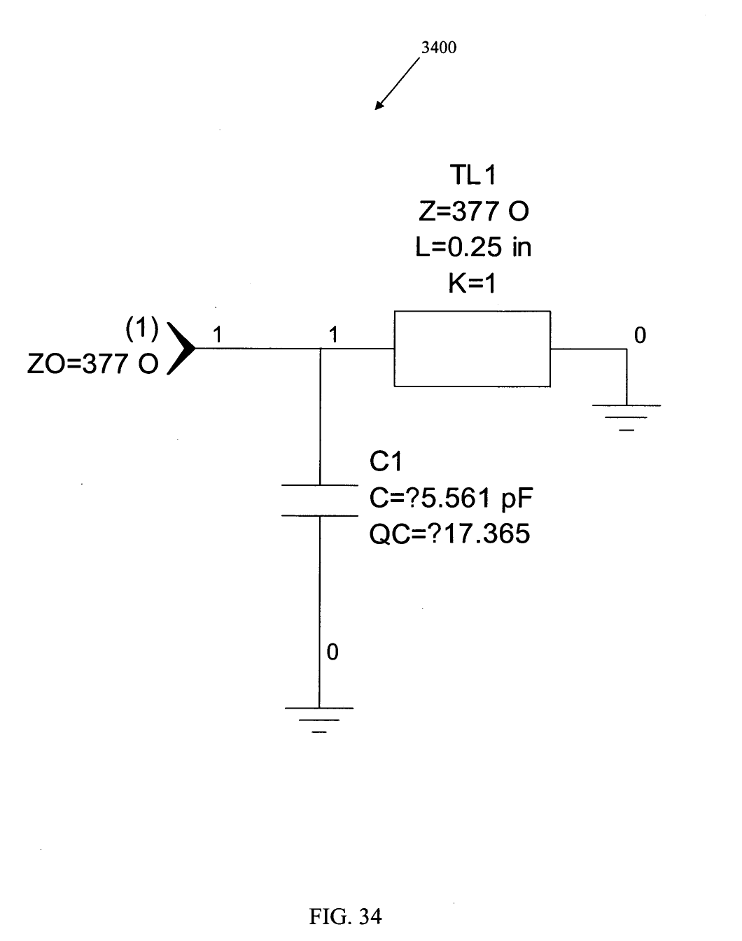

Next, a circuit simulator was used to fit the measured data to the response of a simple reactive but lossy equivalent circuit model 3400, which is shown in FIG. 34. The shorted transmission line was defined in accordance with the ¼″ thick corrugated cardboard core of the prototype TE mode waveguide. The capacitance value of C1 in pF per square was adjusted to yield a resonance at 752 MHz, while the capacitor Q was adjusted to the value of the measured S₁₁ null. The capacitor's Q is 17.4.

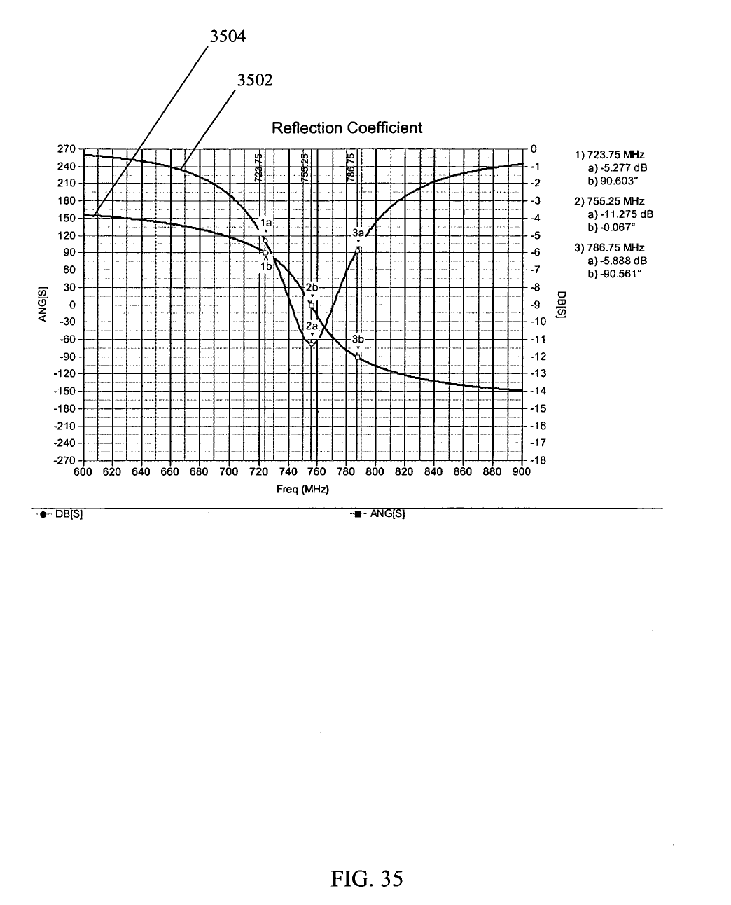

FIG. 35 is a graphical representation 3500 of the simulated reflection coefficient for equivalent circuit model 3400 shown in FIG. 34 according to an embodiment of the present invention. In FIG. 35, curve 3502 represents the magnitude of the reflection coefficient, and curve 3504 represents the phase of the reflection coefficient. The +/−90° reflection phase frequencies are listed in the right-hand margin of graphical representation 3500, and agree with the measured values shown in FIG. 33 to within a few MHz.

Referring back to FIG. 23, the Q of capacitor C1 represents the FSS and may be defined as Q=X_{c}/R=1/(ωRC), where R and C are the effective sheet resistance in Ω/square and the effective sheet capacitance in F/sq, respectively, of the FSS. The resistance is due to both metal and dielectric losses: R=Rₘₑₜₐₗ+R_{diel}. The Q of capacitor C1 may be expressed as:

$$\frac{1}{Q} = ω {R}_{metal} C + ω {R}_{diel} C = ω {R}_{metal} C + \frac{1}{{Q}_{diel}}$$

Rearranging this relationship yields:

$${R}_{metal} = \frac{\frac{1}{Q} - \frac{1}{{Q}_{diel}}}{ω C}$$

The Q of the PET film is the inverse of the dielectric loss tangent, and the loss tangent of PET is given as 0.0025. In this example, Rₘₑₜₐₗ=2.09 Ω, where Rₘₑₜₐₗ is the effective resistance due to the metal at 750 MHz for the circuit analog model of the FSS. The variable Rₘₑₜₐₗ is not the same as the DC resistivity, but they are related through the geometry of the FSS unit cell. Some current crowding occurs at the corners of the large patches that will exacerbate resistive losses.

The reflection coefficient measurements shown in FIGS. 32 and 33 reveal that the silk-screened FSS is relatively lossy. However, the metal losses likely may be reduced at least an order of magnitude if a different manufacturing technique is used for the capacitive FSS. Alternatives include but are not limited to etching, stamping, embossing a metal film, etc.

5.2 Parallel Plate Waveguide Embodiment

5.2.1 Transition Design for a Prototype PPW

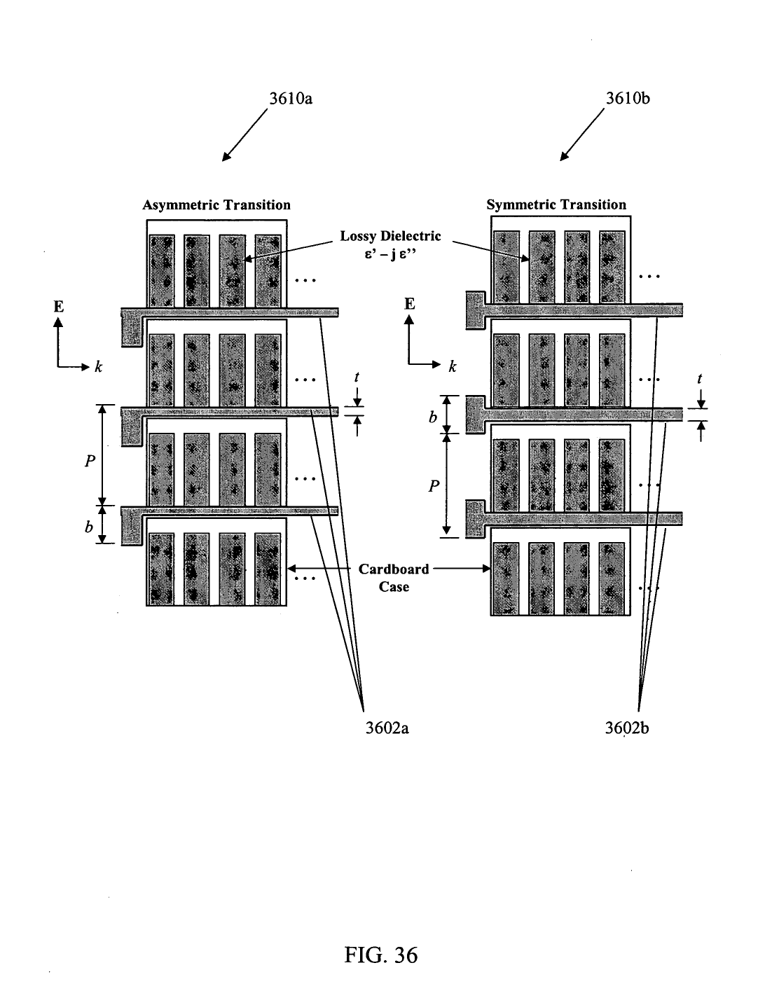

FIG. 36 shows pallet stacks 3610a-b that include respective parallel plate waveguides (PPWs) 3602a-b according to embodiments of the present invention. The RF lossy dielectric product (Pantene shampoo) is shown resting on the top of each PPW 3610a-b, and the cardboard cases are shown to enclose the RF lossy dielectric product. The impedance matching transitions are shown as step changes in the height of PPWs 3602a-b. PPWs 3602a in pallet stack 3610a have respective asymmetric stepped-height transitions, while PPWs 3602b in pallet stack 3610b have respective symmetric stepped-height transitions. PPWs 3602a and 3602b have substantially the same performance for a given aperture height b and length d.

In FIG. 36, the nominal height of a PPW 3602 is represented as t. Given the periodic nature of pallet stack 3610 in the vertical direction, one unit cell of height P may be simulated to determine the transmission parameter S₂₁ from an incident plane wave to the TEM mode guided inside a PPW 3602. Wrap-around boundary conditions may be used in a Microstripes™ time-domain simulation for the top and bottom surfaces of the Microstripes™ workspace. The relative position of the transitions with respect to the cardboard cases should be noted. Any portion of the transition that is thicker than t should be located outside of respective stack 3610a or 3610b, as shown in FIG. 36.

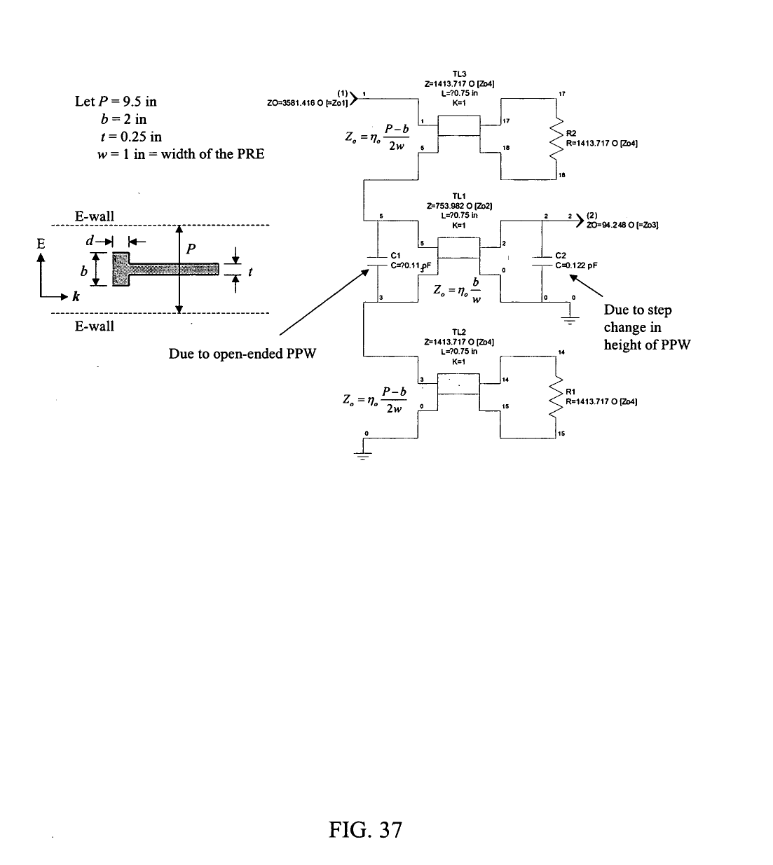

FIG. 37 shows an equivalent circuit 3700 that approximates the stepped height transitions shown in FIG. 36 according to an embodiment of the present invention. Equivalent circuit 3700 will be described with respect to PPWs 3602b and the associated symmetric transitions shown in FIG. 36, though the scope of the present invention is not intended to be limited in this respect. The following discussion applies to PPWs 3602a and the associated asymmetric transitions shown in FIG. 36, as well.

Referring to FIG. 37, if the lossy dielectric is removed from the environment, then the wrap-around boundary conditions may be simplified to electric walls in the planes of symmetry that are located midway between PPWs 3602b in a pallet stack 3610b. As shown in FIG. 37, equivalent circuit 3700 includes three transmission lines in series that load port 1, which is the incident plane wave port in free space. The center transmission line models the length d of a PPW 3602b that has height b. Port 2 corresponds to the PPW TEM mode inside PPW 3602b.

Transmission lines on top and bottom model the space between the electric walls and PPW 3602b. It may be assumed that the exterior transmission lines are terminated in matched loads. This assumption may be fairly accurate, assuming the transition is being modeled alone. Characteristic impedances are scaled from the wave impedance of free space η₀ by multiplying by the height of each waveguide section (PPW or air space) and dividing by the width w that is arbitrarily defined in this 2D model. In this example, a width of 1 inch is used.

Two capacitances are modeled: (1) the aperture capacitance (C_{end}) at the end of PPW 3602b and the step capacitance (Cₛₜₑₚ) at the distance d into PPW 3602b. Both capacitances may be estimated using formulas from N. Marcuvitz, Waveguide Handbook, Peter Peregrinus Ltd, 1986, sections 4.6 and 5.26, which are incorporated herein by reference. For example, referring to FIG. 37, the aperture capacitance may be represented as

$${C}_{end} = \frac{1}{2 π {fZ}_{0}} \frac{b}{λ} ln ( \frac{2 e λ}{γ b} ) ,$$

and the step capacitance may be represented as

$${C}_{step} ≅ \frac{1}{2 π {fZ}_{0}} \frac{2 b}{λ} [ ln ( \frac{e}{4 α} ) + \frac{{α}^{2}}{3} + \frac{1}{2} {( \frac{b}{λ} )}^{2} {( 1 - {α}^{2} )}^{4} ] , \\ where {Z}_{0} = {η}_{0} \frac{b}{w} ,$$

$$α = \frac{t}{b} < 1 , e = 2.718 ,$$

and γ=1.781. The stepped height capacitance formula is also used for the asymmetric transition discontinuity.

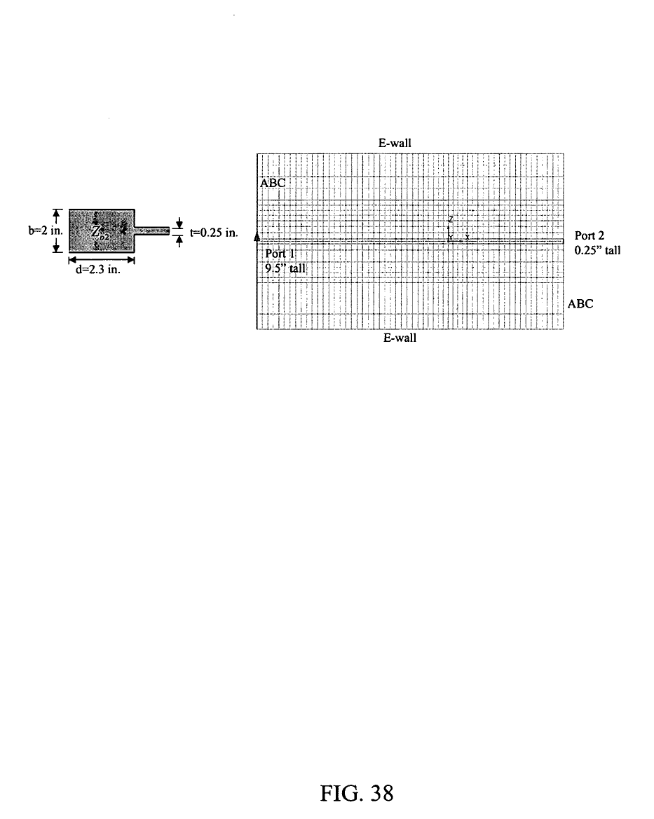

To validate equivalent circuit 3700 shown in FIG. 37, a full-wave Microstripes™ simulation was performed to calculate the two-port transmission from the incident plane wave in free-space to the TEM mode guided inside PPW 3602b. FIG. 38 illustrates the Microstripes™ gridded 2D workspace according to an embodiment of the present invention. Referring to FIG. 38, TEM mode ports 1 and 2 are found at reference planes x=−10 inches and x=+6 inches, respectively. The conductors are modeled as copper, and the dielectric regions are modeled as air.

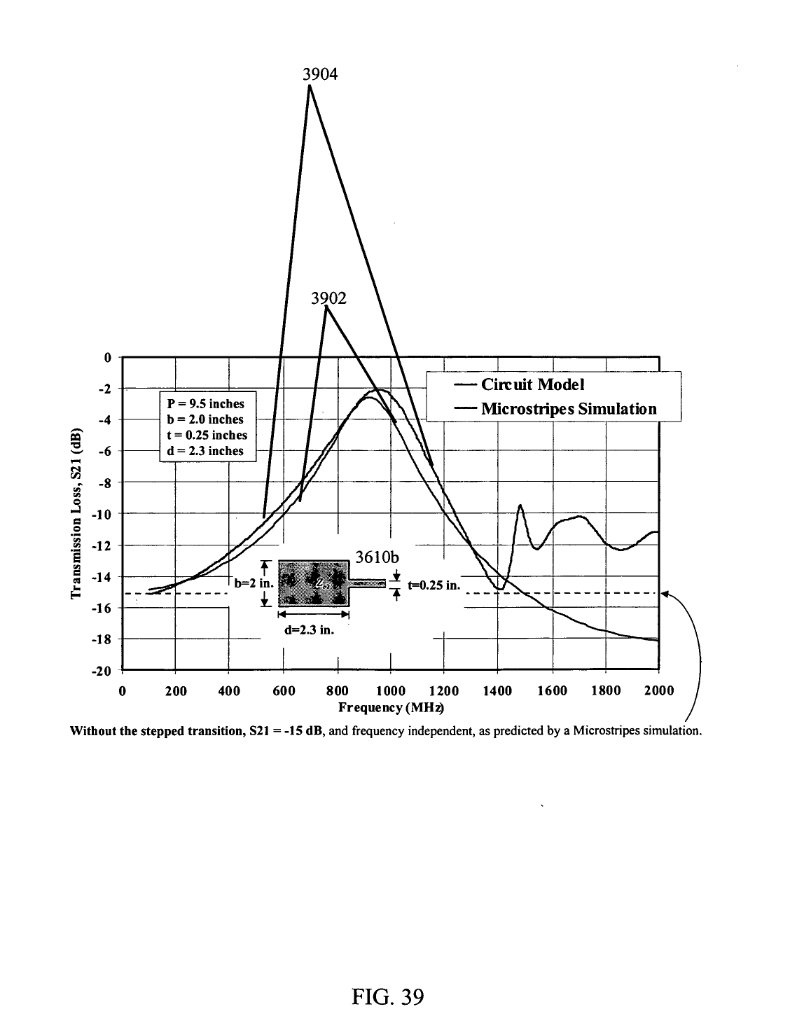

FIG. 39 shows a comparison between the transmission performance S₂₁ of equivalent circuit 3700 in FIG. 37 and the full-wave Microstripes™ model described with reference to FIG. 38. Curve 3902 represents the transmission performance of equivalent circuit 3700, and curve 3904 represents the transmission performance of the full-wave Microstripes™ model.

In FIG. 39, curves 3902 and 3904 are closely related in the RFID band and at frequencies up to about 1400 MHz where the higher order TM₁ mode begins to propagate in the air regions above and below PPW 3602b. The merit of a validated equivalent circuit model is that it allows many different transition designs to be rapidly analyzed and even optimized using commercial circuit simulators.

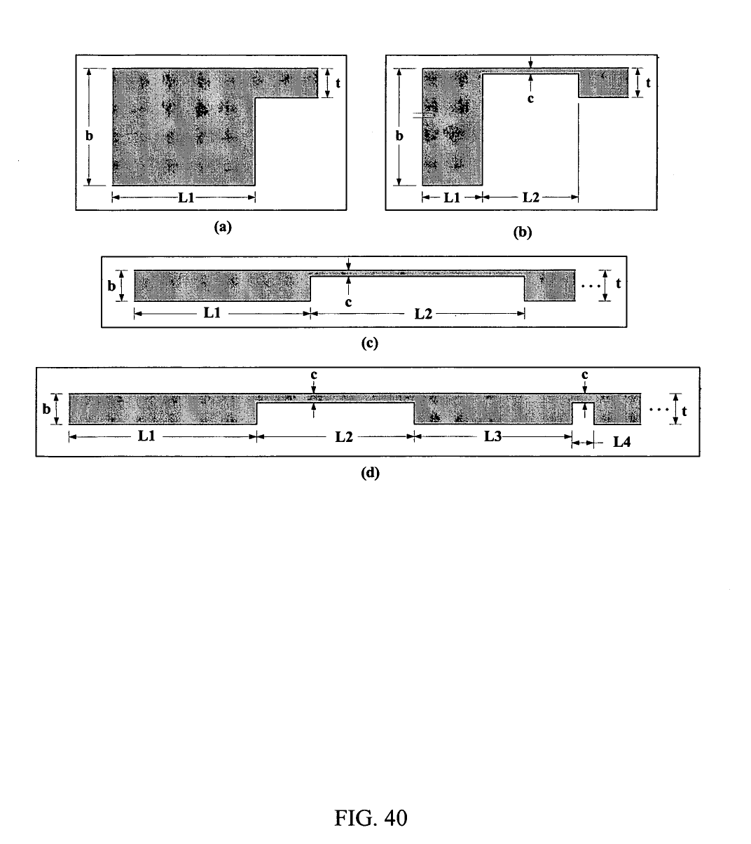

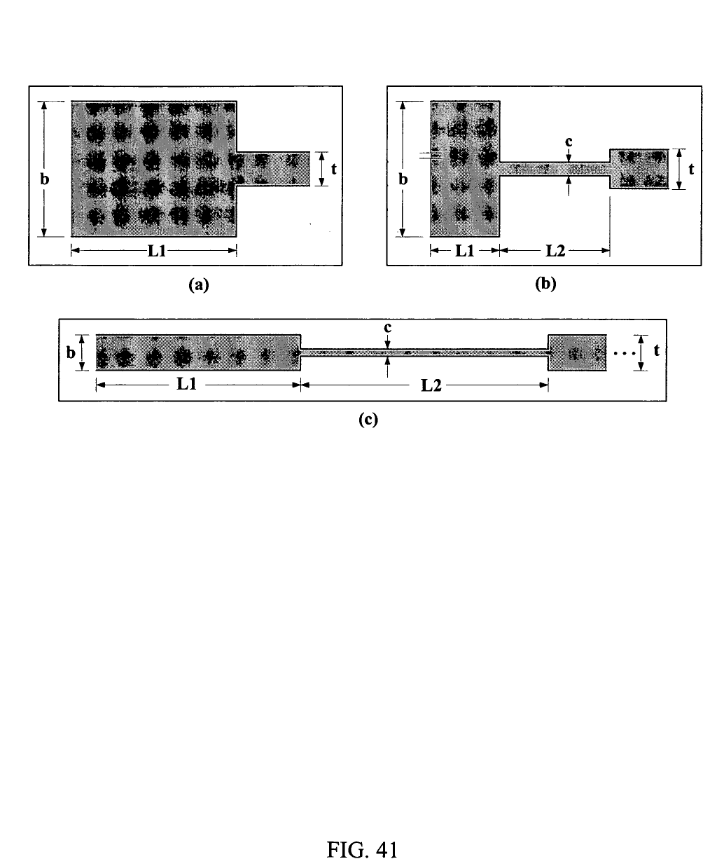

The impedance matching transition at the perimeter of PRE 3602b may be realized with at least seven different embodiments as shown in FIGS. 40 and 41. These embodiments are provided for illustrative purposes and are not intended to limit the scope of the present invention. It will be recognized by persons of ordinary skill in the relevant art(s) that the impedance matching transition at the perimeter may be realized using other embodiments than those shown in FIGS. 40 and 41. Each embodiment shown in FIGS. 40 and 41 is a two-dimensional PPW transition in which the left side is an open-ended aperture of height b and the right side is the PPW of nominal height t. It may be assumed for purposes of simulation that the respective PPW is filled with a low permittivity dielectric such as foam or corrugated cardboard. In the following examples, the height t of the PPW is set to 0.5″. The aperture height b is either 2″ or 0.5″.

FIG. 40 illustrates asymmetric PPW transition embodiments (a)-(c); whereas, FIG. 41 illustrates symmetric PPW transitions according to embodiments of the present invention. Referring to FIG. 40, asymmetric embodiment (a) is a single section transition. The single section transition of asymmetric embodiment (a) includes a transmission line section having a length L1 of approximately 2.4″ to achieve a transmission peak at 915 MHz. Given that the footprint of the Pantene pallet stack in this example is about 39″×45″ and the PRE size goal is only 40″×48″, we see that there is insufficient room to accommodate this length of 2.4″ on any of two opposing sides.

The length L1 of the transmission line section may be reduced using capacitive loading of the aperture as shown in asymmetric embodiment (b). Such loading may take the form of interdigital capacitors, such that the interdigital fingers are partially covering the aperture and are attached to the upper and lower plates. However, it may be necessary to add capacitance at both ends of the transmission line section. This may be accomplished on the inside of the PPW by reducing the height from the nominal t=0.5″ to a smaller value of c=0.1″ to 0.125″. The transition of asymmetric embodiment (b) may have some mechanical integrity issues depending on construction techniques. The shorter length transition of asymmetric embodiment (b) has a higher Q, as compared to asymmetric embodiment (a), meaning a narrower transmission bandwidth for S₂₁ and more RF loss in the transition.

Asymmetric embodiment (c) is a low-profile two-section transition having a transition length that is not compromised and a transition height that does not exceed the nominal height t of the PPW. This is still a stepped height transition, and the bandwidth and efficiency performance similar to the larger configuration of asymmetric embodiment (a) may be achieved. Asymmetric embodiment (c) was fabricated into the prototype PPWs having the following dimensions: b=t=0.5″, c=0.1, L1=2.8″, L2=3″.

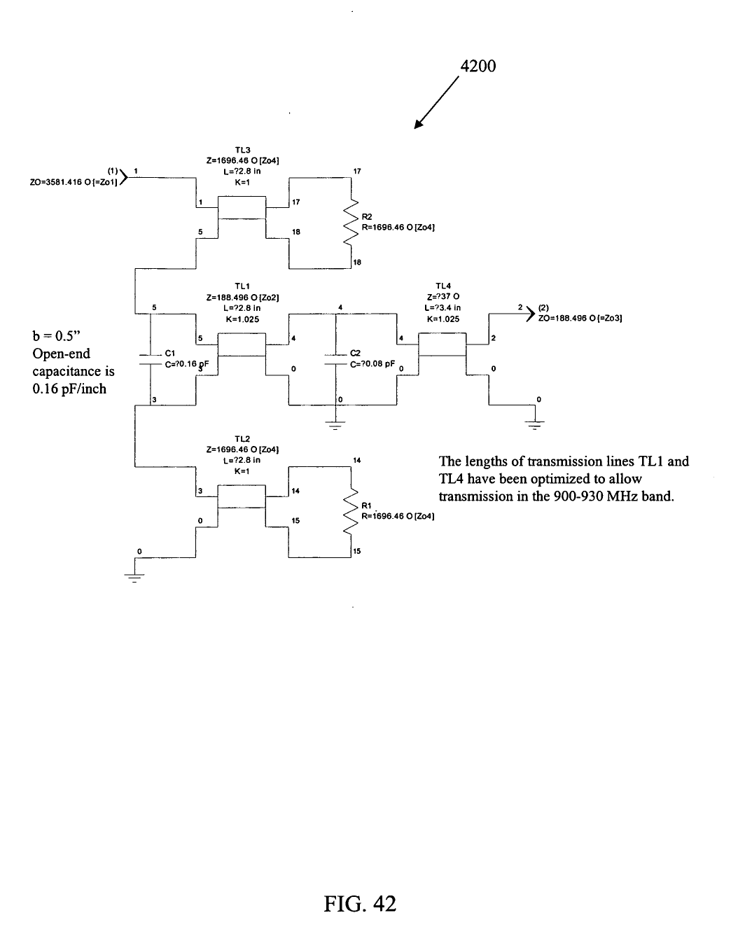

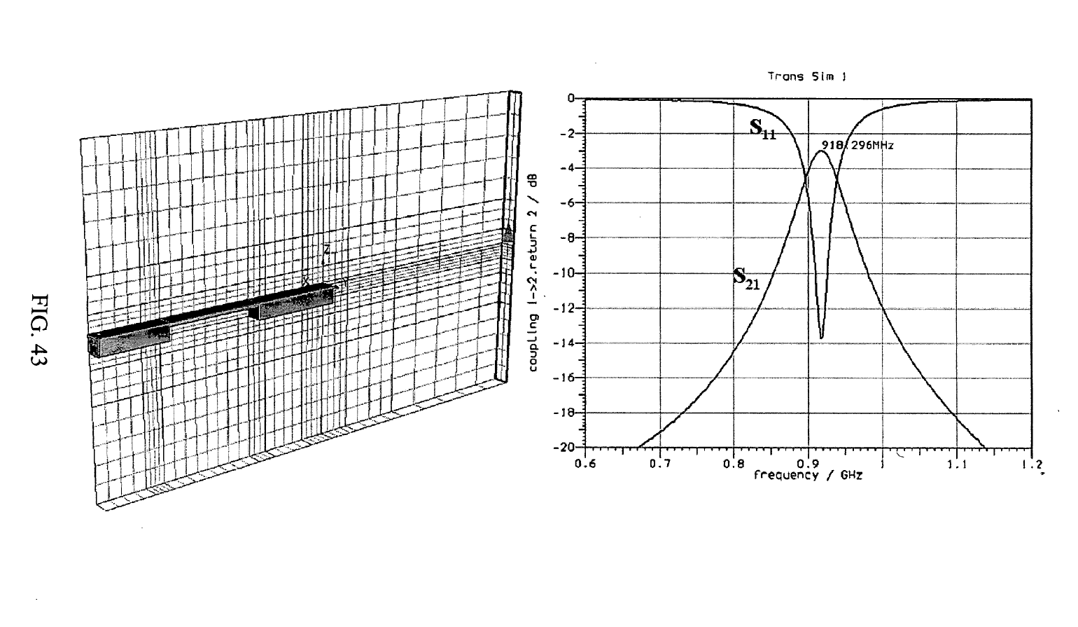

FIG. 42 shows an equivalent circuit 4200 of asymmetric embodiment (c) described above with reference to FIG. 40, according to an embodiment of the present invention. Equivalent circuit 4200 is based on a 1-inch wide section of PPW. The input port, port 1, models a plane wave incident on the PPW. The port 1 characteristic impedance is calculated using a height of 9.5″ and a width of 1″. Port 2 is for the TEM mode inside the ½″ tall PPW, and its reference plane is at the end of the 3″ long low-impedance transmission line labeled TL4. Transmission lines TL2 and TL3 model the empty space above and below the PPW required to create a vertical period of 9.5″. For convenience, this vertical distance is equally divided between the two transmission lines.

Referring to FIG. 42, C1 models the open-end capacitance at the ½″ tall aperture. C2 models the step change in height going from ½″ to 1/10″. A second capacitor equal to C2 should have been included in the circuit model at the right side of TL4. However, the second capacitor equal to C2 was forgotten, and that is why TL4 is 0.4″ longer in FIG. 42 than in the fabricated prototypes or Microstripes™ simulation.

FIG. 43 shows a Microstripes™ simulation of the final transition design according to an embodiment of the present invention. The Microstripes™ simulation includes a gridded geometry having b=t=0.5″, c=0.1″, L1=2.8″, and L2=3″. Port 1 is the 0.5″ tall PPW and port 2 is the 9.75″ tall free-space TEM mode port defined by the vertical period of the stack.

Referring to FIG. 43, the Microstripes™ simulation reveals that S₂₁, the transmitted power from the PPW to the exterior plane wave, peaks near 918 MHz at a value of about −3 dB, and exceeds −4 dB or 40% over the RFID band of 902-928 MHz. Equivalent circuit 4200 in FIG. 42 yields the same S₁₁ and S₂₁ response to within 0.5 dB. Because the transition is a reciprocal network, approximately half of the incident power is captured and guided into the PPW. It should be noted that the height of the PPW is approximately 5% of the vertical period. Without the tuned transition, the ½″ tall PPW is shown to capture approximately 5% of the input power, which means S₂₁ is a frequency independent value of −13 dB.

The dielectric core of the prototype PPW was foamboard. It was determined that foamboard having a thickness of 0.1″ was not available. Thus, foamboard having a thickness of 0.125″ or greater was used to fabricate a multi-section transition whose smallest height is c=0.125″. Such a transition can be fabricated in prototype form using standard ⅛″ and ⅜″ thick foamboard. The four-section transition of asymmetric embodiment (d) in FIG. 40 was optimized using the GENESYS circuit simulator. The equivalent circuit model is similar to equivalent circuit 4200 in FIG. 42, except that two additional transmission line sections were included between TL4 and port 2.

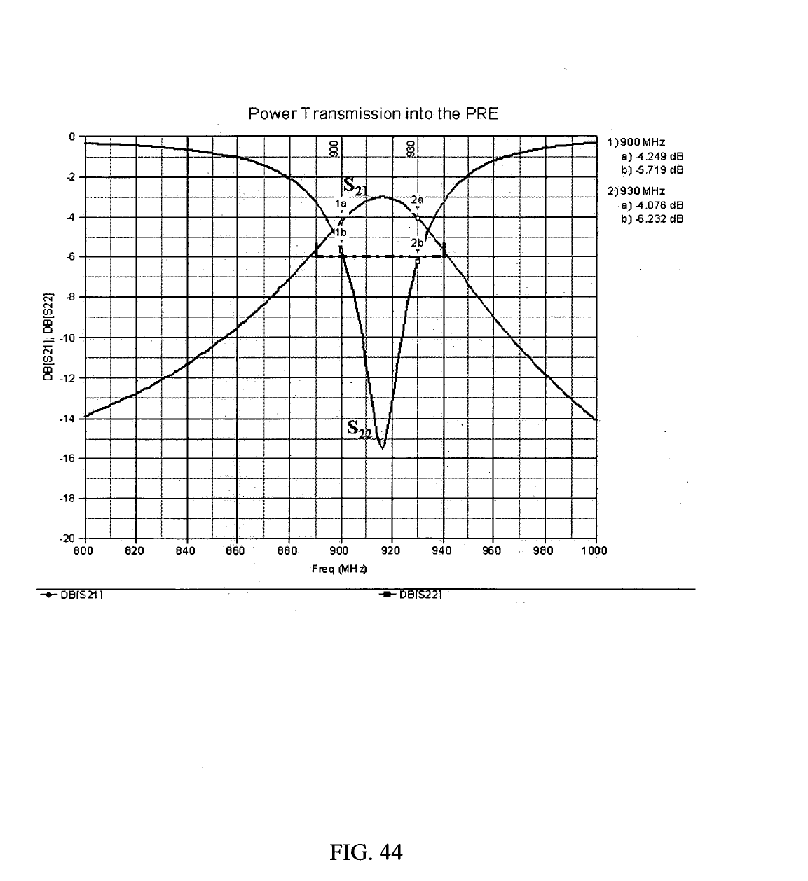

FIG. 44 is a graphical representation of the S-parameters associated with the equivalent model of the four-section transition of asymmetric embodiment (d) shown in FIG. 40. The transmission performance is better for shorter transitions where c=0.1″ (see FIG. 13 for a comparison), and the return loss seen from inside the PPW is better with a null that is 2 dB deeper. The overall length of the four-section transition of asymmetric embodiment (d) is 9.25″. This overall length may not be ideal for some applications, such as the 16 element coupling slot array described in section 5.2.2 below. Asymmetric embodiment (d) was not constructed, though it may be electrically superior to some other embodiments.

It will be recognized by persons of ordinary skill in the art that any of the 2D transitions shown in FIGS. 40 and 41 can be accurately modeled using a circuit simulator if one takes proper care in calculating the discontinuity capacitances using the formulas described above with reference to Marcuvitz's Waveguide Handbook. One of the merits of having an equivalent circuit model is that it affords a means to analyze combined features of the PPW by modeling these features as additional networks. This capability will be shown to be advantageous in the following sections.

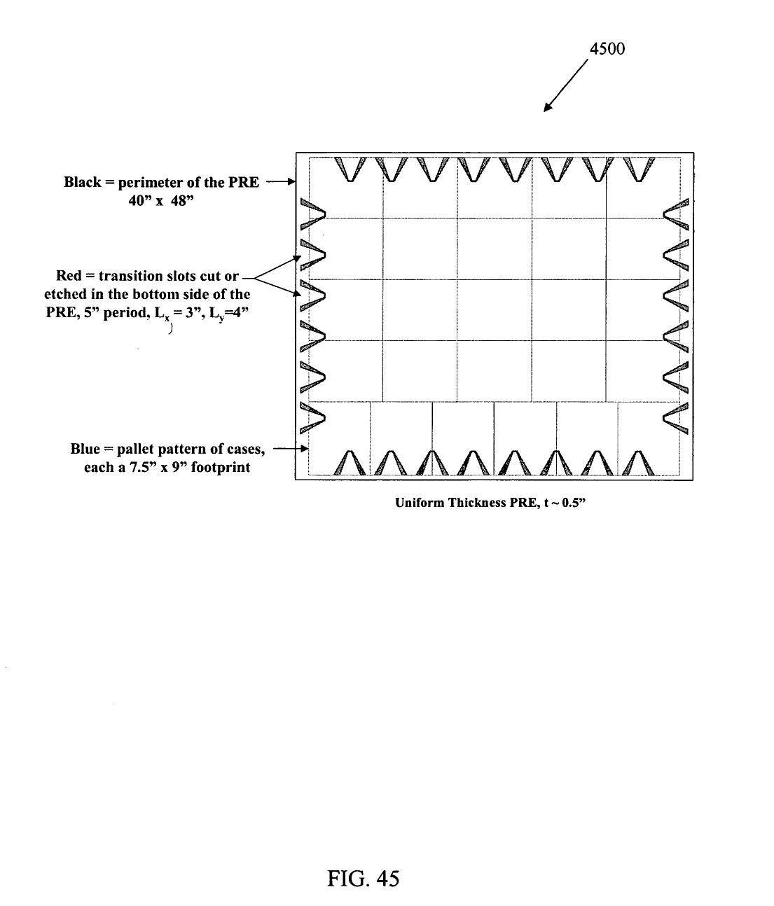

FIG. 45 shows a PPW 4500 that includes a linear array of V-shaped coupling slots etched or cut in the lower plate of PPW 4500 according to an embodiment of the present invention. For example, PPW 4500 may avoid the manufacturing challenge of a transition with stepped heights. In FIG. 45, the V-shaped coupling slots are located near the edge of PPW 4500. Each side of PPW 4500 is shown to have a transition region to capture incident power, though the scope of the present invention is not limited in this respect. In the embodiment of FIG. 45, the V-shaped slots are configured to receive vertically polarized electric fields only, which are electric fields that are normal to the surface of PPW 4500.

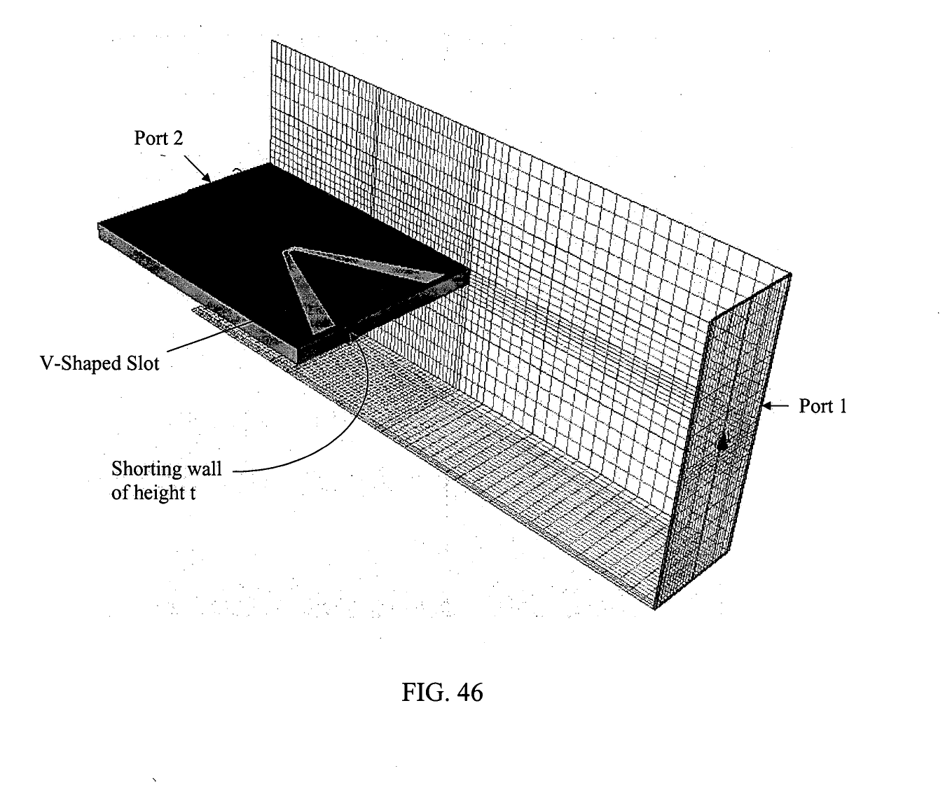

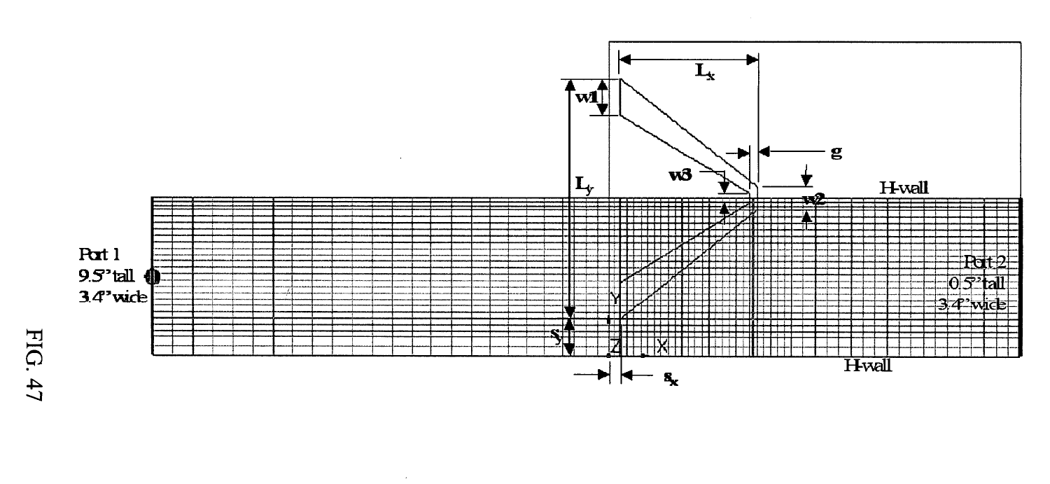

FIG. 46 shows a perspective view of one slot of the array of V-shaped slots shown in FIG. 45 according to an embodiment of the present invention. In FIG. 46 the slot is represented using a Microstripes™ model of a two-port network. Port 1 is an incident plane wave in free space. Port 2 is a PPW mode port referenced several inches behind the slot. The leading edge of the PPW is a short-circuited PPW. The Microstripes™ model is configured such that the only path to couple power into the PRE is through the slot array.

In FIG. 46, wrap-around boundary conditions are applied to the top and bottom of the workspace to simulate a periodic structure in the vertical direction. Magnetic walls are used on the sides of the workspace, which coincide with the two planes of symmetry in an infinitely wide linear array of slots.

FIG. 47 shows a plan view of the slot in FIG. 46 according to an embodiment of the present invention. FIG. 47 includes a definition of the parameters required to uniquely define the dimensions of the slot and the position of the slot near the edge of the PPW.

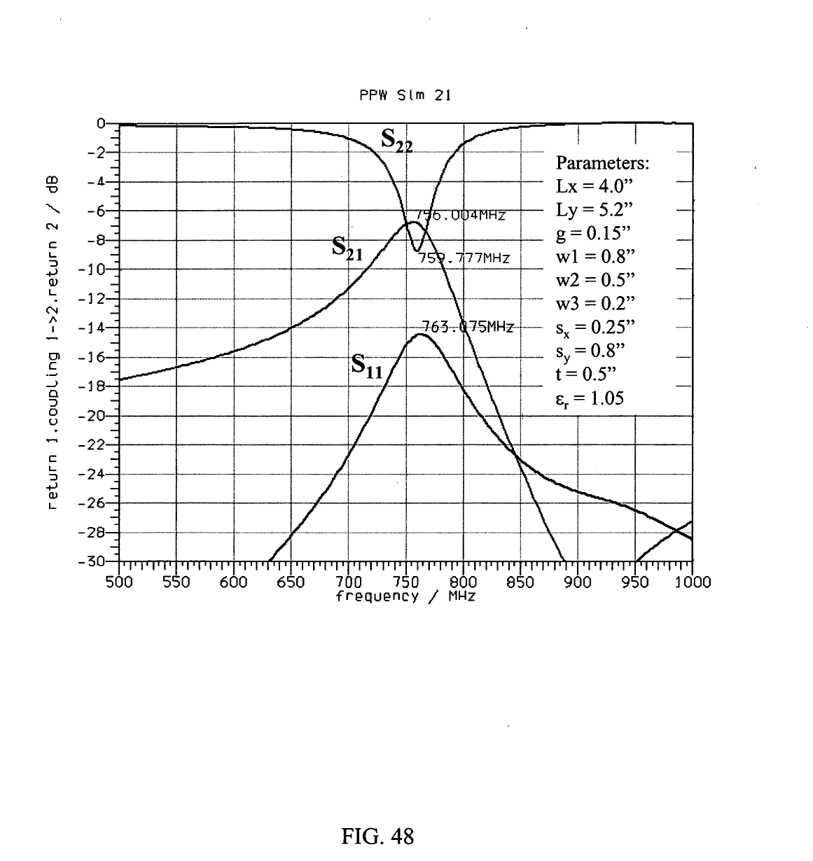

FIG. 48 is a graphical representation of the normalized scattering parameters for the slot array transition illustrated in FIGS. 46 and 47, according to an embodiment of the present invention. Although this slot array is not optimized for the RFID band, S₂₁ peaks at approximately −7 dB, which means that approximately 20% of the incident power is captured by the PPW. This design can be improved by optimizing the center frequency, bandwidth, output return loss S₂₂, and peak transmission level S₂₁. Note that there exist 10 parameters to optimize in V-shaped slot array design. Optimization should be performed using full-wave simulators as most of the modern 3D electromagnetic simulators are capable of performing parametric sweeps using dimensional variables.

The V-shaped slot array transition is relatively simple to fabricate and may have a low cost in large volume production. Slots can be made in any of a variety of ways, including but not limited to laser cutting, etching, stamping, or embossing in metal foil. Slots can also be silk screened with conductive ink.

A transition using linear arrays of V-shaped slots can be realized in embodiments other than those specifically described herein. For example, two linear slot arrays may be fabricated, one in the upper plate of the PPW and the other in the lower plate of the PPW, such that both linear arrays are located near the edge. The slot arrays may be aligned, or registered, top and bottom, or they may be offset by half of the transverse period. According to an embodiment, an improved S₂₁ bandwidth is achieved by making the upper and lower arrays slightly different from each other. In another embodiment, dissimilar transverse periods are employed. Many possible perturbations may be explored for improved power transmission levels and bandwidth. Yet another embodiment includes a combination of an array of V-shaped slots with the open end of the PPW. The open end may be shorted, for example.

One of the issues to explore is the potential degradation of coupling due to proximity of RF lossy products such as the Pantene shampoo to the location of the slots in the PPW. The simulation described above with reference to FIGS. 46-48 does not take into account losses other than copper losses in the PPW.

5.2.2 Resonant Coupling Slot Design for a Prototype PPW

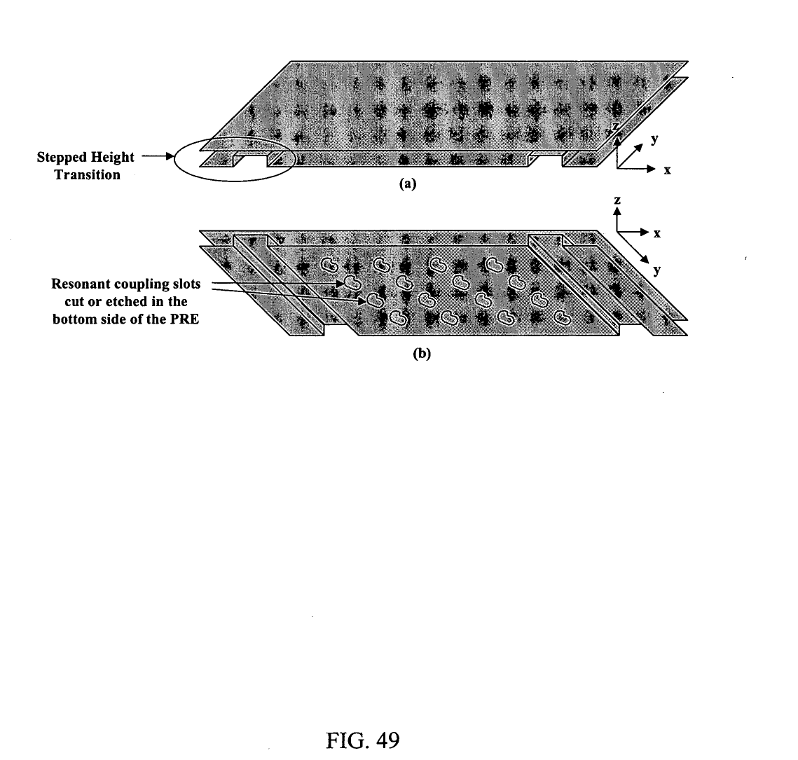

FIG. 49 shows two perspective views a PPW having coupling slots according to an embodiment of the present invention. Perspective view (a) shows the top side of the PPW, and perspective view (b) shows the bottom side of the PPW. As shown in FIG. 49, the resonant coupling slots form an array on the bottom side of the PPW. Design variables for the PPW include the choice of lattice (rectangular, triangular, hexagonal, etc.), the lattice constants (which are the periods in the x and y directions for a rectangular lattice), the size and shape of the coupling slots, and the orientation or rotation of the coupling slots with respect to the principal axes of the PPW.

Referring to FIG. 49, the PPW captures RF power at the transition edges and guides that power in the +/−x directions across the array. The slot array is designed to reduce reflected power inside the PPW due to backscattering from the slots. It is desired to radiate into the pallet stack as much power as possible from the portion of the slot array that is closest to the excited transition.

The coupling slot simulations described herein focus on rectangular arrays of coupling slots merely because currently available computational tools cannot as easily simulate coupling slots of other shapes. However, it will be recognized by persons of ordinary skill in the relevant art(s) that coupling slots of any array lattice shape (e.g., triangular, hexagonal, etc.) may be simulated in accordance with embodiments of the present invention. The slot simulations were performed using periodic boundary conditions in the y direction suitable for modeling a slot in an infinitely wide array environment. Time and other resources did not permit the more detailed modeling of a finite width array. Equivalent circuit models were derived for individual slots based on full-wave simulations, and the equivalent circuits were cascaded to simulate the performance of the finite length array.

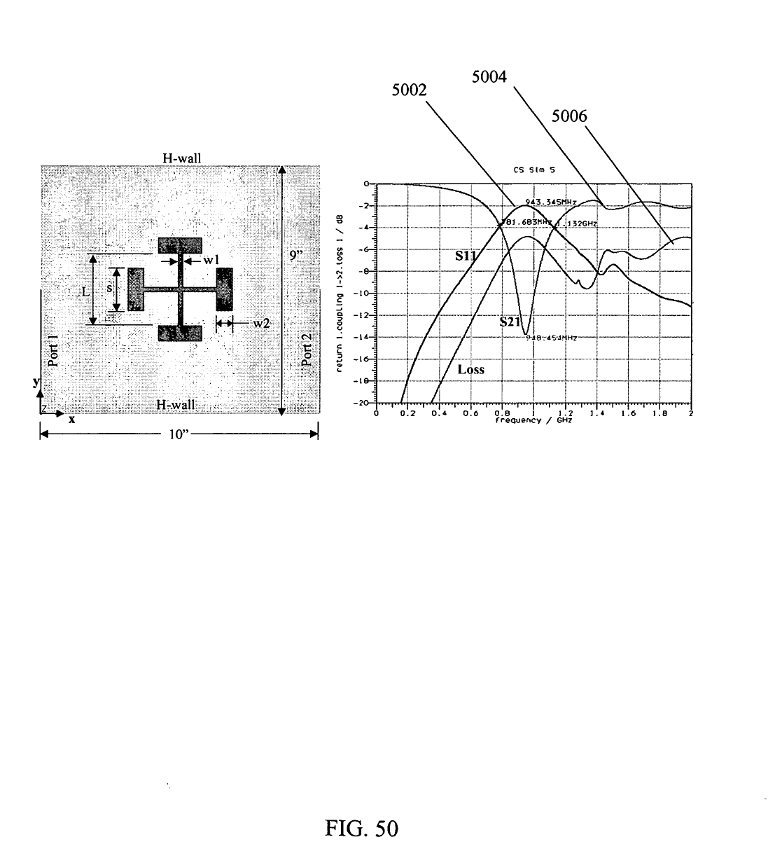

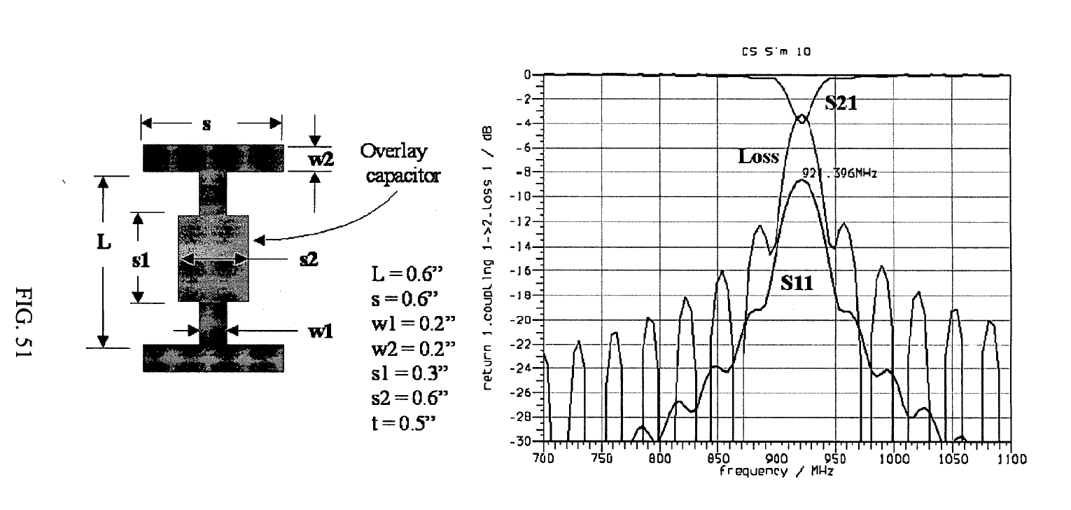

There are many different styles of resonant coupling slots that can be used to launch radiation into the pallet stack interior. Some example types of resonant coupling slots include but are not limited to bowties, crossed bowties, L-shaped slots, I-shaped slots, H-shaped slots, Jerusalem crossed slots, and serpentine or s-shaped slots. The basic idea is to interrupt electric current flowing on the lower plate of the PPW, which will force the slot to be excited. If the slot dimensions are properly chosen, the slot will resonate and radiate in the RFID band. However, controlling the coupling level is the challenging part of the design. As an example, consider the Jerusalem crossed slot shown in FIG. 50.

FIG. 50 shows simulated geometry and s-parameter results for a crossed slot in which the slotline open ends allow the overall slot size to be reduced, according to an embodiment of the present invention. In FIG. 50, the PPW is 0.5″ thick, and TEM mode ports are defined on the left and right sides (x-min and x-max) of the Microstripes™ workspace, which are also absorbing boundary conditions. Due to symmetry of the coupling slot and excitation, magnetic walls are defined at y-min and y-max to simulate a periodic array of slots in the y-direction. The 9″ period in the transverse or y direction is somewhat arbitrary, but it is influenced by the need to fit four coupling slots into the 40″ width of the PPW.

In FIG. 50, curve 5002 is the return loss at port 1, which is the same for ports 1 and 2 due to symmetry. The return loss is relatively high at −2 dB, indicating that most of the incident power at 900 MHz is reflected by the slot discontinuity, not radiated. The transmitted power from port 1 to 2, S₂₁, is shown as curve 5004. The S₂₁ null of −14 dB means that only 4% of the incident power at 900 MHz reaches the opposite port. This is a relatively low value of S₂₁ given the need for a uniform excitation of at least half of the array. Curve 5006 is the power loss due to radiation, which peaks at a value near −5 dB, or 31%. As shown in FIG. 50, less power is radiated than is reflected by a ratio of approximately 3 dB.

Most types of coupling slots, including the Jerusalem cross, can be accurately modeled near their fundamental resonant frequency with an equivalent circuit that includes one shunt RLC branch. This series RLC network has values of 2.8 Ω, 4.2 nH, and 7.1 pF for the crossed slot of FIG. 50. The characteristic impedance of the transmission line in this circuit model is η₀, the wave impedance of free space, multiplied by PPW height of 0.5″, and divided by the transverse period of 9″. Because a foamboard substrate was planned for use in the PRE prototypes, the dielectric constant of unity was assumed for the PPW and no adjustment of characteristic impedance was made for dielectric loading.

Referring to FIG. 50, reducing the overall slot length decreases the reflected power, but raises the resonant frequency. One method of maintaining the same resonant frequency with a smaller slot is to load the center of the slot with a shunt capacitor.

FIG. 51 shows a coupling slot that is center-loaded with a shunt capacitor according to an embodiment of the present invention. The shunt capacitor, which is also referred to as an overlay capacitor, includes a metal plate of size s1×s2, which is separated from the lower plate of the PPW by a 10 mil dielectric film having a relative permittivity of ∈ᵣ=3.2. The net result of using the overlay capacitor is that the return loss peak is reduced to −8.5 dB, though the coupling response is narrowband. Center-loading the coupling slot with the shunt capacitor may lower the resonant frequency of the coupling slot.

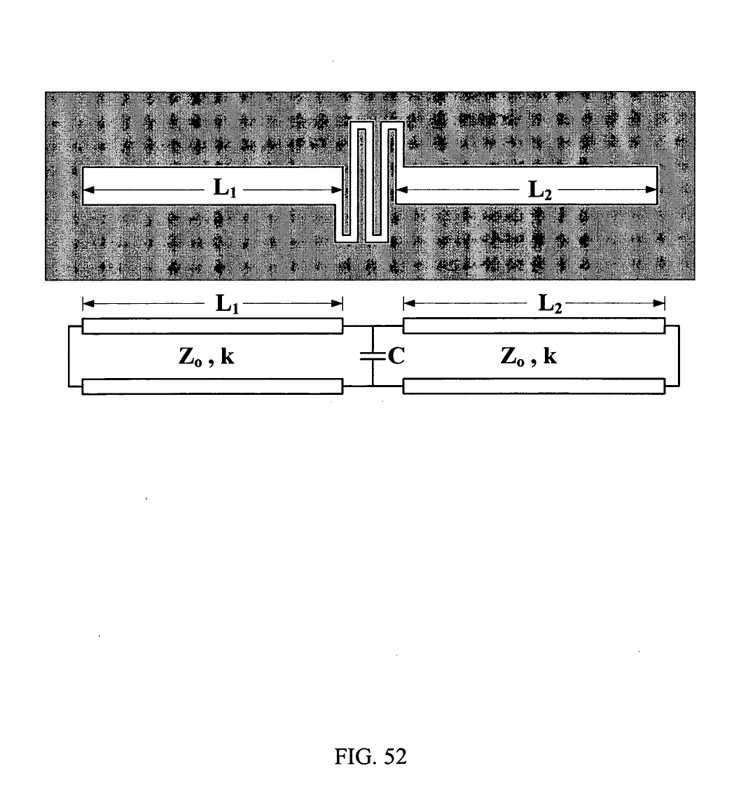

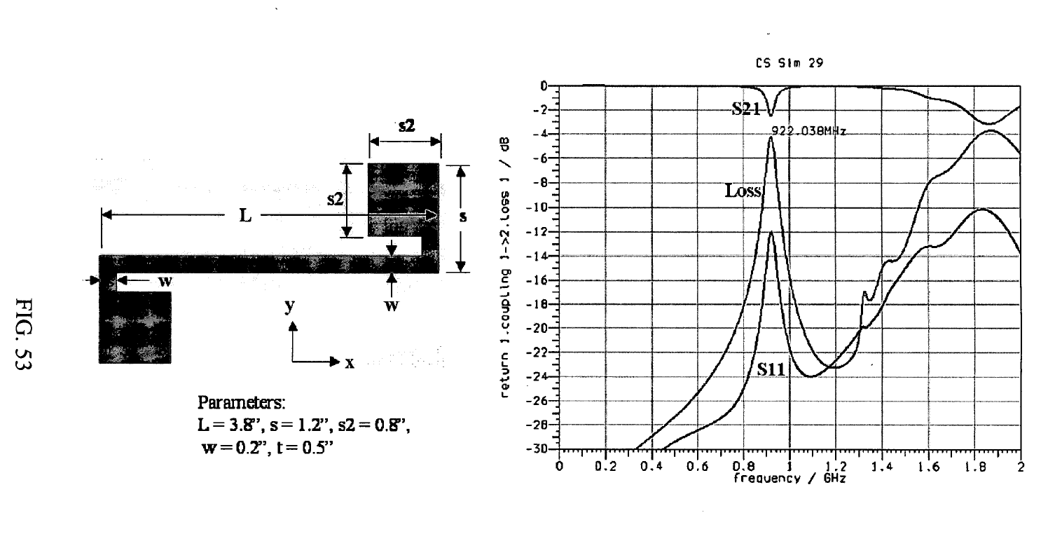

FIG. 52 shows a coupling slot that is center-loaded with an interdigital capacitor according to an embodiment of the present invention. Referring to FIG. 52, a first transmission line segment has a length of L₁, and a second transmission line segment has a length of L₂. The interdigital capacitor is coupled between the first and second transmission line segments. Referring to FIG. 52, the coupling slot may be configured such that L₁+L₂<<λ₀/2. This configuration may be advantageous because it does not require additional metal layer(s), though the coupling response is narrowband. Center-loading the coupling slot with the interdigital capacitor may lower the resonant frequency of the coupling slot.

FIG. 53 shows an S-shaped coupling slot according to an embodiment of the present invention. The resonant frequency and the coupling coefficient of the S-shaped coupling slot may be independently controlled. Referring to FIG. 53, the TEM mode wave propagates in the +/−x direction. Parameter s defines the slot dimension in the y or transverse direction, and it determines the coupling level. The resonant frequency is determined based on the sum of L and s, along with the size of the slotline open, which is shown in FIG. 53 to have dimensions s2 by s2.

Circuit modeling reveals that for a 4×4 slot array, two different coupling levels of slots should be used. The low coupling level slot should have an effective shunt resistance of at least 25 Ω, and the high coupling level slots should have a resistance in a range between 10 Ω and 15 Ω. In the embodiment of FIG. 53, it may be assumed that the transmission line has a characteristic impedance of 20 Ω because the transverse period is 9″ and the PPW height is 0.5″. The low coupling level slot should be located closer than the high coupling level slot to the transition region of the PPW. The S-shaped coupling slot shown in FIG. 53 may be designed using any of a variety of means, such as a Microstripes™ software tool or a CST Microwave Studio™ software tool.

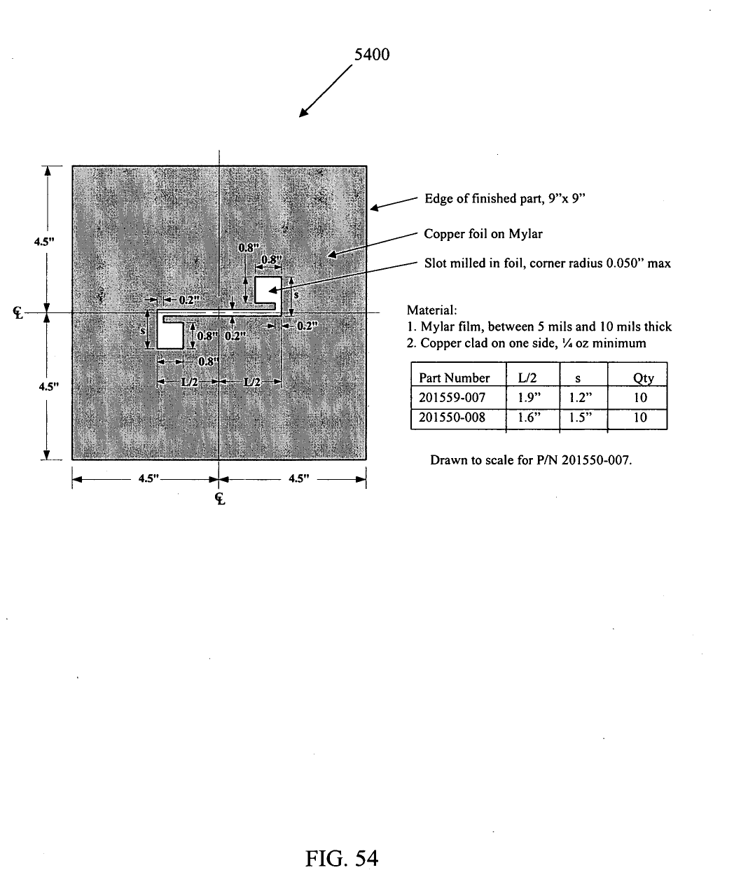

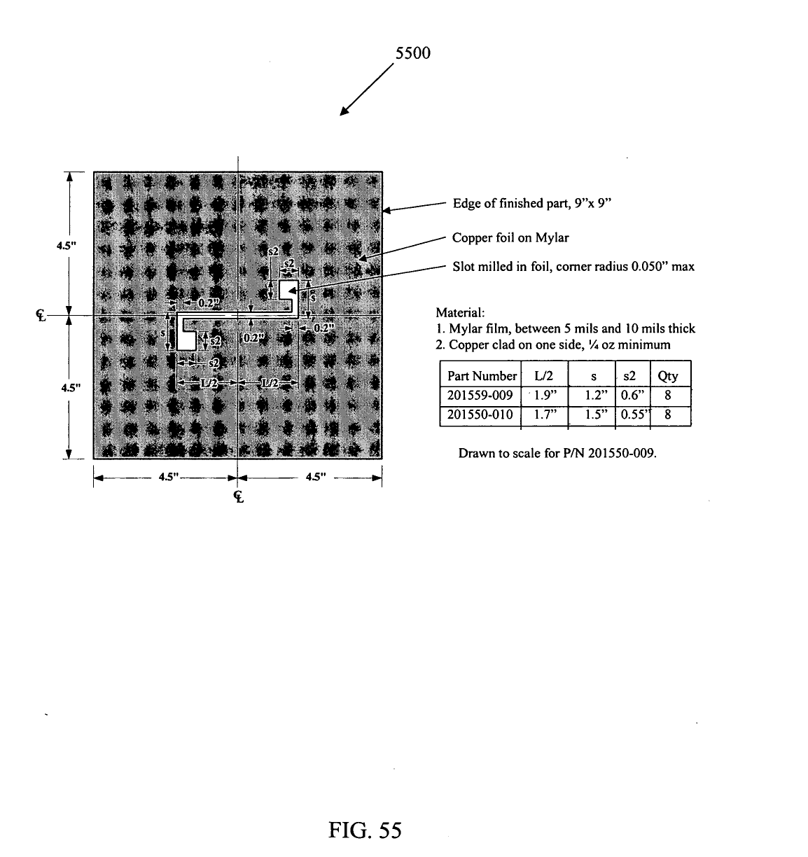

FIG. 54 shows dimensions of an S-shaped coupling slot 5400 that is based on a simulation using a Microstripes™ software program, according to an embodiment of the present invention. FIG. 55 shows dimensions of an S-shaped coupling slot 5500 based on a simulation using a CST Microwave Studio™ software program, according to an embodiment of the present invention. Coupling slots 5400 and 5500 were each milled into a copper foil of a 6-mil thick single-clad PET film. The milling was performed for the prototypes using a T-Tech™ circuit board milling machine. However, for high volume manufacturing, other methods may be more economical.

5.2.3 Slot Array Design for a Prototype PPW

In the description that follows, the performance of slot arrays are summarized without the effect of the transition regions. A slot array may be designed to provide a low return loss over the RFID band (e.g., 902-928 MHz). For instance, the slot array may be designed to provide a return loss of −10 dB or less. A slot array may be designed to maximize the power radiated by the first two slots of the array, and to equalize this radiated power between slots.

In the present example, slot arrays were simulated using a GENESYS™ circuit simulator concurrently with a full-wave simulation of individual coupling slots. Although coupling slots based on both Microstripes™ and CST Microwave Studio™ simulations were analyzed, only results for the Microwave Studio™ simulated slots are discussed below for simplicity.

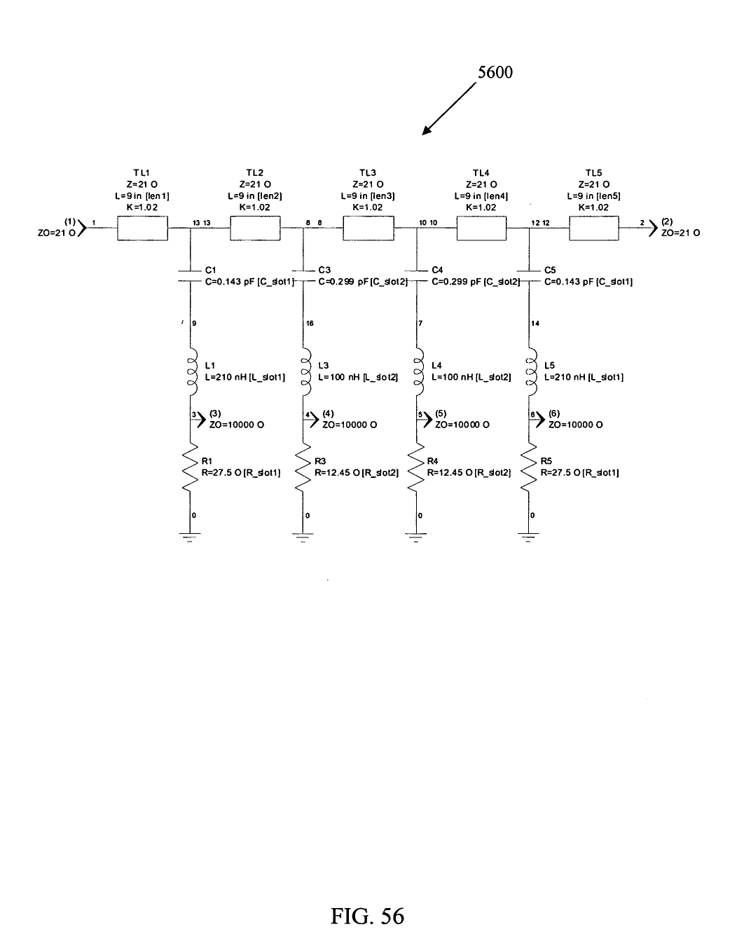

FIG. 56 shows an equivalent circuit model 5600 for a cascade of four slots in the x direction according to an embodiment of the present invention. As shown in FIG. 56, equivalent circuit model 5600 has Ports 1-6. Ports 1 and 2 are PPW ports for the TEM mode. Ports 3, 4, 5, and 6 are fictitious high impedance ports added to measure the voltage across the effective resistance of each slot. In the embodiment of FIG. 56, the distance between slots was varied, and it was found that 9″ is near optimum to minimize reflected power or to reduce S₁₁ to in-band levels below −15 dB. This corresponds to approximately 70% of a guide wavelength. In this embodiment, four slots were found to offer a better match than 3 or 5 slots. As illustrated in FIG. 56, the higher resistance slots (indicated by R1 and R5) should be located toward the outer edge of equivalent circuit model 5600, and the lower resistance (i.e., higher coupling) slots (indicated by R3 and R4) should be located toward the inner portion of equivalent circuit model 5600 to improve return loss. Such a configuration may equalizing the power radiated by the first two slots.

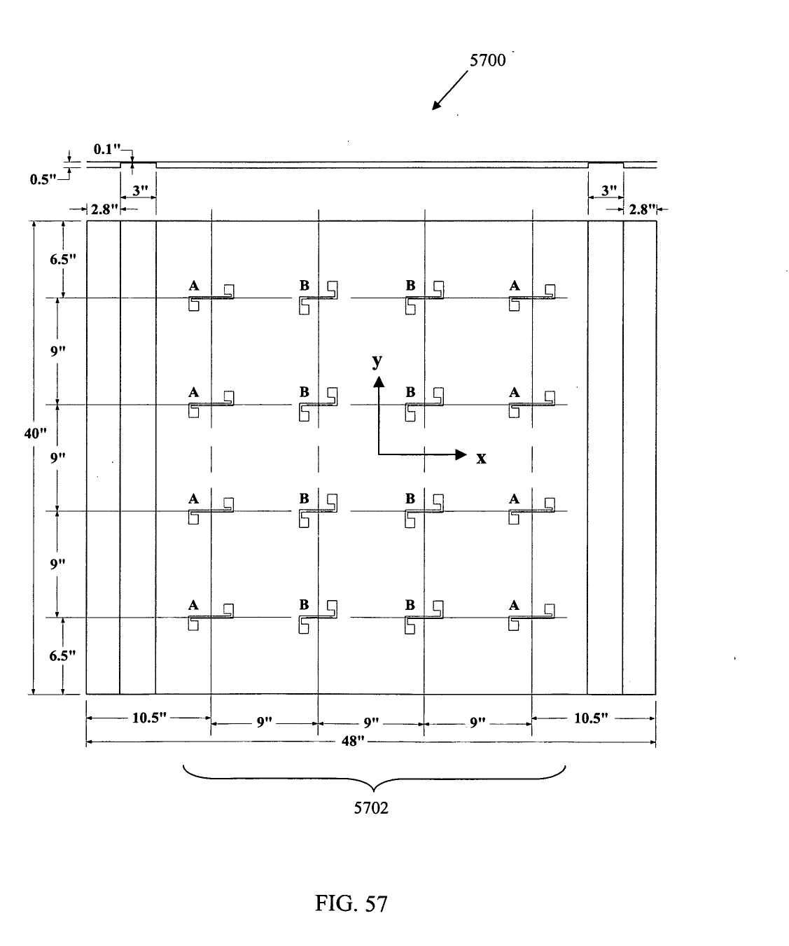

FIG. 57 shows a PPW 5700 having a 4×4 coupling slot array 5702 according to an embodiment of the present invention. Because the maximum width of the Pantene pallet stack in this example is 45″, and four cascaded coupling slots are used, the 45″ pallet dimension is divided into five equal parts to obtain a 9″ period in the x direction. Because a 9″ transverse period allows four coupling slots to fit comfortably within the 40″ dimension of the PPW, a 9″ period is used in both x and y directions. In FIG. 57, slots labeled “A” are low coupling level slots, and slots labeled “B” are high coupling level slots.

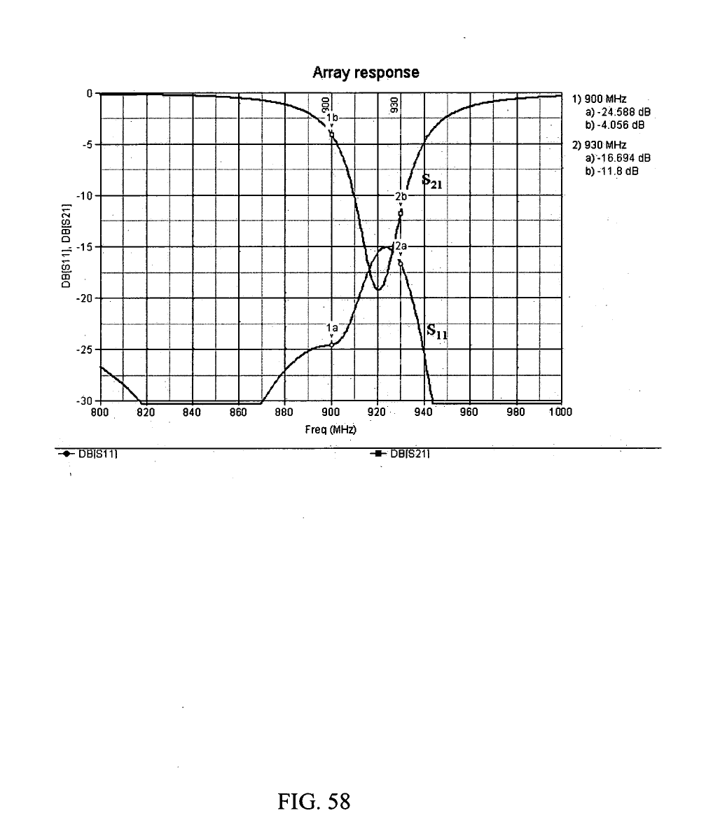

FIG. 58 is a graphical representation of the network response for equivalent circuit model 5600 shown in FIG. 56 according to an embodiment of the present invention. Recall that equivalent circuit model 5600 includes four cascaded coupling slots, two of which are type A and the other two of which are type B. As shown in FIG. 58, the input return loss is −15 dB or better across the RFID band. The slots appear to be tuned slightly high in resonant frequency since the S₂₁ null is found at 920 MHz instead of 915 MHz.

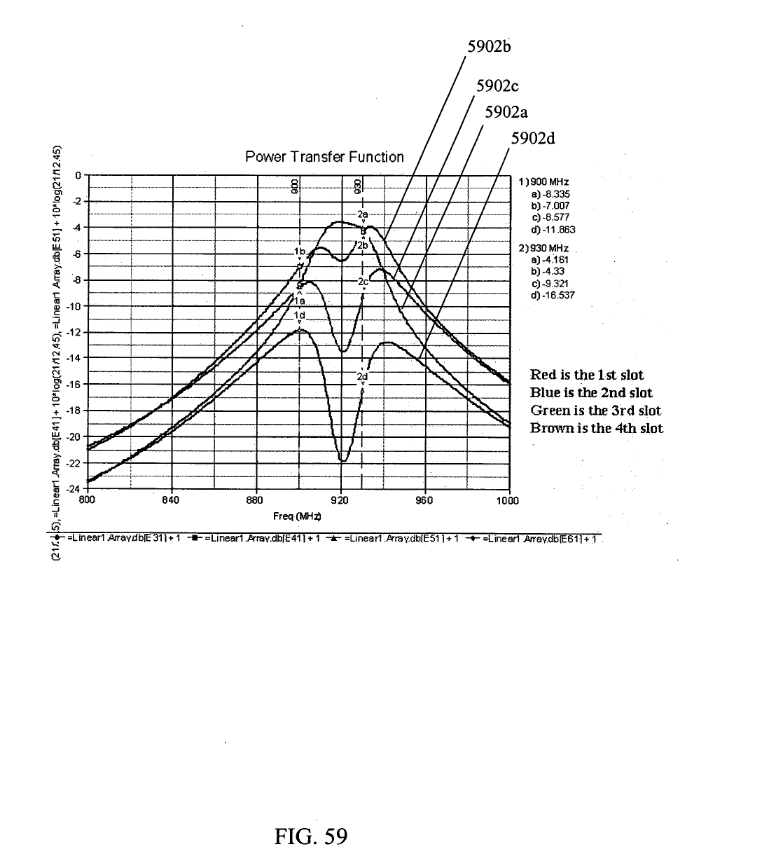

FIG. 59 shows the power radiated by each cascaded slot of equivalent circuit model 5600 relative to the input power at port 1 according to an embodiment of the present invention. Curves 5902a-d represent the power radiated by the first, second, third, and fourth cascaded slots of coupling slot array 5702 of FIG. 57. The power radiated by each cascaded slot is calculated from voltage gain at auxiliary ports 3 through 6, and the ratios of slot load resistance to the characteristic impedance of the input port. Referring to FIG. 59, the first two cascaded slots, corresponding to auxiliary ports 3 and 4, radiate approximately the same power level to within 3 dB over the RFID band.

5.2.4 Cascaded Circuit Model for a Prototype PPW

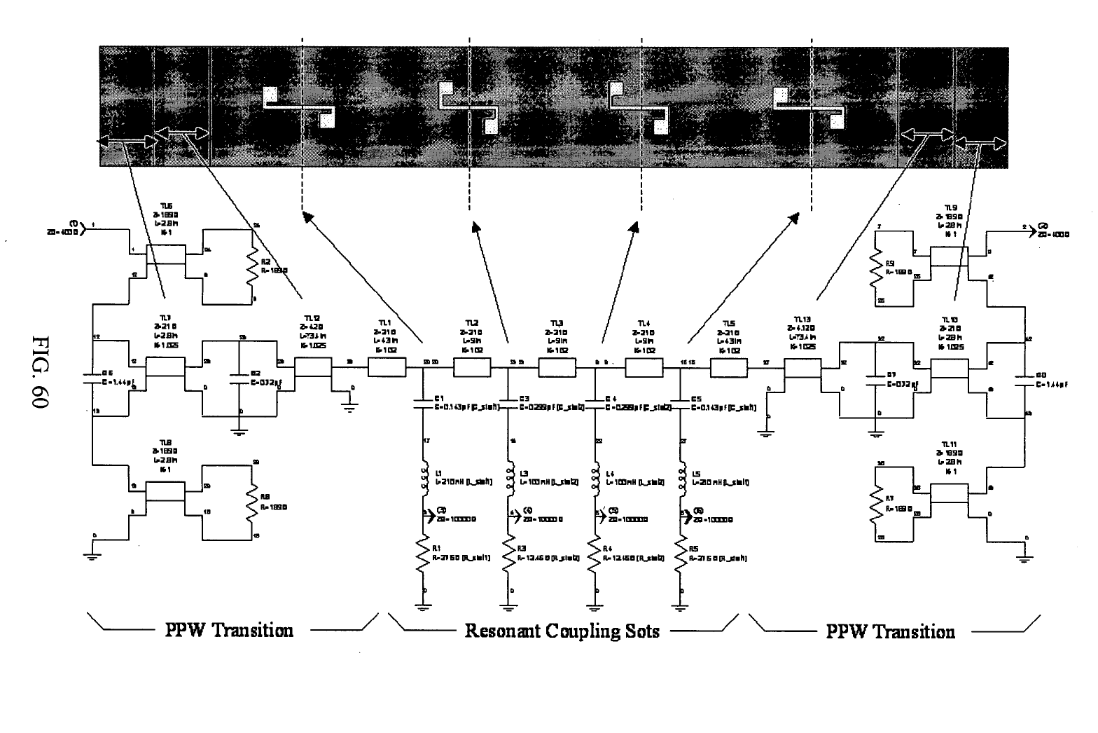

In this section the transitions and slot array are modeled as a cascaded network in an attempt to predict the ratio of power radiated by the resonant coupling slots to the power incident upon a pallet stack. This is the power transfer function for the slots. FIG. 60 illustrates mapping of the transmission lines and slot loads of an equivalent circuit model 6000 into each physical feature of the PPW according to an embodiment of the present invention. Equivalent circuit model 6000 has transmission line characteristic impedances that are based on a 9″ wide PPW. Note that equivalent circuit model 6000 assumes an infinite periodic structure in the transverse or y direction with a 9″ period. As with the previous section, the slot equivalent circuits are based on CST Microwave Studio™ simulations.

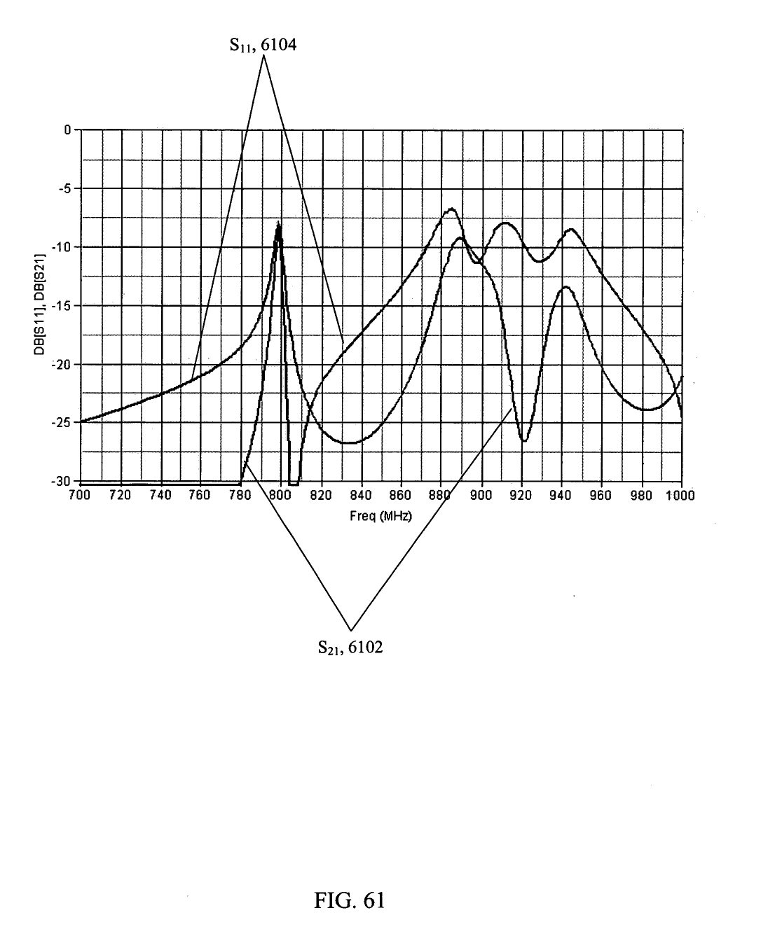

FIG. 61 shows the predicted end-to-end transmission performance S₂₁ 6102 and the port return loss S₁₁ 6104 of equivalent circuit model 60 in FIG. 60 according to an embodiment of the present invention. Within the 900-930 MHz band, less than −12 dB or 6% of the incident plane wave power passes through the PPW. Note that port 1 models all power incident upon the pallet stack in a 9.5″ tall period. Power that is not captured by the PPW impedance matching transition is either reflected or absorbed by the lossy dielectric, which is referred to as shampoo in this example. The power that is not captured is represented as power absorbed in the matched loads for TL6 and TL8. Although the predicted input return loss varies from approximately −8 dB to −12 dB, it should be noted that equivalent circuit model 6000 does not account for power reflected by the shampoo cases.

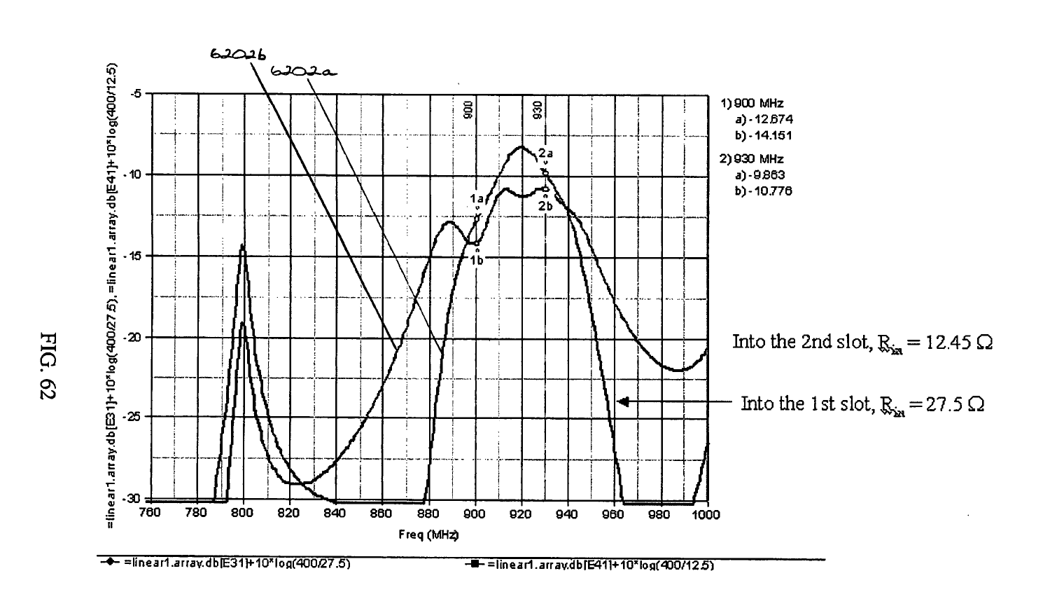

FIG. 62 shows power transfer functions 6202a-b for respective first and second slots of equivalent circuit model 6000 shown in FIG. 60 according to embodiments of the present invention. Power transfer functions 6202a-b assume an infinite periodic structure in the transverse direction. Ideally, power transfer functions 6202a-b would be identical, flat, and as high as possible. In FIG. 60, power transfer functions 6202a-b track each other to within a few dB over the 900-930 MHz band. Over the RFID band, the approximate ratio of power radiated by each slot to the incident power on a 9″ wide by 9.5″ tall surface area of the pallet stack is approximately −14 dB to −8 dB.

5.2.5 Fabrication of a Prototype PPW

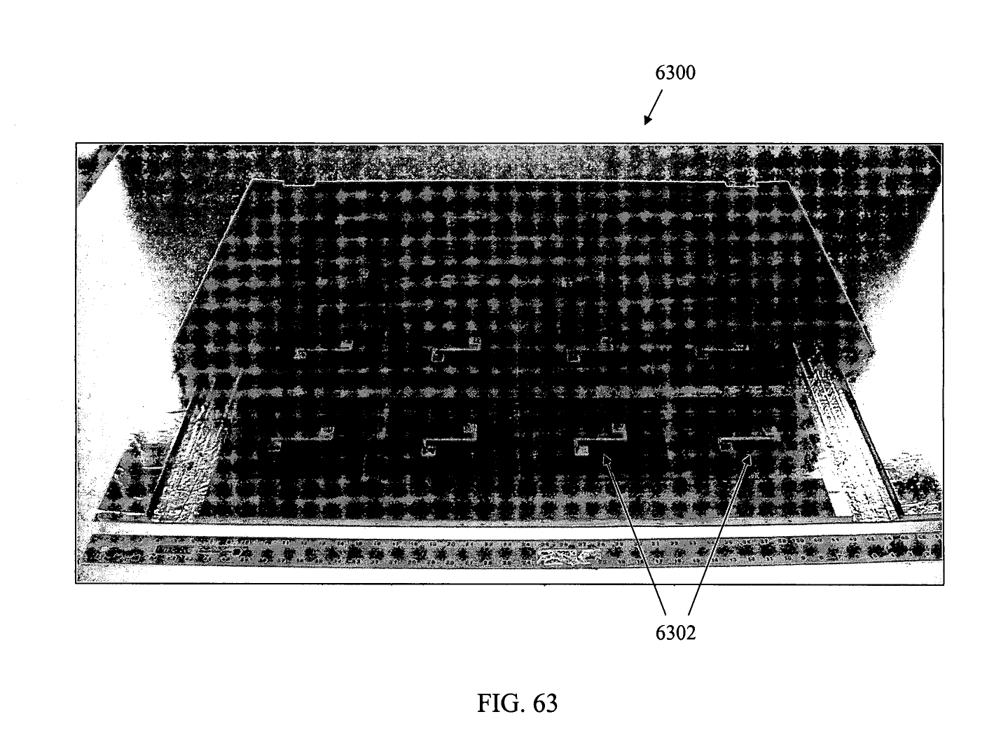

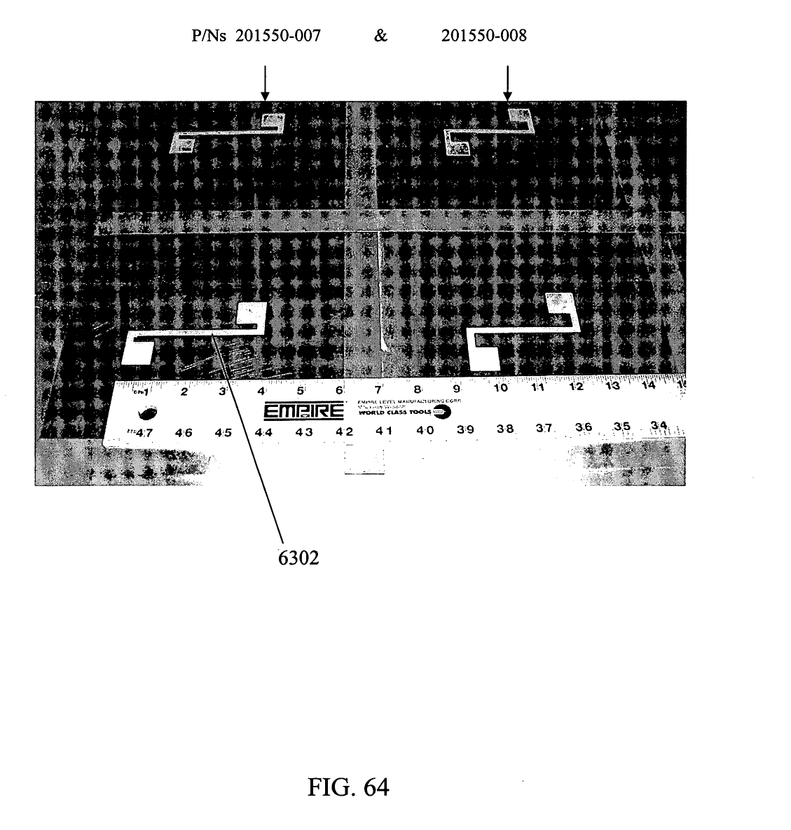

FIG. 63 shows a prototype PPW 6300, referred to as S/N-001PPW, according to an embodiment of the present invention. FIG. 64 is a more detailed view of resonant coupling slots 6302 of PPW 6300 according to an embodiment of the present invention. Resonant coupling slots 6302, labeled as P/N 201550-007 and P/N 201550-008 in FIG. 64, were designed using Microstripes™ software. Dimensional details of resonant coupling slots are described above with reference to FIGS. 54 and 55.

The core of prototype PPW 6300 is a ½″ thick Gatorfoam™ graphics arts board made by International Paper Company. Gatorfoam™ is a durable and rigid foamboard having a polystyrene core and a Luxcell® wood fiber veneer on each side. The surface of Gatorfoam™ is smooth, and it can be milled with standard woodworking tools. In this example, the Gatorfoam™ was milled using a table saw having a dado head cutter to create a profile of 2.8″ at the full 0.5″ height followed by 3″ at 0.1″ height. This is consistent with the transition region dimensions used for the Microstripes™ simulation described with reference to FIG. 43. Both of the 40″ long sides of the Gatorfoam™ were milled for the impedance matching transition.

The resonant coupling slots were milled in the copper foil of a 6 mil single-clad PET film. The milling was performed at JEM Engineering, LLC using a T-Tech milling machine. 3M-brand spray 77 adhesive was applied to the PET side of the slots and on the Gatorfoam™ to provide a secure bond between the two. For instance, adhesive may be applied to both surfaces to prevent the copper-clad film from rolling up. In this example, each PET film was cut to a 9″ square as shown in FIG. 54. Individual films were adhesively attached to the Gatorfoam™ in an edge-to-edge pattern similar to tiling a floor. Seams between the 9″ square parts were joined using 1″ wide copper tape. Aluminum foil was bonded to the entire topside of PPW 6300, and to the transition regions, using a spray adhesive designed for foils.

A second PPW prototype, referred to as S/N-002PPW, was fabricated in the same manner as PPW 6300 using slots having part numbers P/N 201550-009 and P/N201550-010. The second PPW was intended to be identical to PPW 6300 (i.e., S/N-001PPW), except for the difference in coupling slots. The P/N 201550-009 and P/N 201550-010 part numbers were used in locations A and B, respectively, as shown in FIG. 57.

5.2.6 Test Results of a Prototype PPW

The first and second PPW prototypes were evaluated in two ways. First, loop probe measurements were used to determine the frequency response of the radiating slots when the PPW transition was illuminated with an incident V-pol wave. The second test was a portal reader test in which the PPW covered one layer of tagged Pantene cases to facilitate determining which cases may be read.

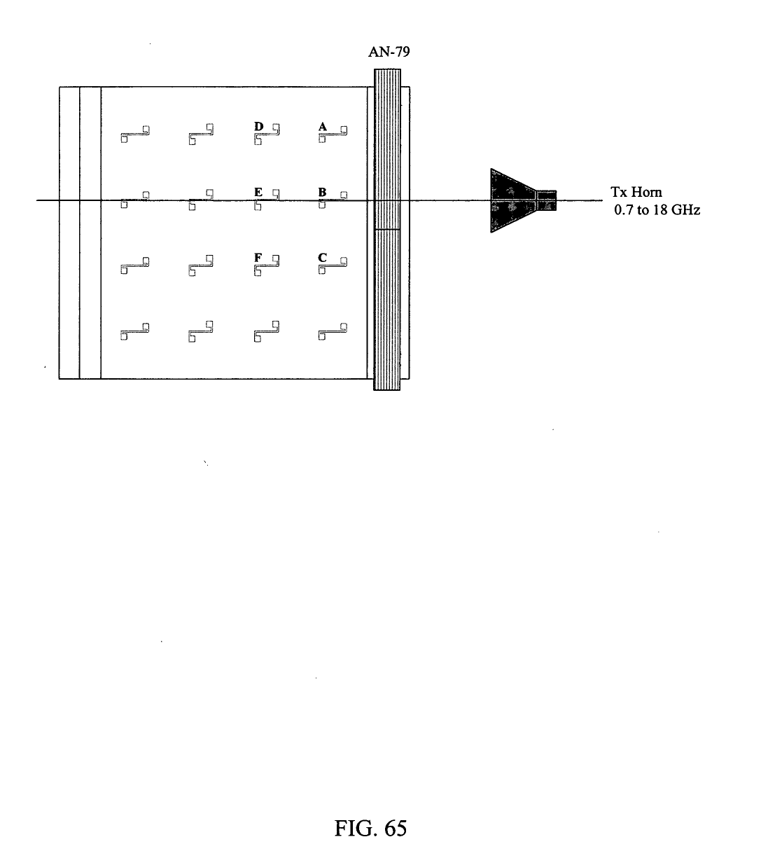

The loop probe measurements was a two-port measurement in which a broadband 0.7-18 GHz horn was used as a transmitter antenna, and a 1⅜″ diameter coaxial loop probe was used as the receiver antenna. FIG. 65 is a plan view of the test setup showing the relationship between the test horn and the slots to be probed, according to an embodiment of the present invention. An 8722ES network analyzer manufactured by Agilent Technologies, Inc. was used for S₂₁ measurements. Calibration of the loop for through response was performed with the loop positioned approximately 6 inches in front of the vertically polarized horn. As shown in FIG. 65, the Tx horn was aligned with the second row of coupling slots, and pointed toward the PPW edge, separated from the edge by about 18″.

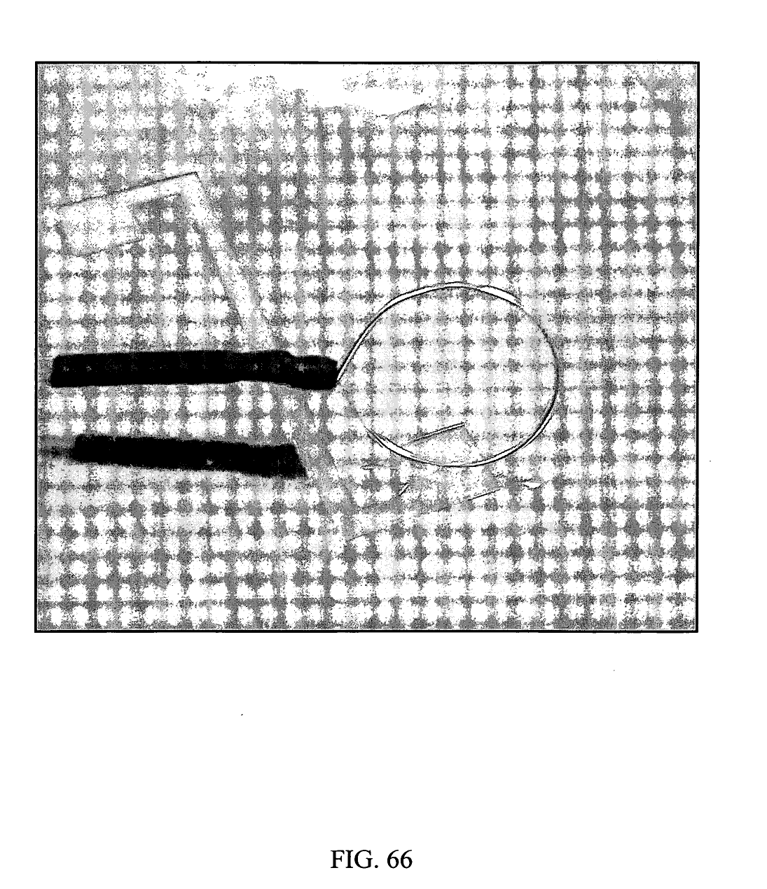

In this experiment, the loop probe was constructed by wrapping the center conductor of a 50 Ω coaxial cable back to its outer conductor. As shown in FIG. 66, the loop probe was positioned in a vertical plane at the end of a given slot. The metal loop rested on the PET film of the slot aperture. In some cases, the probe was positioned such that the loop touched the metal surface just inside the open end.

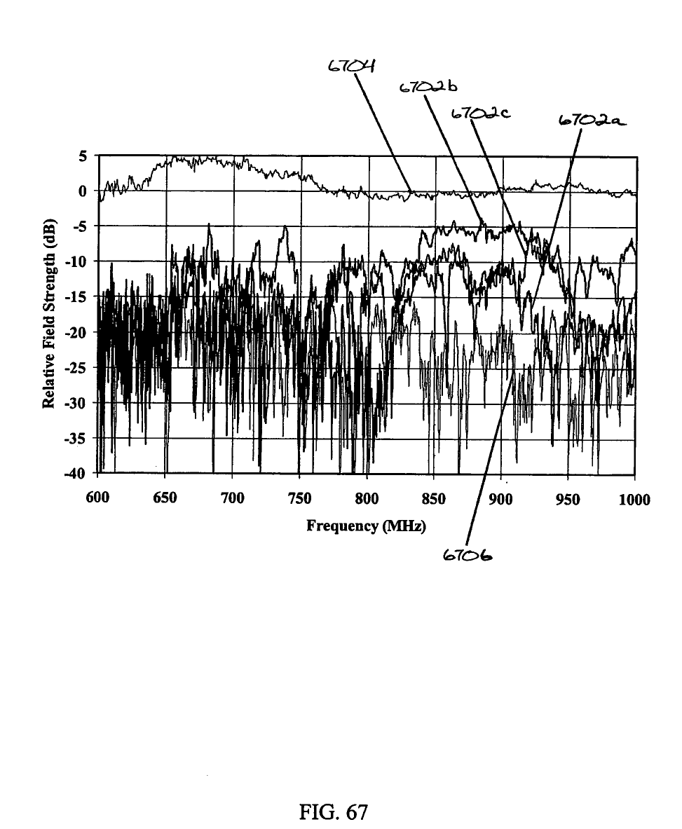

FIG. 67 shows loop probe S₂₁ coupling measurements for slots A, B, and C of first prototype PPW 6300 (a.k.a. S/N-001PPW) according to an embodiment of the present invention. Curves 6702a-c represent measurements associated with respective slots A, B, and C. Curve 6704 represents the strength of the field incident on the edge of PPW 6300. Curve 6706 represents the noise floor.

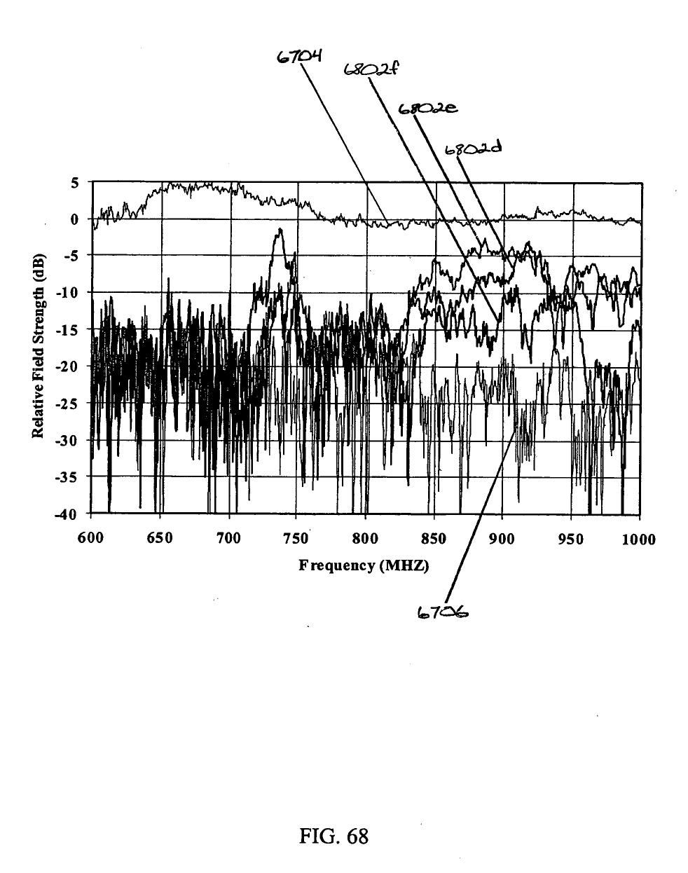

FIG. 68 shows loop probe S₂₁ coupling measurements for slots D, E, and F of first prototype PPW 6300 according to an embodiment of the present invention. Curves 6802d-f represent measurements associated with respective slots D, E, and F.

Referring to FIGS. 67 and 68, coupling measurements were made with the probe positioned at the six slots identified as locations A through F in FIG. 65. Incident field strength 6704 was measured by suspending the probe approximately 6″ in front of the horn. Noise floor 6706 was measured by moving the probe about 15 feet away from the respective PPWs, and behind the Tx horn. This configuration was also used for isolation calibration. In this example, the dynamic range is approximately 20 dB. The dynamic range measurement should be made in an anechoic chamber. However, the measurement was made in a laboratory environment with a steel raised panel floor and a corrugated steel ceiling located approximately 12 feet above the floor. Time domain gating may be employed, though it was not used in this example.

FIGS. 67 and 68 reveal that the six slots of first prototype PPW 6300 (a.k.a. S/N-001PPW) that were probed radiate over the RFID band of 902-928 MHz, though the response is broader in frequency than predicted by equivalent circuit model 6000. This may be due to the predictions being based on an infinite array in the transverse direction and only four slots being used. As shown in respective FIGS. 67 and 68, slots B and E offer the highest signal strength, as compared to the other slots. It should be noted that slots B and E are collinear with the Tx horn and its main beam direction. The signal level is relatively high at slots B and E, approximately 5 dB below the signal strength measures near the mouth of the Tx horn. When the probe was lifted away from the slots, its received power level quickly decreased to near noise floor 6706 even though the probe was still located behind the wall of AN-79 absorber.

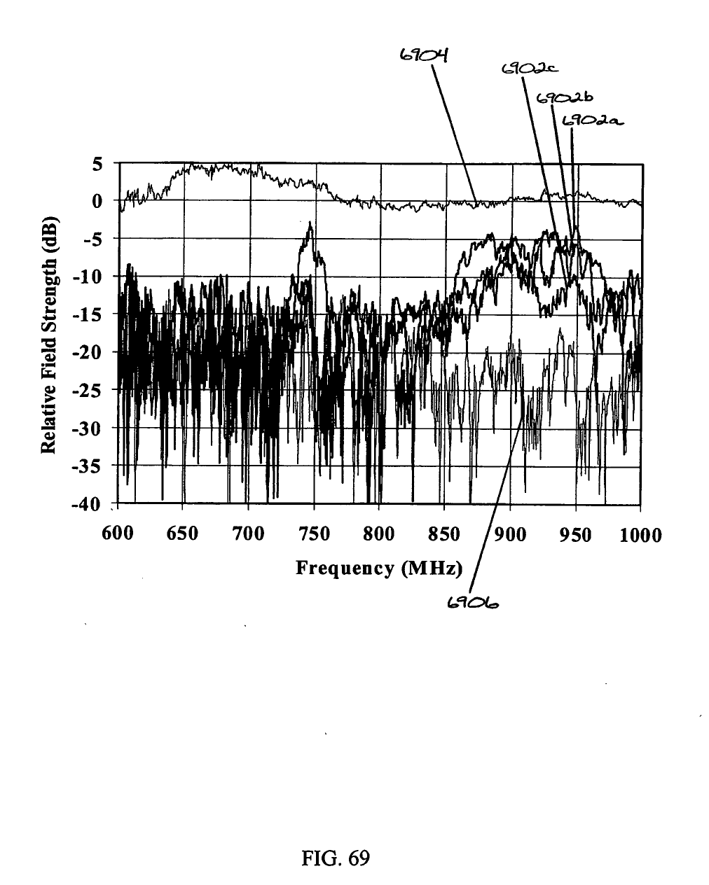

FIG. 69 shows loop probe S₂₁ coupling measurements for slots A, B, and C of the second prototype PPW (a.k.a. S/N-002PPW) according to an embodiment of the present invention. Curves 6902a-c represent measurements associated with respective slots A, B, and C. Curve 6904 represents the strength of the field incident on the edge of the second prototype PPW. Curve 6906 represents the noise floor.

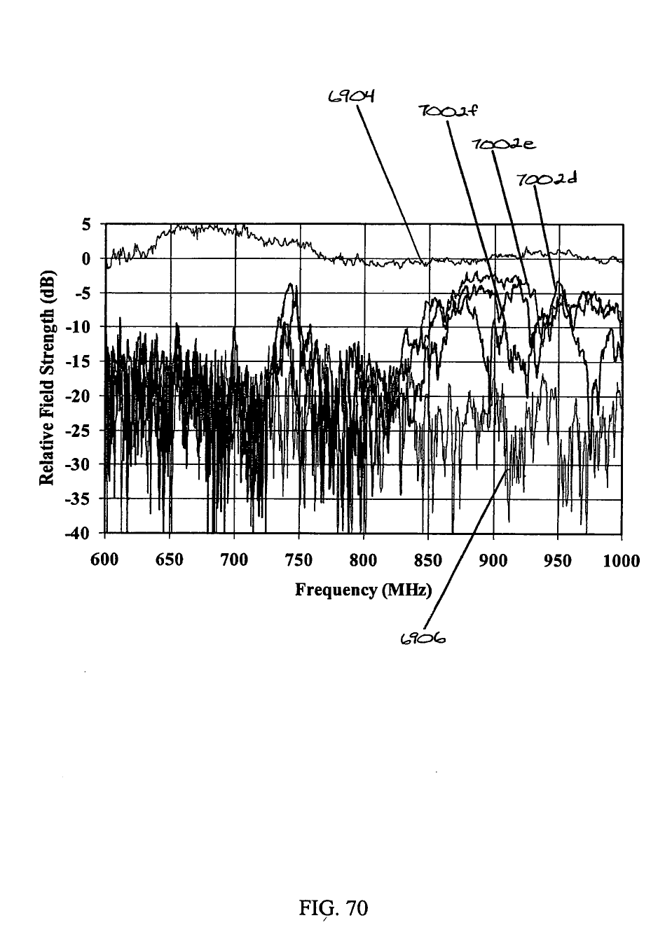

FIG. 70 shows loop probe S₂₁ coupling measurements for slots D, E, and F of the second prototype PPW according to an embodiment of the present invention. Curves 7002d-f represent measurements associated with respective slots D, E, and F.

The test setup shown in FIG. 65 was used to probe the second PPW, S/N-002PPW, with the same calibration that was used to probe first prototype PPW 6300. The frequency response of the second prototype PPW appears to be slightly better defined than that of first prototype PPW 6300. The peak signal levels of the second prototype PPW are slightly higher than those of first prototype PPW 6300. Slots of the second prototype PPW that are collinear with the Tx horn have the highest signal strength, as compared to the other slots of the second prototype PPW. The relatively narrowband response that appears near 740 MHz in FIGS. 69 and 70 was predicted by circuit simulations as shown in FIGS. 61 and 62. Although the predicted narrowband response is about 50 MHz higher than the measured response, the response peak may be cause by an internal PPW resonance between slots.

5.3 TM Mode Surface Waveguide Embodiment

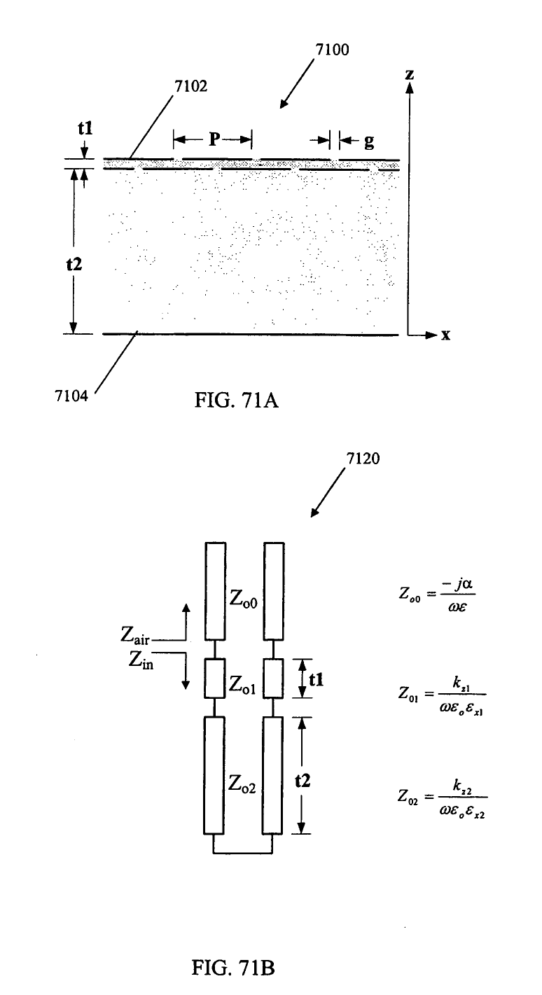

FIG. 71A is a side view of another example TM mode surface waveguide 7100 according to an embodiment of the present invention. TM mode surface waveguide 7100 includes a capacitive frequency selective surface (FSS) 7102 offset a distance t₂ from a plane 7104. Plane 7104 may be a ground plane or a metal foil, to provide some examples. Surface wave propagation along TM mode surface waveguide 7100 can be analyzed using the transverse resonance method.

Assuming that the surface wave power of TM mode surface waveguide 7100 propagates in the +x direction, an equivalent transmission line 7120 for wave propagation in the z direction may be derived, as shown in FIG. 71B. Enforcing the continuity of tangential electric and magnetic fields at boundaries yields the transverse resonance equation Zᵢₙ+Zₐᵢᵣ=0, where

$${Z}_{air} = \frac{- jα}{{ωɛ}_{o}} and$$

$${Z}_{i n} = \frac{{k}_{z 1}}{{ωɛ}_{o} {ɛ}_{x 1}} \frac{j \frac{{k}_{z 2}}{{ωɛ}_{o} {ɛ}_{x 2}} tan ( {k}_{z 2} {t}_{2} ) cos ( {k}_{z 1} {t}_{1} ) + j \frac{{k}_{z 1}}{{ωɛ}_{o} {ɛ}_{x 1}} sin ( {k}_{z 1} {t}_{1} )}{\frac{{k}_{z 1}}{{ωɛ}_{o} {ɛ}_{x 1}} cos ( {k}_{z 1} {t}_{1} ) - \frac{{k}_{z 2}}{{ωɛ}_{o} {ɛ}_{x 2}} tan ( {k}_{z 2} {t}_{2} ) sin ( {k}_{z 1} {t}_{1} )}$$

The transverse resonance equation may be solved for the decay constant α in the air region to yield

$$\begin{matrix}α = {jωɛ}_{o} {Z}_{i n} \\ = \frac{{k}_{z 1}}{{ɛ}_{x 1}} \\ \frac{\frac{{k}_{z 2}}{{ɛ}_{o} {ɛ}_{x 2}} tan ( {k}_{z 2} {t}_{2} ) cos ( {k}_{z 1} {t}_{1} ) + \frac{{k}_{z 1}}{{ɛ}_{o} {ɛ}_{x 1}} sin ( {k}_{z 1} {t}_{1} )}{\frac{{k}_{z 1}}{{ɛ}_{o} {ɛ}_{x 1}} cos ( {k}_{z 1} {t}_{1} ) - \frac{{k}_{z 2}}{{ɛ}_{o} {ɛ}_{x 2}} tan ( {k}_{z 2} {t}_{2} ) sin ( {k}_{z 1} {t}_{1} )}\end{matrix}$$

having the units of Nepers per meter. Substituting a back into the dispersion equation for the air region kₓ²+k_{z}²=k₀² where k_{z}=−jα provides kₓ^{TM}={square root over (k₀²+α(k_{z1}(kₓ), k_{z2}(kₓ))²)}. For TM waves in anisotropic media, such as the FSS layer,

$${k}_{z 1 , 2} = {k}_{o} \sqrt{{μ}_{y 1 , 2} {ɛ}_{x 1 , 2} - {( \frac{{k}_{x}}{{k}_{o}} )}^{2} \frac{{ɛ}_{x 1 , 2}}{{ɛ}_{z 1 , 2}}} . {ɛ}_{x 1} = \frac{C}{{ɛ}_{o} {t}_{1}} ,$$

where

$$C = \frac{{ɛ}_{o} {{ɛ}_{r 1} ( \frac{P - g}{2} )}^{2}}{{t}_{1}}$$

is the FSS capacitance per unit square. μ_{y1}=1 is the y tensor component for relative permeability of the FSS. ∈_{z1}=∈ᵣ₂ is the normal tensor component for relative permittivity of the FSS when it is constructed from overlapping square metal patches.

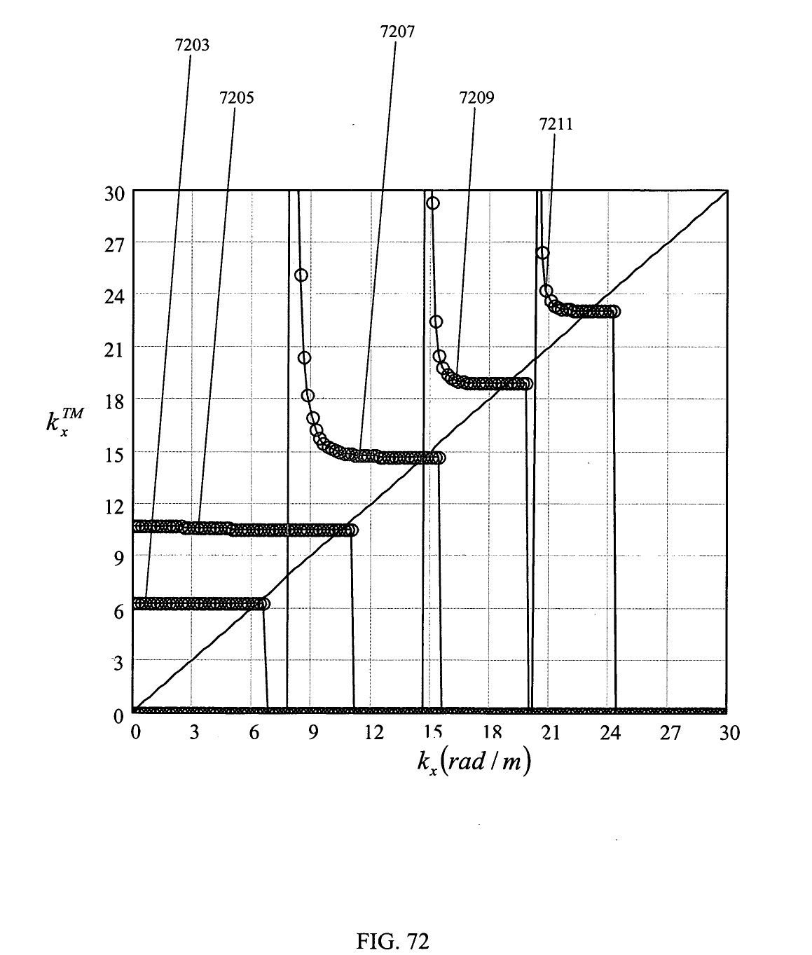

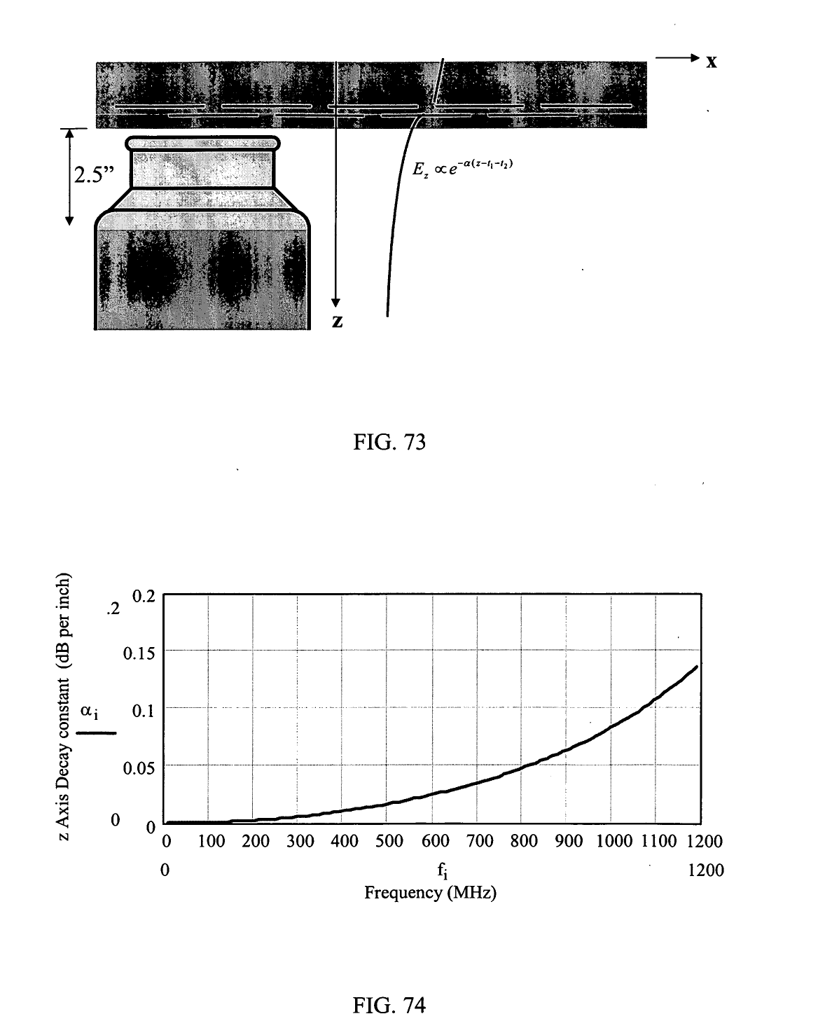

TM mode surface waveguide 7100 was analyzed at a variety of frequencies. FIG. 72 shows plots of kₓ^{TM} versus the independent variable kₓ for different frequencies according to an embodiment of the present invention. Curve 7203 corresponds with a frequency of 300 MHz. Curve 7205 corresponds with a frequency of 500 MHz. Curve 7207 corresponds with a frequency of 700 MHz. Curve 7209 corresponds with a frequency of 900 MHz. Curve 7211 corresponds with a frequency of 1100 MHz. Intersections of these curves 7203-7211 with the line kₓ^{TM}=kₓ indicate the existence of a guided TM mode at the respective frequencies. Curves 7203-7211 correspond with TM mode surface waveguide 7100 of FIG. 71A having the following parameters: t1=4 mils, t2=250 mils, ∈ᵣ₁=3.2, ∈ᵣ₂=1.1, P=460, and g=20 mils, where ∈ᵣ₁ is the relative permittivity of the FSS dielectric, and ∈ᵣ₂ is the relative permittivity of the spacer layer. In this example, a 2.5″ gap exists between the surface of the PPW and the lossy dielectric (shampoo), as shown in FIG. 73. FIG. 74 shows the relationship between the normal direction decay constant α and frequency, the design parameters for which are provided in this paragraph, according to an embodiment of the present invention.

### 6.0 Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system for identifying objects, comprising:
a radio frequency identification (RFID) tag attached to an object in a stack of objects; and
a waveguide provided between objects in the stack to facilitate communication between an RFID reader and the tag.

2. The system of claim 1, wherein the waveguide is a TE (transverse electric) mode surface waveguide.

3. The system of claim 1, wherein the waveguide is a TM (transverse magnetic) mode surface waveguide.

4. The system of claim 1, wherein the waveguide is a parallel plate waveguide.

5. The system of claim 1, wherein the waveguide is an electromagnetic hard surface.

6. The system of claim 1, wherein the waveguide has an edge portion that extends beyond a perimeter of the stack.

7. The system of claim 1, wherein the waveguide is provided between vertical layers of objects in the stack.

8. The system of claim 1, wherein the waveguide is provided between horizontal layers of objects in the stack.

9. The system of claim 1, wherein the waveguide includes tapered metallic elements along an edge of the waveguide.

10. The system of claim 1, wherein the waveguide includes a first planar layer having a first plurality of conductive elements, a second planar layer having a second plurality of conductive elements, and a dielectric layer coupled between the first planar layer and the second planar layer; and wherein elements of the first plurality and elements of the second plurality partially overlap with each other.

11. The system of claim 1, wherein the waveguide includes an asymmetric stepped height transition at an edge of the waveguide.

12. The system of claim 1, wherein the waveguide includes a symmetric stepped height transition at an edge of the waveguide.

13. The system of claim 1, wherein the waveguide has transition coupling slots at an edge of the waveguide.

14. The system of claim 1, wherein the waveguide has a slot through which radio frequency (RF) energy radiates to the tag.

15. The system of claim 1, wherein the waveguide includes interdigital capacitors.

16. The system of claim 1, wherein the waveguide includes overlay capacitors.

17. The system of claim 1, wherein the waveguide includes:
a capacitive frequency selective surface (FSS); and
a dielectric spacer layer attached to at least one side of the FSS.

18. A method for identifying objects, comprising:
transmitting a first radio frequency (RF) signal to a waveguide that is provided between objects in a stack of objects; and
receiving a response signal from a tag that is affixed to an object in the stack.

19. The method of claim 18, further comprising:
processing the first RF signal to generate the response signal.

20. The method of claim 18, wherein transmitting the first RF signal includes transmitting the first RF signal to tapered metallic elements along an edge of the waveguide.

21. The method of claim 18, wherein transmitting the first RF signal includes transmitting the first RF signal in a direction that is normal to an electric field associated with the first RF signal.

22. The method of claim 18, wherein transmitting the first RF signal includes transmitting the first RF signal in a direction that is normal to a magnetic field associated with the first RF signal.

23. The method of claim 18, further comprising:
radiating the first RF signal from the waveguide to the tag via a slot in the waveguide.

24. A method for arranging objects for tracking, comprising:
(a) positioning a planar waveguide on a surface; and
(b) positioning objects on the planar waveguide to form a stack;
wherein the waveguide is capable of receiving a tracking signal and guiding the tracking signal to reach the objects.

25. The method of claim 22, further comprising:
repeating at least one of steps (a) and (b) at least one additional time to add to the stack.
